(19) United States
(12) Patent Application Publication
(10) Pub. No.: US 2024/0162483 A1
(43) Pub. Date: May 16, 2024

(54) SHEET FOR ELECTRODE AND ALL-SOLID STATE SECONDARY BATTERY, AND MANUFACTURING METHODS FOR SHEET FOR ELECTRODE, ELECTRODE SHEET, AND ALL-SOLID STATE SECONDARY BATTERY

(71) Applicant: FUJIFILM Corporation, Tokyo (JP)

(72) Inventor: Hideyuki Suzuki, Kanagawa (JP)

(73) Assignee: FUJIFILM Corporation, Tokyo (JP)

(21) Appl. No.: 18/406,190

(22) Filed: Jan. 7, 2024

Related U.S. Application Data
(63) Continuation of application No. PCT/JP2022/036128, filed on Sep. 28, 2022.

(30) Foreign Application Priority Data
Sep. 29, 2021 (JP) 2021-159110

(51) Int. Cl. H01M 10/0562; H01M 4/02; H01M 4/04; H01M 4/62

(52) U.S. Cl. CPC H01M 10/0562; H01M 4/0407; H01M 4/043; H01M 4/622; H01M 2004/021; H01M 2004/027; H01M 2004/028; H01M 2300/0068

(57) ABSTRACT

There are provided a sheet for an electrode, which includes an active material layer precursor layer containing an inorganic solid electrolyte, an active material, and a polymer binder, in which the active material layer precursor layer is such that a content of the polymer binder is 3% by mass or less and a filling rate of 35% to 50% is exhibited, a manufacturing method therefor, an all-solid state secondary battery, and manufacturing methods for an electrode sheet and an all-solid state secondary battery, in which this sheet for an electrode is used.

### CROSS-REFERENCE TO RELATED APPLICATIONS

This application is a Continuation of PCT International Application No. PCT/JP2022/036128 filed on Sep. 28, 2022, which claims priority under 35 U.S.C. § 119 (a) to Japanese Patent Application No. 2021-159110 filed in Japan on Sep. 29, 2021. Each of the above applications is hereby expressly incorporated by reference, in its entirety, into the present application.

### BACKGROUND OF THE INVENTION

### 1. Field of the Invention

The present invention relates to a sheet for an electrode and an all-solid state secondary battery, and manufacturing methods for a sheet for an electrode, an electrode sheet, and an all-solid state secondary battery.

### 2. Description of the Related Art

In all-solid state secondary batteries, since all of the negative electrode, the electrolyte, and the positive electrode are solid, safety and reliability that are considered as a problem of batteries in which the organic electrolytic solution is used can be significantly improved. It is also said to be capable of extending the battery life. Further, an all-solid state secondary battery can be provided with a structure in which the electrode and the electrolyte are directly disposed in series. As a result, it is possible to increase the energy density to be high as compared with a secondary battery in which an organic electrolytic solution is used, and thus the application to electric vehicles, large-sized storage batteries, and the like is anticipated.

In such an all-solid state secondary battery, examples of the substance that forms an active material layer (also referred to as an electrode layer) include an inorganic solid electrolyte and an active material. This inorganic solid electrolyte, particularly an oxide-based inorganic solid electrolyte or a sulfide-based inorganic solid electrolyte is expected as an electrolyte material having a high ion conductivity comparable to that of the organic electrolytic solution.

In general, the active material layer of the all-solid state secondary battery is formed as an electrode sheet by forming a film (carrying out coating and drying) of a material on a base material, the material being a material (also referred to as an active material layer forming material or an electrode composition) obtained by dispersing or dissolving the above-described inorganic solid electrolyte and active material, as well as a binder (a binding agent) and the like in a dispersion medium. For example, JP2017-062939A describes “a method of manufacturing an electrode laminate including an active material layer and a solid electrolyte layer on a surface of the active material layer, in which the method of manufacturing an electrode laminate includes an active material layer forming step of forming the active material layer and a solid electrolyte layer forming step of applying a slurry for a solid electrolyte layer onto the active material layer and drying the slurry to form the solid electrolyte layer on the active material layer, where a product of a filling rate of the active material layer and a volume ratio of the active material in the active material layer is 0.33 or more and 0.41 or less”. In addition, JP2019-109998A describes a method of applying a slurry or paste containing an active material, a solid electrolyte, and various additives onto a collector, carrying out drying, and then rolling to form an active material layer.

### SUMMARY OF THE INVENTION

In the active material layer formed of the solid particles (the inorganic solid electrolyte, the active material, the conductive auxiliary agent, and the like) described above, the interfacial contact state between the solid particles as well as the interfacial contact state between the solid particles and the collector are restricted, and as a result, the interface resistance tends to increase. In addition, the binding force between the solid particles as well as the binding force between the solid particles and the base material (the collector) is not sufficient. An all-solid state secondary battery having such an active material layer causes an increase in battery resistance as well as a deterioration of battery performance such as cycle characteristics. Therefore, in a case of producing an active material layer by using solid particles, a method or technique, in which from the stage of the electrode sheet, voids are reduced to firmly bind the solid particles (in a dense state) at a high filling rate, for example, by using a relatively large amount of binder in combination or pressing the active material layer, has been generally adopted so far. For example, JP2017-062939A (Examples) includes a step of pressing an active material layer formed of a 5% by mass of a binder, where a filling rate of the active material layer is set to 51% to 77%. In addition, JP2019-109998A says that in order to increase the density ratio of the active material layer, the active material layer may be subjected to a pressing step such as roll pressing after 5% by mass of a binder has been allowed to be contained in the active material layer in a production step of the active material layer. However, a binder exhibits electron-insulating properties and ion-insulating properties in a case where a relatively large amount of binder is used in combination, and thus the resistance is resultantly increased even in a case where the interfacial contact state of the solid particles can be improved.

By the way, in recent years, research and development for the performance improvement, the practical application, and the like of electric vehicles have progressed rapidly, and studies have been also carried out on the industrial manufacturing of all-solid state secondary batteries used therein, for example, continuous manufacturing such as a roll-to-roll method. In such an industrial manufacturing method, for example, a roll-to-roll method in which an active material layer is formed on a base material sheet while continuously supplying a long-shaped base material sheet wound around a roll to a production line, and the obtained electrode sheet is wound into a roll shape is suitably adopted. However, in a case of manufacturing an electrode sheet having an active material layer in which solid particles are bound at a high filling rate, by an industrial manufacturing method based on the above-described method or technique which is generally adopted, it was found that there is a problem that defects (cracking, breakage, chipping, and the like) in the active material layer due to the disintegration of binding of the solid particles during the transport in the production line and during the roll winding as well as peeling from a base material occur (transportability is inferior). However, JP2017-062939A and JP2019-109998A have not studied the suppression of the occurrence of disintegration of binding of solid particles during transport or the like.

An object of the present invention is to provide a sheet for an electrode, which realizes high transportability and is capable of suppressing the occurrence of defects in an active material layer precursor layer while suppressing an increase in resistance, even in a case of being applied to an industrial manufacturing method, and a manufacturing method therefor. In addition, another object of the present invention is to provide an all-solid state secondary battery and manufacturing methods for an electrode sheet and an all-solid state secondary battery, in which this sheet for an electrode is used.

As a result of diligent studies on a filling state of an active material layer, reduction of resistance, and transportability in an electrode sheet, the inventors of the present invention found that contrary to the methods or techniques that have been typically adopted so far, where solid particles are bound at a high filling rate to form an active material layer, a layer formed by causing the solid particles to adhere deliberately at a low filling rate (a sparse state) after a polymer binder of a small content has been allowed to be contained exhibits high transportability even in a case of being applied to an industrial manufacturing method. Moreover, it was found that in a case of pressing this layer formed by causing the solid particles to adhere at a low filling rate, in the manufacturing process of the all-solid state secondary battery, it can be converted into an active material layer in which the solid particles are bound at a high filling rate, and as a result, an all-solid state secondary battery having low resistance can be manufactured.

The present invention has been completed through further studies based on these findings. That is, the above problems have been solved by the following means.
<1> A sheet for an electrode, comprising:
an active material layer precursor layer containing an inorganic solid electrolyte having ion conductivity of a metal belonging to Group 1 or Group 2 in the periodic table, an active material, and a polymer binder,
in which the active material layer precursor layer is such that a content of the polymer binder is 3% by mass or less and a filling rate of 35% to 50% is exhibited.
<2> The sheet for an electrode according to <1>, in which the active material layer precursor layer has a layer thickness of 150 μm or more.
<3> The sheet for an electrode according to <1> or <2>, in which the inorganic solid electrolyte is a sulfide-based inorganic solid electrolyte.
<4> The sheet for an electrode according to any one of <1> to <3>, in which the inorganic solid electrolyte has a particle diameter of 0.1 to 2.5
<5> The sheet for an electrode according to any one of <1> to <4>, in which the active material layer precursor layer is a positive electrode active material layer precursor layer having a film density of 1.4 to 2.0 g/cm³.
<6> The sheet for an electrode according to any one of <1> to <4>, in which the active material layer precursor layer is a negative electrode active material layer precursor layer having a film density of 0.8 to 1.0 g/cm³.
<7> A manufacturing method for a sheet for an electrode, which is a method of manufacturing the sheet for an electrode according to any one of <1> to <6>, in which an electrode composition containing an inorganic solid electrolyte having ion conductivity of a metal belonging to Group 1 or Group 2 in the periodic table, an active material, a polymer binder, and a dispersion medium is applied onto a base material and dried to form an active material layer precursor layer, the manufacturing method comprising:
a step of setting a content of solid contents of the polymer binder to 3% by mass or less to prepare the electrode composition; and
a step of setting a filling rate of the active material layer precursor layer to 35% to 50%.

<8> A manufacturing method for an electrode sheet, which is a manufacturing method for an electrode sheet having an active material layer on a base material, the manufacturing method comprising:
pressing an active material layer precursor layer of a sheet for an electrode obtained by the manufacturing method for a sheet for an electrode according to <7>, to form an active material layer.
<9> A manufacturing method for an all-solid state secondary battery, which is a manufacturing method for an all-solid state secondary battery including a positive electrode active material layer, a solid electrolyte layer, and a negative electrode active material layer in this order, the manufacturing method comprising:
pressing and forming at least one of the positive electrode active material layer or the negative electrode active material layer in a state where a sheet for an electrode obtained by the manufacturing method for a sheet for an electrode according to <7> is superposed with a solid electrolyte layer or a solid electrolyte layer forming material.
<10> An all-solid state secondary battery manufactured by the manufacturing method for an all-solid state secondary battery according to <9>.

The present invention can provide a sheet for an electrode, which realizes high transportability and is capable of suppressing the occurrence of defects in an active material layer while suppressing an increase in resistance, even in a case of being applied to an industrial manufacturing method, and a manufacturing method therefor. In addition, another object of the present invention is to provide an all-solid state secondary battery and manufacturing methods for an electrode sheet and an all-solid state secondary battery, in which this sheet for an electrode is used.

The above-described and other characteristics and advantages of the present invention will be further clarified by the following description with appropriate reference to the accompanying drawing.

### BRIEF DESCRIPTION OF THE DRAWINGS

FIG. 1 is a vertical cross-sectional view schematically illustrating a sheet for an electrode according to a preferred embodiment of the present invention.

FIG. 2 is a vertical cross-sectional view schematically illustrating an all-solid state secondary battery according to a preferred embodiment of the present invention.

### DESCRIPTION OF THE PREFERRED EMBODIMENTS

In the present invention, a numerical value range indicated using “to” means a range including numerical values before and after the “to” as the lower limit value and the upper limit value. In a case where a plurality of numerical value ranges are set and described for the content, physical properties, and the like of a component in the present invention, the upper limit value and the lower limit value, which form each of the numerical value ranges, are not limited to a specific combination described before and after “to” as a specific numerical value range and can be set to a numerical value range obtained by appropriately combining the upper limit value and the lower limit value of each numerical value range.

In the present invention, the expression of a compound (for example, in a case where a compound is represented by an expression in which “compound” is attached to the end) refers to not only the compound itself but also a salt or an ion thereof. In addition, this expression also refers to a derivative obtained by modifying a part of the compound, for example, by introducing a substituent into the compound within a range where the effect of the present invention is not impaired.

In the present invention, (meth)acryl means one or both of acryl and methacryl. The same applies to (meth)acrylate.

In the present invention, a substituent, a linking group, or the like (hereinafter, referred to as a substituent or the like), which is not specified regarding whether to be substituted or unsubstituted, may have an appropriate substituent. Accordingly, even in a case where a YYY group is simply described in the present invention, this YYY group includes not only an aspect not having a substituent but also an aspect having a substituent. The same shall be applied to a compound that is not specified in the present specification regarding whether to be substituted or unsubstituted. Examples of the preferred examples of the substituent include a substituent Z described later.

In the present invention, in a case where a plurality of substituents or the like represented by a specific reference numeral are present or a plurality of substituents or the like are simultaneously or alternatively defined, the respective substituents or the like may be the same or different from each other. In addition, unless specified otherwise, in a case where a plurality of substituents or the like are adjacent to each other, the substituents may be linked or fused to each other to form a ring.

In the present invention, the polymer means a polymer; however, it has the same meaning as a so-called polymeric compound. In addition, a polymer binder (also simply referred to as a binder) means a binder composed of a polymer and includes a polymer itself and a binder composed (formed) by containing a polymer.

In the present invention, the sheet for an electrode includes a sheet for a positive electrode, which includes a positive electrode active material layer precursor layer of which the active material layer precursor layer is converted into a positive electrode active material layer of an all-solid state secondary battery, and a sheet for a negative electrode, which includes a negative electrode active material layer precursor layer which is converted into a negative electrode active material layer of an all-solid state secondary battery. In addition, similarly, the electrode sheet includes a positive electrode sheet including a positive electrode active material layer and a negative electrode sheet including a negative electrode active material layer.

In the present invention, a composition containing an inorganic solid electrolyte, an active material, and a dispersion medium and used as a material (an active material layer forming material) that forms an active material layer of an all-solid state secondary battery is referred to as an electrode composition for an all-solid state secondary battery or simply an electrode composition. On the other hand, a composition containing an inorganic solid electrolyte and used as a material that forms a solid electrolyte layer of an all-solid state secondary battery is referred to as an inorganic solid electrolyte-containing composition, where this composition generally does not contain an active material.

In the present invention, the electrode composition includes a positive electrode composition containing a positive electrode active material and a negative electrode composition containing a negative electrode active material. Therefore, any one of the positive electrode composition and the negative electrode composition, or collectively both of them may be simply referred to as an electrode composition, and any one of the positive electrode active material layer and the negative electrode active material layer, or collectively both of them may be simply referred to as an active material layer or an electrode active material layer. Further, in the present invention, any one of the positive electrode active material and the negative electrode active material, or collectively both of them may be simply referred to as an active material or an electrode active material.

### Sheet for Electrode

The sheet for an electrode according to the embodiment of the present invention is a sheet for an electrode, which includes an active material layer precursor layer containing an inorganic solid electrolyte having ion conductivity of a metal belonging to Group 1 or Group 2 in the periodic table, an active material, and a polymer binder, where the sheet for an electrode is suitably used as a material sheet for manufacturing an active material layer of an electrode sheet or an all-solid state secondary battery, or a laminate (an electrode) of a collector and an active material layer.

In this sheet for an electrode, the active material layer precursor layer is such that a content of the polymer binder is 3% by mass or less and a low filling rate of 35% to 50% is exhibited. A sheet for an electrode, which includes such an active material layer precursor layer, realizes high transportability and can suppress the occurrence of defects in an active material layer precursor layer while suppressing an increase in resistance, even in a case of being applied to an industrial manufacturing method, and in a case of including a base material, it can also suppress the peeling between the base material and the active material layer precursor layer. As a result, the sheet for an electrode is converted into an active material layer, whereby it is possible to suppress an increase in the resistance of the all-solid state secondary battery.

Although the details of the reason for the above are not yet clear, it is conceived to be as follows.

In the active material layer precursor layer of the sheet for an electrode, a content of the polymer binder is set to 3% by mass or less, and a filling rate described later is set to 35% to 50%, whereby the adhesion force of the solid particles can be maintained while suppressing the increase in resistance due to the incorporation of the polymer binder, and moreover, the flexibility is exhibited. As a result, the stress (for example, the compression stress or the elongation stress) that acts during transport, winding, or the like is relaxed to exhibit followability to bending well in an industrial manufacturing method, whereby it is possible to suppress the disintegration of adhesion of the solid particles while maintaining low resistance. Moreover, in a case of pressing the active material layer precursor layer in the manufacturing of the all-solid state secondary battery, it is possible to form a low-resistance active material layer, which has a filling rate that has been increased to a level required for the active material layer of the all-solid state secondary battery. As a result, it is conceived that the sheet for an electrode according to the embodiment of the present invention can be converted into an active material layer required for an all-solid state secondary battery by pressing, while making it possible to suppress the occurrence of defects in the active material layer precursor layer even in a case of being applied to an industrial manufacturing method, and it is possible to realize the suppression of the increase in resistance required for the all-solid state secondary battery.

The all-solid state secondary battery, in which an increase in resistance is suppressed, hardly causes overcurrent to occur during charging and discharging, can prevent the deterioration of solid particles, and has excellent cycle characteristics without significantly deteriorating battery characteristics even after repeated charging and discharging. On the other hand, it is conceived that an all-solid state secondary battery manufactured by using a sheet for an electrode having excellent transportability hardly causes defects to occur in the active material layer and thus can suppress the occurrence of the short circuit.

The sheet for an electrode preferably includes a base material, particularly a base material that functions as a collector of an all-solid state secondary battery. In this case, it is also possible to suppress the occurrence of the peeling between the active material layer precursor layer and the base material due to the disintegration of adhesion of the solid particles. In a case where the sheet for an electrode has a base material, the active material layer precursor layer is disposed on the base material directly or through another layer. Each of the active material layer precursor layer, the base material, and other layers, which constitute the sheet for an electrode, may have a monolayer structure or may have a multilayer structure as long as a specific function is exhibited.

The sheet for an electrode according to the embodiment of the present invention is not particularly limited in the configuration as long as it has the above-described configuration, and for example, a known configuration for an electrode sheet that is used in an all-solid state secondary battery can be employed. For example, the sheet for an electrode may have another layer in addition to each of the above-described layers. Examples of the other layer include a protective layer (a peeling sheet) and a coating layer.

The sheet for an electrode according to the embodiment of the present invention may be a single-sheet type sheet; however, it is preferably a long-sheet type sheet due to excellent transportability. In addition, in a case of being used in the manufacturing of the all-solid state secondary battery, the sheet for an electrode includes a sheet (a sheet material) cut into a predetermined shape, and examples thereof include those cut into a shape of a plate shape or a disk shape depending on the shape of the all-solid state secondary battery.

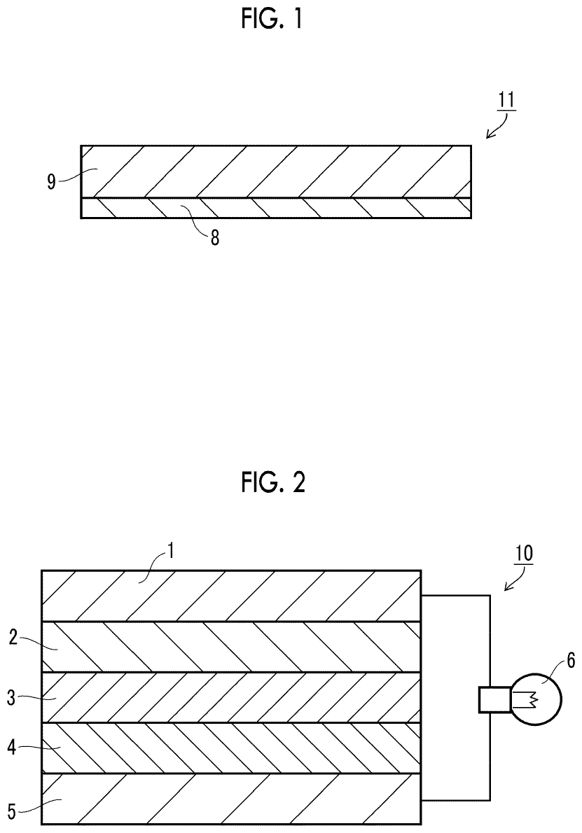

FIG. 1 schematically shows a preferred embodiment of the sheet for an electrode according to the embodiment of the present invention. This sheet 11 for an electrode has a structure in which a base material 8 and an active material layer precursor layer 9 are laminated in this order, and the base 8 and the active material layer precursor layer 9 each have a monolayer structure and are in contact with each other.

### Base Material

The base material of the sheet for an electrode is not particularly limited as long as it can support the active material layer precursor layer. Examples thereof include a sheet body (plate-shaped body) formed of a material described later regarding the collector, an organic material, and an inorganic material, where a material described regarding the collector is preferable. Examples of the organic materials include various polymers, and specific examples thereof include polyethylene terephthalate, polypropylene, polyethylene, and cellulose. Examples of the inorganic materials include glass and ceramic.

### Active Material Layer Precursor Layer

The active material layer precursor layer is a precursor layer that is converted into an active material layer of each of an electrode sheet and an all-solid state secondary battery by pressing, and it contains an inorganic solid electrolyte having ion conductivity of a metal belonging to Group 1 or Group 2 in the periodic table, an active material, and a polymer binder. Details of each component contained in the active material layer precursor layer will be described later.

This active material layer precursor layer exhibits a filling rate of 35% or more and 50% or less. In a case where the filling rate of the active material layer precursor layer is 50% or less, it is possible to realize high transportability of the sheet for an electrode while maintaining the battery characteristics (the suppression of the increase in resistance). On the other hand, in a case where the filling rate is 35% or more, it is possible to secure the strength (the strength as a self-supporting film) required for handling, transporting, or the like of the active material layer precursor layer. From the viewpoint that the active material layer precursor layer is capable of being converted into an active material layer having a low resistance and a high filling rate, in which solid particles are firmly bound, and can achieve both transportability and battery characteristics at a higher level, the filling rate of the active material layer precursor layer is preferably 35% to 48% and more preferably 38% to 46%.

In the present invention, the filling rate of the active material layer precursor layer shall be a value that is calculated according to the following expression from the film density (g/cm³) of the active material layer precursor layer and the true density (g/cm³) of the active material layer precursor layer.

Filling rate (%)=(film density/true density)×100

Here, the film density (g/cm³) of the active material layer precursor layer is a value obtained by dividing the mass of the active material layer precursor layer by the volume of the active material layer precursor layer, and it can be calculated according to the method and conditions described in Examples.

The true density (g/cm³) of the active material layer precursor layer means a density in which the volume of gaps that are generated between the solid particles constituting the active material layer precursor layer is not taken into consideration. This true density is a value obtained by dividing the mass of solid particles that constitute the active material layer precursor layer by the true volume of the solid particles, where the true density is calculated as the sum of products of the true density and the content rate, which are calculated for respective kinds of solid particles. The true density of the solid particles can be measured by a gas replacement method at 25° C. by using, for example, a density measuring device: BELPYCNO (product name, manufactured by MicrotracBEL Corp.). The true volume means a volume in which only the volume of the solid particles is taken into consideration, where the true volume means a volume in which the volume of gaps that are generated between the solid particles is not taken into consideration.

A method of setting the filling rate of the active material layer precursor layer within the above range will be described in the manufacturing method for a sheet for an electrode described later.

The active material layer precursor layer includes, in addition to the coated and dried layer itself that is obtained by subjecting an electrode composition described later to coating and drying, a layer that has been subjected to a treatment that is generally carried out on this coated and dried layer, for example, a precursor layer obtained by pressurizing (roll pressing or the like) a coated and dried layer within a range from which the filling rate does not deviate.

The film density of the active material layer precursor layer is not particularly limited and is appropriately set in consideration of the filling rate, the layer thickness, and the like. For example, it can be set to 0.8 to 2.2 g/cm³, and it can also be set to 0.8 to 2.0 g/cm³. It is preferably 1.4 to 2.2 g/cm³, and it is also preferably 1.4 to 2.0 g/cm³, in a case where the sheet for an electrode according to the embodiment of the present invention is a sheet for a positive electrode. On the other hand, in a case where the sheet for an electrode according to the embodiment of the present invention is a sheet for a negative electrode, the film density of the negative electrode active material layer precursor layer is preferably 0.8 to 1.0 g/cm³. A method of setting the film density of the active material layer precursor layer within the above range will be described in the manufacturing method for a sheet for an electrode described later.

The layer thickness (the film thickness) of the active material layer precursor layer is appropriately determined in consideration of the layer thickness of the active material layer of the all-solid state secondary battery, the amount of compression by pressing, and the like. It can be set to, for example, 10 to 1,000 μm, and it is preferably 50 to 500 μm and more preferably 100 to 300 μm. In the sheet for an electrode according to the embodiment of the present invention, it is also possible to increase the layer thickness in order for high transportability (bending resistance) to be exhibited. For example, it can be 100 μm or more, and it is preferably 150 μm or more and more preferably 200 μm or more. The upper limit value thereof is not particularly limited. It can be set to, for example, 1,000 μm or less, and it is preferably 500 μm or less and more preferably 300 μm or less.

Hereinafter, components that constitute the active material layer precursor layer will be described.

It is noted that the physical properties of the solid particles contained in the active material layer precursor layer are the same as the physical properties and the like of the solid particles that are used in the formation of the active material layer precursor layer, and the physical properties of the solid particles in the active material layer precursor layer can be appropriately set, for example, by adjusting the physical properties and the like of the solid particles to be used.

### Inorganic Solid Electrolyte

The electrode composition according to the embodiment of the present invention contains the inorganic solid electrolyte.

In the present invention, the inorganic solid electrolyte is an inorganic solid electrolyte, where the solid electrolyte refers to a solid-form electrolyte capable of migrating ions therein. The inorganic solid electrolyte is clearly distinguished from the organic solid electrolyte (the polymeric electrolyte such as polyethylene oxide (PEO) or the organic electrolyte salt such as lithium bis(trifluoromethanesulfonyl)imide (LiTFSI)) since it does not include any organic substance as a principal ion-conductive material. In addition, the inorganic solid electrolyte is solid in a steady state and thus, typically, is not dissociated or liberated into cations and anions. Due to this fact, the inorganic solid electrolyte is also clearly distinguished from inorganic electrolyte salts of which cations and anions are dissociated or liberated in electrolytic solutions or polymers (LiPF₆, LiBF₄, lithium bis(fluorosulfonyl)imide (LiFSI), LiCl, and the like). The inorganic solid electrolyte is not particularly limited as long as it has an ion conductivity of a metal belonging to Group 1 or Group 2 in the periodic table and generally does not have electron conductivity.

As the inorganic solid electrolyte contained in the electrode composition according to the embodiment of the present invention, a solid electrolyte material that is typically used for an all-solid state secondary battery can be appropriately selected and used. Examples of the inorganic solid electrolyte include (i) a sulfide-based inorganic solid electrolyte, (ii) an oxide-based inorganic solid electrolyte, (iii) a halide-based inorganic solid electrolyte, and (iv) a hydride-based inorganic solid electrolyte. A sulfide-based inorganic solid electrolyte is preferable from the viewpoint that it is possible to form a more favorable interface between the active material and the inorganic solid electrolyte as well as from the viewpoint that an active material layer having a high filling rate can be formed in the pressing in the manufacturing method for an all-solid state secondary battery described later.

In a case where the all-solid state secondary battery according to the embodiment of the present invention is a lithium ion battery, the inorganic solid electrolyte preferably has a lithium ion conductivity.

### (i) Sulfide-Based Inorganic Solid Electrolyte

The sulfide-based inorganic solid electrolyte is preferably an electrolyte that contains a sulfur atom, has an ion conductivity of a metal belonging to Group 1 or Group 2 in the periodic table, and has electron-insulating properties. The sulfide-based inorganic solid electrolytes are preferably inorganic solid electrolytes which contain, as elements, at least Li, S, and P and have a lithium ion conductivity; however, the sulfide-based inorganic solid electrolytes may appropriately include elements other than Li, S, and P.

Examples of the sulfide-based inorganic solid electrolyte include a lithium ion-conductive inorganic solid electrolyte satisfying the composition represented by Formula (S1).

Lₐ₁M_{b1}P_{c1}S_{d1}Aₑ₁ (S1)

In Formula (S1), L represents an element selected from Li, Na, or K and is preferably Li. M represents an element selected from B, Zn, Sn, Si, Cu, Ga, Sb, Al, or Ge. A represents an element selected from I, Br, Cl, or F. a1 to e1 represent the compositional ratios between the respective elements, and a1:b1:c1:d1:e1 satisfies 1 to 12:0 to 5:1:2 to 12:0 to 10. a1 is preferably 1 to 9 and more preferably 1.5 to 7.5. b1 is preferably 0 to 3 and more preferably 0 to 1. d1 is preferably 2.5 to 10 and more preferably 3.0 to 8.5. e1 is preferably 0 to 5 and more preferably 0 to 3.

The compositional ratios between the respective elements can be controlled by adjusting the amounts of raw material compounds blended to manufacture the sulfide-based inorganic solid electrolyte as described below.

The sulfide-based inorganic solid electrolytes may be non-crystalline (glass) or crystallized (made into glass ceramic) or may be only partially crystallized. For example, it is possible to use Li—P—S-based glass containing Li, P, and S or Li—P—S-based glass ceramic containing Li, P, and S.

The sulfide-based inorganic solid electrolytes can be manufactured by a reaction of at least two or more raw materials of, for example, lithium sulfide (Li₂S), phosphorus sulfide (for example, diphosphorus pentasulfide (P₂S₅)), a phosphorus single body, a sulfur single body, sodium sulfide, hydrogen sulfide, lithium halides (for example, LiI, LiBr, and LiCl), or sulfides of an element represented by M (for example, SiS₂, SnS, and GeS₂) described above.

The ratio of Li₂S to P₂S₅ in Li—P—S-based glass and Li—P—S-based glass ceramic is preferably 60:40 to 90:10 and more preferably 68:32 to 78:22 in terms of the molar ratio, Li₂S:P₂S₅. In a case where the ratio between Li₂S and P₂S₅ is set in the above-described range, it is possible to increase a lithium ion conductivity. Specifically, the lithium ion conductivity can be preferably set to 1×10′ S/cm or more and more preferably set to 1×10⁻³ S/cm or more. The upper limit is not particularly limited but practically 1×10⁻³ S/cm or less.

As specific examples of the sulfide-based inorganic solid electrolytes, combination examples of raw materials will be described below. Examples thereof include Li₂S—P₂S₅, Li₂S—P₂S₅—LiCl, Li₂S—P₂S₅—H₂S, Li₂S—P₂S₅—H₂S—LiCl, Li₂S—LiI—P₂S₅, Li₂S—LiI—Li₂O—P₂S₅, Li₂S—LiBr—P₂S₅, Li₂S—Li₂O—P₂S₅, Li₂S—Li₃PO₄—P₂S₅, Li₂S—P₂S₅—P₂O₅, Li₂S—P₂S₅—SiS₂, Li₂S—P₂S₅—SiS₂LiCl, Li₂S—P₂S₅—SnS, Li₂S—P₂S₅—Al₂S₃, Li₂S—GeS₂, Li₂S—GeS₂—ZnS, Li₂S—Ga₂S₃, Li₂S—GeS₂—Ga₂S₃, Li₂S—GeS₂—P₂S₅, Li₂S—GeS₂—Sb₂S₅, Li₂S—GeS₂—Al₂S₃, Li₂S—SiS₂, Li₂S—Al₂S₃, Li₂S—SiS₂—Al₂S₃, Li₂S—SiS₂—P₂S₅, Li₂S—Si_{S}2—P₂S₅—LiI, Li₂S—SiS₂—LiI, Li₂S—SiS₂—Li₄SiO₄, Li₂S—SiS₂—Li₃PO₄, and Li₁₀GeP₂S₁₂. The mixing ratio between the individual raw materials does not matter. Examples of the method of synthesizing a sulfide-based inorganic solid electrolyte material using the above-described raw material compositions include an amorphization method. Examples of the amorphization method include a mechanical milling method, a solution method, and a melting quenching method. This is because treatment can be carried out at a normal temperature, whereby it is possible to simplify manufacturing steps.

### (ii) Oxide-Based Inorganic Solid Electrolyte

The oxide-based inorganic solid electrolyte is preferably an electrolyte that contains an oxygen atom, has an ion conductivity of a metal belonging to Group 1 or Group 2 in the periodic table, and has electron-insulating properties.

The ion conductivity of the oxide-based inorganic solid electrolyte is preferably 1×10⁻⁶ S/cm or more, more preferably 5×10⁻⁶ S/cm or more, and particularly preferably 1×10⁻⁵ S/cm or more. The upper limit is not particularly limited; however, it is practically 1×10⁻³ S/cm or less.

Specific examples of the compound include LiₓₐLa_{ya}TiO₃ (LLT) [xa satisfies 0.3≤xa≤0.7, and ya satisfies 0.3≤ya≤0.7]; Li_{xb}La_{yb}Zr_{zb}M^{bb}_{mb}O_{nb} (M^{bb} is one or more elements selected from Al, Mg, Ca, Sr, V, Nb, Ta, Ti, Ge, In, and Sn, xb satisfies 5≤xb≤10, yb satisfies 1≤yb≤4, zb satisfies 1≤zb≤4, mb satisfies 0≤mb≤2, and nb satisfies 5≤nb≤20); Li_{xc}B_{yc}M^{cc}_{zc}O_{nc} (M^{cc} is one or more elements selected from C, S, Al, Si, Ga, Ge, In, and Sn, xc satisfies 0<xc ≤5, yc satisfies 0<yc≤1, zc satisfies 0<zc≤1, and nc satisfies 0<nc≤6); Li_{xd}(Al, Ga)_{yd}(Ti, Ge)_{zd}Si_{ad}P_{md}O_{nd} (xd satisfies 1≤xd≤3, yd satisfies 0≤yd≤1, zd satisfies 0≤zd≤2, ad satisfies 0≤ad≤1, md satisfies 1≤md≤7, and nd satisfies 3≤nd≤13.); Li₍₃₋₂ₓₑ₎M^{ee}ₓₑD^{ee}O (xe represents a number of 0 or more and 0.1 or less, and M^{ee} represents a divalent metal atom, D^{ee} represents a halogen atom or a combination of two or more halogen atoms); Li_{xf}Si_{yf}O_{zf} (xf satisfies 1≤xf ≤5, yf satisfies 0<yf≤3, zf satisfies 1≤zf≤10); Li_{xg}S_{yg}O_{zg} (xg satisfies 1≤xg≤3, yg satisfies 0<yg≤2, zg satisfies 1≤zg≤10); Li₃BO₃; Li₃BO₃—Li₂SO₄; Li₂O—B₂O₃—P₂O₅; Li₂O—SiO₂, Li₆BaLa₂Ta₂O₁₂; Li₃PO_{(4-3/2w)}N_{w} (w satisfies w<1); Li_{3.5}Zn_{0.25}GeO₄ having a lithium super ionic conductor (LISICON)-type crystal structure; La_{0.55}Li_{0.35}TiO₃ having a perovskite-type crystal structure; LiTi₂P₃O₁₂ having a natrium super ionic conductor (NASICON)-type crystal structure; Li_{1+xh+yg}(Al, Ga)ₓₕ(Ti, Ge)₂₋ₓₕSi_{yh}P_{3-yh}O₁₂ (xh satisfies 0≤xh≤1, and yh satisfies 0≤yh≤1); and Li₇La₃Zr₂O₁₂ (LLZ) having a garnet-type crystal structure. In addition, a phosphorus compound containing Li, P, or O is also desirable. Examples thereof include lithium phosphate (Li₃PO₄); LiPON in which a part of oxygen elements in lithium phosphate are substituted with a nitrogen element; and LiPOD¹ (D¹ is preferably one or more elements selected from Ti, V, Cr, Mn, Fe, Co, Ni, Cu, Zr, Nb, Mo, Ru, Ag, Ta, W, Pt, and Au).

Further, it is also possible to preferably use LiA¹ON (A¹ is one or more elements selected from Si, B, Ge, Al, C, and Ga).

### (iii) Halide-Based Inorganic Solid Electrolyte

The halide-based inorganic solid electrolyte is preferably a compound that contains a halogen atom, has an ion conductivity of a metal belonging to Group 1 or Group 2 in the periodic table, and has electron-insulating properties.

The halide-based inorganic solid electrolyte is not particularly limited; however, examples thereof include LiCl, LiBr, LiI, and compounds such as Li₃YBr₆ or Li₃YCl₆ described in ADVANCED MATERIALS, 2018, 30, 1803075. In particular, Li₃ YBr₆ or Li₃ YCl₆ is preferable.

### (iv) Hydride-Based Inorganic Solid Electrolyte

The hydride-based inorganic solid electrolyte is preferably a compound that contains a hydrogen atom, has an ion conductivity of a metal belonging to Group 1 or Group 2 in the periodic table, and has electron-insulating properties.

The hydride-based inorganic solid electrolyte is not particularly limited; however, examples thereof include LiBH₄, Li₄(BH₄)₃I, and 3LiBH₄—LiCl.

The inorganic solid electrolyte contained in the active material layer precursor layer of the sheet for an electrode according to the embodiment of the present invention preferably has a particle shape in the active material layer precursor layer. The shape of the particle is not particularly limited and may be a flat shape, an amorphous shape, or the like; however, a spherical shape or a granular shape is preferable.

In a case where the inorganic solid electrolyte has a particle shape, the particle diameter (volume average particle diameter) of the inorganic solid electrolyte is not particularly limited; however, it is preferably 0.01 μm or more, more preferably 0.1 μm or more, and still more preferably 0.5 μm or more. The upper limit is preferably 100 μm or less, more preferably 50 μm or less, still more preferably 10 μm or less, even still more preferably 5.0 μm or less, and particularly preferably 2.5 μm or less. In particular, in a case where the particle diameter is in a range of 0.1 to 2.5 μm, the transportability is excellent, and an increase in resistance can be effectively suppressed.

The particle diameter of the inorganic solid electrolyte is measured according to the following procedure. Using water (heptane in a case where the inorganic solid electrolyte is unstable in water), the particles of the inorganic solid electrolyte are diluted in a 20 mL sample bottle to prepare 1% by mass of a dispersion liquid. The diluted dispersion liquid sample is irradiated with 1 kHz ultrasonic waves for 10 minutes and is then immediately used for testing. Using this dispersion liquid sample, data collection is carried out 50 times by using a laser scattering-type particle size distribution analyzer LA-920 (product name, manufactured by Horiba Ltd.) and using a quartz cell for measurement at a temperature of 25° C. to obtain the volume average particle diameter. Other detailed conditions and the like can be found in Japanese Industrial Standards (JIS) Z8828: 2013 “Particle Diameter Analysis-Dynamic Light Scattering Method” as necessary. Five samples per level are produced and measured, and the average values thereof are employed.

The method of adjusting the particle diameter of the inorganic solid electrolyte that is used in the formation of the active material layer precursor layer is not particularly limited, and a known method can be applied. Examples thereof include a method using a normal pulverizer or a classifier. As the pulverizer or a classifier, for example, a mortar, a ball mill, a sand mill, a vibration ball mill, a satellite ball mill, a planetary ball mill, a swirling airflow-type jet mill, or a sieve is suitably used. During pulverization, it is possible to carry out wet-type pulverization in which water or a dispersion medium such as methanol is made to be present together. In order to provide the desired particle diameter, classification is preferably carried out. The classification is not particularly limited and can be carried out using a sieve, a wind power classifier, or the like. Both the dry-type classification and the wet-type classification can be carried out.

The true density (g/cm³) of the inorganic solid electrolyte contained in the active material layer precursor layer is not particularly limited and is set appropriately. From the viewpoint that the filling rate is easily set in the above range, the true density of the inorganic solid electrolyte is preferably 1 to 3 g/cm³ and more preferably 1.5 to 2.5 g/cm³. The true density of the inorganic solid electrolyte shall be a value measured according to the above-described gas replacement method. It is noted that the true volume (cm³) of the inorganic solid electrolyte is not particularly limited and is set appropriately.

The inorganic solid electrolyte contained in the active material layer precursor layer may be one kind or two or more kinds.

The content of the inorganic solid electrolyte in the active material layer precursor layer is not particularly limited and is appropriately determined. For example, it is preferably 50% by mass or more, more preferably 70% by mass or more, and particularly preferably 90% by mass or more, in the active material layer precursor layer (100% by mass) in terms of the total with the active material described later. From the same viewpoint, the upper limit thereof is preferably 99.9% by mass or less, more preferably 99.5% by mass or less, and particularly preferably 99% by mass or less.

In the present invention, in a case where the active material layer precursor layer contains two or more kinds of components of the inorganic solid electrolyte and the like, the content of each component shall be in terms of the total content thereof.

### Active Material

The active material layer precursor layer contains an active material capable of intercalating and deintercalating ions of a metal belonging to Group 1 or Group 2 in the periodic table.

Examples of such active materials include a positive electrode active material and a negative electrode active material, which will be described later.

An active material layer precursor layer containing the positive electrode active material may be referred to as a positive electrode active material layer precursor layer, and an active material layer precursor layer containing the negative electrode active material may be referred to as a negative electrode active material layer precursor layer.

### Positive Electrode Active Material

The positive electrode active material is an active material capable of intercalating and deintercalating an ion of a metal belonging to Group 1 or Group 2 of the periodic table, and it is preferably one capable of reversibly intercalating and deintercalating a lithium ion. The above-described material is not particularly limited as long as the material has the above-described characteristics and may be a transition metal oxide or an element, which is capable of being complexed with Li, such as sulfur or the like by disassembling the battery.

Among the above, as the positive electrode active material, transition metal oxides are preferably used, and transition metal oxides having a transition metal element M^{a} (one or more elements selected from Co, Ni, Fe, Mn, Cu, or V) are more preferable. In addition, an element M^{b} (an element of Group 1 (Ia) of the metal periodic table other than lithium, an element of Group 2 (Ha), or an element such as Al, Ga, In, Ge, Sn, Pb, Sb, Bi, Si, P, or B) may be mixed into this transition metal oxide. The mixing amount thereof is preferably 0% to 30% by mole of the amount (100% by mole) of the transition metal element M^{a}. It is more preferable that the transition metal oxide is synthesized by mixing the above components such that a molar ratio Li/M^{a} is 0.3 to 2.2.

Specific examples of the transition metal oxides include transition metal oxides having a bedded salt-type structure (MA), transition metal oxides having a spinel-type structure (MB), lithium-containing transition metal phosphoric acid compounds (MC), lithium-containing transition metal halogenated phosphoric acid compounds (MD), and lithium-containing transition metal silicate compounds (ME).

Specific examples of the transition metal oxides having a bedded salt-type structure (MA) include LiCoO2 (lithium cobalt oxide [LCO]), LiNi₂O₂ (lithium nickelate), LiNi_{0.85}Co_{0.10}Al_{0.05}O₂ (lithium nickel cobalt aluminum oxide [NCA]), LiNi_{1/3}Co_{1/3}Mn_{1/3}O₂ (lithium nickel manganese cobalt oxide [NMC]), and LiNi_{0.5}Mn_{0.5}O₂ (lithium manganese nickelate).

Specific examples of the transition metal oxides having a spinel-type structure (MB) include LiMn₂O₄ (LMO), LiCoMnO₄, Li₂FeMn₃O₈, Li₂CuMn₃O₈, Li₂CrMn₃O₈, and Li₂NiMn₃O₈.

Examples of the lithium-containing transition metal phosphoric acid compound (MC) include olivine-type iron phosphate salts such as LiFePO₄ and Li₃Fe₂(PO₄)₃, iron pyrophosphates such as LiFeP₂O₇, and cobalt phosphates such as LiCoPO₄, and a monoclinic NASICON type vanadium phosphate salt such as Li₃V₂(PO₄)₃ (lithium vanadium phosphate).

Examples of the lithium-containing transition metal halogenated phosphoric acid compound (MD) include iron fluorophosphates such as Li₂FePO₄F, manganese fluorophosphates such as Li₂MnPO₄F, cobalt fluorophosphates such as Li₂CoPO₄F.

Examples of the lithium-containing transition metal silicate compounds (ME) include Li₂FeSiO₄, Li₂MnSiO₄, and Li₂CoSiO₄.

In the present invention, the transition metal oxide having a bedded salt-type structure (MA) is preferable, and LCO or NMC is more preferable.

A positive electrode active material obtained using a baking method may be used after being washed with water, an acidic aqueous solution, an alkaline aqueous solution, or an organic solvent.

The positive electrode active material contained in the active material layer precursor layer preferably has a particle shape in the active material layer precursor layer. The shape of the particle is not particularly limited and may be a flat shape, an amorphous shape, or the like; however, a spherical shape or a granular shape is preferable. In a case where the positive electrode active material has a particle shape, the particle diameter (volume average particle diameter) of the positive electrode active material is not particularly limited; however, it is, for example, preferably 0.1 to 50 μm and more preferably 0.5 to 10 μm. The particle diameter of the positive electrode active material particle can be adjusted in the same manner as in the adjustment of the particle diameter of the inorganic solid electrolyte, and the particle diameter thereof can be measured by the same measuring method as the measuring method for the particle diameter of the inorganic solid electrolyte.

The true density (g/cm³) of the positive electrode active material contained in the active material layer precursor layer is not particularly limited and is set appropriately. From the viewpoint that the filling rate is easily set in the above range, the true density of the positive electrode active material is preferably 3 to 7 g/cm³ and more preferably 4 to 6 g/cm³. The true density of the positive electrode active material shall be a value measured according to the above-described gas replacement method. It is noted that the true volume (cm³) of the positive electrode active material is not particularly limited and is set appropriately.

The positive electrode active material contained in the active material layer precursor layer may be one kind or two or more kinds.

The content of the positive electrode active material in the active material layer precursor layer is not particularly limited and is appropriately determined. For example, it is preferably 10% to 97% by mass, more preferably 30% to 95% by mass, still more preferably 40% to 93% by mass, and particularly preferably 50% to 90% by mass in the active material layer precursor layer.

### Negative Electrode Active Material

The negative electrode active material is an active material capable of intercalating and deintercalating an ion of a metal belonging to Group 1 or Group 2 of the periodic table, and it is preferably one capable of reversibly intercalating and deintercalating a lithium ion. The material is not particularly limited as long as it has the above-described characteristics, and examples thereof include a carbonaceous material, a metal oxide, a metal composite oxide, a lithium single body, a lithium alloy, and a negative electrode active material that is capable of forming an alloy (capable of being alloyed) with lithium. Among the above, a carbonaceous material, a metal composite oxide, or a lithium single body is preferably used from the viewpoint of reliability. An active material that is capable of being alloyed with lithium is preferable since the capacity of the all-solid state secondary battery can be increased.

The carbonaceous material that is used as the negative electrode active material is a material substantially consisting of carbon. Examples thereof include petroleum pitch, carbon black such as acetylene black (AB), graphite (natural graphite, artificial graphite such as vapor-grown graphite), and carbonaceous material obtained by baking a variety of synthetic resins such as polyacrylonitrile (PAN)-based resins or furfuryl alcohol resins. Further, examples thereof also include a variety of carbon fibers such as PAN-based carbon fibers, cellulose-based carbon fibers, pitch-based carbon fibers, vapor-grown carbon fibers, dehydrated polyvinyl alcohol (PVA)-based carbon fibers, lignin carbon fibers, vitreous carbon fibers, and activated carbon fibers, mesophase microspheres, graphite whisker, and tabular graphite.

These carbonaceous materials can be classified into non-graphitizable carbonaceous materials (also referred to as “hard carbon”) and graphitizable carbonaceous materials based on the graphitization degree. In addition, it is preferable that the carbonaceous material has the surface spacing, density, and crystallite size described in JP1987-22066A (JP-S62-22066A), JP1990-6856A (JP-H2-6856A), and JP1991-45473A (JP-H3-45473A). The carbonaceous material is not necessarily a single material and, for example, may be a mixture of natural graphite and artificial graphite described in JP1993-90844A (JP-H5-90844A) or graphite having a coating layer described in JP1994-4516A (JP-H6-4516A).

As the carbonaceous material, hard carbon or graphite is preferably used, and graphite is more preferably used.

The oxide of a metal or a metalloid element that is applied as the negative electrode active material is not particularly limited as long as it is an oxide capable of intercalating and deintercalating lithium, and examples thereof include an oxide of a metal element (metal oxide), a composite oxide of a metal element or a composite oxide of a metal element and a metalloid element (collectively referred to as “metal composite oxide), and an oxide of a metalloid element (a metalloid oxide). The oxides are preferably noncrystalline oxides, and preferred examples thereof include chalcogenides which are reaction products between metal elements and elements in Group 16 of the periodic table. In the present invention, the metalloid element refers to an element having intermediate properties between those of a metal element and a non-metal element. Typically, the metalloid elements include six elements including boron, silicon, germanium, arsenic, antimony, and tellurium, and further include three elements including selenium, polonium, and astatine. In addition, “noncrystalline” represents an oxide having a broad scattering band with an apex in a range of 20° to 40° in terms of 2θ value in case of being measured by an X-ray diffraction method using CuKα rays, and the oxide may have a crystalline diffraction line. The highest intensity in a crystalline diffraction line observed in a range of 40° to 70° in terms of 2θ value is preferably 100 times or less and more preferably 5 times or less with respect to the intensity of a diffraction line at the apex in a broad scattering band observed in a range of 20° to 40° in terms of 2θ value, and it is particularly preferable that the oxide does not have a crystalline diffraction line.

In the compound group consisting of the noncrystalline oxides and the chalcogenides, noncrystalline oxides of metalloid elements and chalcogenides are more preferable, and (composite) oxides consisting of one element or a combination of two or more elements selected from elements (for example, Al, Ga, Si, Sn, Ge, Pb, Sb, and Bi) belonging to Groups 13 (IBB) to 15 (VB) in the periodic table or chalcogenides are particularly preferable. Specific examples of the preferred noncrystalline oxide and chalcogenide preferably include Ga₂O₃, GeO, PbO, PbO₂, Pb₂O₃, Pb₂O₄, Pb₃O₄, Sb₂O₃, Sb₂O₄, Sb₂O₈Bi₂O₃, Sb₂O₈Si₂O₃, Sb₂O₅, Bi₂O₃, Bi₂O₄, GeS, PbS, PbS₂, Sb₂S₃, and Sb₂S₅.

Suitable examples of the negative electrode active material which can be used in combination with a noncrystalline oxide containing Sn, Si, or Ge as a major component include a carbonaceous material capable of intercalating and/or deintercalating lithium ions or lithium metal, a lithium single body, a lithium alloy, and a negative electrode active material that is capable of being alloyed with lithium.

It is preferable that an oxide of a metal or a metalloid element, in particular, a metal (composite) oxide and the chalcogenide contain at least one of titanium or lithium as the constitutional component from the viewpoint of high current density charging and discharging characteristics. Examples of the metal composite oxide (lithium composite metal oxide) including lithium include a composite oxide of lithium oxide and the above metal (composite) oxide or the above chalcogenide, and specifically, Li₂SnO₂.

As the negative electrode active material, for example, a metal oxide (titanium oxide) having a titanium element is also preferable. Specifically, Li₄Ti₅O₁₂ (lithium titanate [LTO]) is preferable since the volume variation during the intercalation and deintercalation of lithium ions is small, and thus the high-speed charging and discharging characteristics are excellent, and the deterioration of electrodes is suppressed, whereby it becomes possible to improve the life of the lithium ion secondary battery.

The lithium alloy as the negative electrode active material is not particularly limited as long as it is typically used as a negative electrode active material for a secondary battery, and examples thereof include a lithium aluminum alloy, and specifically, a lithium aluminum alloy, using lithium as a base metal, to which 10% by mass of aluminum is added.

The negative electrode active material capable of forming an alloy with lithium is not particularly limited as long as it is usually used as a negative electrode active material for a secondary battery. Examples of such an active material include a (negative electrode) active material (an alloy or the like) having a silicon element or a tin element and a metal such as Al or In, a negative electrode active material (a silicon element-containing active material) having a silicon element capable of exhibiting high battery capacity is preferable, and a silicon element-containing active material in which the content of the silicon element is 50% by mole or more with respect to all the constitutional elements is more preferable.

In general, a negative electrode including the negative electrode active material (for example, a Si negative electrode including a silicon element-containing active material or an Sn negative electrode containing an active material containing a tin element) can intercalate a larger amount of Li ions than a carbon negative electrode (for example, graphite or acetylene black). That is, the amount of Li ions intercalated per unit mass increases. As a result, the battery capacity (the energy density) can be increased. As a result, there is an advantage in that the battery driving duration can be extended.

Examples of the silicon element-containing active material include a silicon-containing alloy (for example, LaSi₂, VSi₂, La—Si, Gd—Si, or Ni—Si) including a silicon material such as Si or SiOₓ (0<x≤1) and titanium, vanadium, chromium, manganese, nickel, copper, lanthanum, or the like or a structured active material thereof (for example, LaSi₂/Si), and an active material such as SnSiO₃ or SnSiS₃ including silicon element and tin element. In addition, since SiOₓ itself can be used as a negative electrode active material (a metalloid oxide) and Si is produced along with the operation of an all-solid state secondary battery, SiOₓ can be used as a negative electrode active material (or a precursor material thereof) capable of being alloyed with lithium.

Examples of the negative electrode active material including the tin element include Sn, SnO, SnO₂, SnS, SnS₂, and the above-described active material including the silicon element and the tin element. In addition, a composite oxide with lithium oxide, for example, Li₂SnO₂ can also be used.

In the present invention, the above-described negative electrode active material can be used without any particular limitation. From the viewpoint of battery capacity, a preferred aspect as the negative electrode active material is a negative electrode active material that is capable of being alloyed with lithium. Among them, the silicon material or the silicon-containing alloy (the alloy containing a silicon element) described above is more preferable, and it is still more preferable to include a negative electrode active material containing silicon (Si) or a silicon-containing alloy.

The negative electrode active material contained in the active material layer precursor layer preferably has a particle shape in the active material layer precursor layer. The shape of the particle is not particularly limited and may be a flat shape, an amorphous shape, or the like; however, a spherical shape or a granular shape is preferable. In a case where the negative electrode active material has a particle shape, the particle diameter (volume average particle diameter) of the negative electrode active material is not particularly limited; however, it is, for example, preferably 0.1 to 60 μm and more preferably 0.5 to 10 μm. The particle diameter of the negative electrode active material particle can be adjusted in the same manner as in the adjustment of the particle diameter of the inorganic solid electrolyte, and the particle diameter thereof can be measured by the same measuring method as the measuring method for the particle diameter of the inorganic solid electrolyte.

The true density (g/cm³) of the negative electrode active material contained in the active material layer precursor layer is not particularly limited and is set appropriately. From the viewpoint that the filling rate is easily set in the above range, the true density of the negative electrode active material is preferably 1 to 3 g/cm³ and more preferably 1.5 to 2.5 g/cm³. The true density of the negative electrode active material shall be a value measured according to the above-described gas replacement method. It is noted that the true volume (cm³) of the negative electrode active material is not particularly limited and is set appropriately.

The negative electrode active material contained in the active material layer precursor layer may be one kind or two or more kinds.

The content of the negative electrode active material in the active material layer precursor layer is not particularly limited and is appropriately determined. For example, it is preferably 10% to 90% by mass, more preferably 20% to 85% by mass, still more preferably 30% to 80% by mass, and even still more preferably 40% to 75% by mass in the active material layer precursor layer.

In the present invention, a negative electrode active material layer can be formed by charging a secondary battery. In this case, ions of a metal belonging to Group 1 or Group 2 in the periodic table produced in the all-solid state secondary battery can be used instead of the negative electrode active material. By bonding the ions to electrons and precipitating a metal, a negative electrode active material layer can be formed.

The chemical formulae of the compounds obtained by the above baking method can be calculated using an inductively coupled plasma (ICP) emission spectroscopy as a measuring method from the mass difference of powder before and after baking as a convenient method.

### Coating of Active Material

The surfaces of the positive electrode active material and the negative electrode active material may be subjected to surface coating with another metal oxide. Examples of the surface coating agent include metal oxides and the like containing Ti, Nb, Ta, W, Zr, Al, Si, or Li. Specific examples thereof include titanium oxide spinel, tantalum-based oxides, niobium-based oxides, and lithium niobate-based compounds, and specific examples thereof include Li₄Ti₅O₁₂, Li₂Ti₂O₅, LiTaO₃, LiNbO₃, LiAlO₂, Li₂ZrO₃, Li₂WO₄, Li₂TiO₃, Li₂B₄O₇, Li₃PO₄, Li₂MoO₄, Li₃BO₃, LiBO₂, Li₂CO₃, Li₂SiO₃, SiO₂, TiO₂, ZrO₂, Al₂O₃, and B₂O₃.

In addition, the surface of the electrode containing the positive electrode active material or negative electrode active material may be subjected to a surface treatment with sulfur or phosphorus.

Further, the particle surface of the positive electrode active material or negative electrode active material may be subjected to a surface treatment with an actinic ray or an active gas (plasma or the like) before and after the surface coating.

### Polymer Binder

The polymer binder contained in the electrode composition according to the embodiment of the present invention contains one kind or two or more kinds of the following polymer binders.

It is conceived that in the electrode composition described later, the polymer binder is adsorbed to the active material or the inorganic solid electrolyte or interposed between solid particles in a state of being dissolved or dispersed in a particle shape in a dispersion medium, thereby exhibiting a function of dispersing the active material or the inorganic solid electrolyte in the dispersion medium. On the other hand, it is conceived that in the active material layer precursor layer and the active material layer, the polymer binder functions as an adhesive or a binding agent, which is adsorbed to the active material or the inorganic solid electrolyte to be allowed to adhere mutually or to be bound mutually. Here, the adsorption of the polymer binder to the active material or the inorganic solid electrolyte is not particularly limited; however, it includes not only physical adsorption but also chemical adsorption (adsorption by chemical bond formation, adsorption by transfer of electrons, or the like). In addition, the polymer binder may also function as a binding agent that binds a collector to solid particles.

The polymer binder contained in the active material layer precursor layer may be present in any form in the active material layer precursor layer, and it may be in a state of being precipitated or solidified in a case of subjecting the electrode composition to coating and drying and may have a particle shape derived from the dispersed particles in the electrode composition.

### Polymer That Forms Polymer Binder

The polymer that forms the polymer binder is not particularly limited, and various polymers can be used. Among them, preferred examples thereof include a polymer having, in the main chain, at least one bond selected from a urethane bond, a urea bond, an amide bond, an imide bond, and an ester bond, or a polymerized chain of carbon-carbon double bonds. In the present invention, the polymerized chain of carbon-carbon double bonds refers to as a polymerized chain that is obtained by polymerizing carbon-carbon double bonds (ethylenically unsaturated groups), and specifically, it refers to a polymerized chain obtained by polymerizing (homopolymerizing or copolymerizing) a monomer having a carbon-carbon unsaturated bond.

In the present invention, a main chain of the polymer refers to a linear molecular chain in which all the molecular chains that constitute the polymer other than the main chain can be conceived as a branched chain or a pendant group with respect to the main chain. Although it depends on the mass average molecular weight of the molecular chain regarded as a branched chain or pendant chain, the longest chain among the molecular chains that constitute the polymer is typically the main chain. In this case, a terminal group at the polymer terminal is not included in the main chain. In addition, side chains of the polymer refer to molecular chains other than the main chain and include a short molecular chain and a long molecular chain.

The above bond is not particularly limited as long as it is contained in the main chain of the polymer, and it may have any aspect in which it is contained in the constitutional unit(the repeating unit) and/or an aspect in which it is contained as a bond that connects different constitutional units to each other. Further, the above-described bond contained in the main chain is not limited to one kind, it may be 2 or more kinds, and it is preferably 1 to 6 kinds and more preferably 1 to 4 kinds. In this case, the bonding mode of the main chain is not particularly limited. The main chain may randomly have two or more kinds of bonds and may be a main chain that is segmented to a segment having a specific bond and a segment having another bond.

The main chain having the above bond is not particularly limited. However, it is preferably a main chain that has at least one segment among the above bonds, more preferably a main chain consisting of polyamide, polyurea, polyurethane, and (meth)acrylic polymer, and still more preferably a main chain consisting of polyurethane or a (meth)acrylic polymer.

Examples of the polymer having, among the above bonds, a urethane bond, a urea bond, an amide bond, an imide bond, or an ester bond in the main chain include sequential polymerization (polycondensation, polyaddition, or addition condensation) polymers such as polyurethane, polyurea, polyamide, polyimide, and polyester, and copolymers thereof. The copolymer may be a block copolymer having each of the above polymers as a segment, or a random copolymer in which each constitutional component that constitutes two or more polymers among the above polymers is randomly bonded.

Examples of the polymer having a polymerized chain of carbon-carbon double bonds in the main chain include chain polymerization polymers such as a fluoropolymer (a fluorine-containing polymer), a hydrocarbon polymer, a vinyl polymer, and a (meth)acrylic polymer. The polymerization mode of these chain polymerization polymers is not particularly limited, and the chain polymerization polymer may be any of a block copolymer, an alternating copolymer, or a random copolymer.

The polymer that forms the above-described binder may be one kind or two or more kinds.

The polymer that forms the above-described binder preferably has a constitutional component represented by any one of Formulae (1-1) to (1-5) and more preferably has a constitutional component represented by Formula (1-1) or formula (1-2).

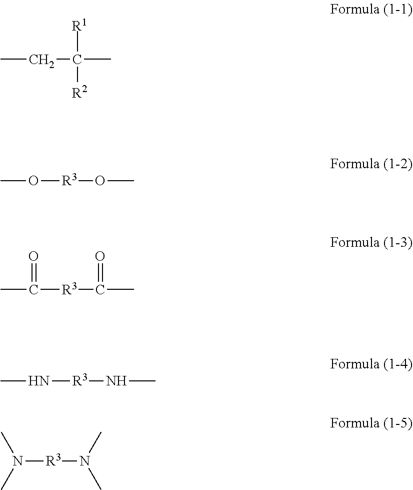

In Formula (1-1), R¹ represents a hydrogen atom or an alkyl group (preferably having 1 to 12 carbon atoms, more preferably 1 to 6 carbon atoms, and still more preferably 1 to 3 carbon atoms). The alkyl group that can be adopted as R¹ may have a substituent. The substituent is not particularly limited; however, examples thereof include a substituent Z described later. A group other than the functional group selected from the Group (a) of functional groups is preferable, and suitable examples thereof include a halogen atom.

R² represents a group having a hydrocarbon group having 4 or more carbon atoms. In the present invention, the group having a hydrocarbon group includes a group consisting of the hydrocarbon group itself (where the hydrocarbon group is directly bonded to the carbon atom in the above formula, to which R¹ is bonded) and a group consisting of a linking group (where a hydrocarbon group is bonded to the carbon atom in the above formula via a linking group, to which R¹ is bonded) that links the carbon atom in the above formula, to which R² is bonded, to a hydrocarbon group.

The hydrocarbon group is a group composed of a carbon atom and a hydrogen atom, and it is generally introduced at the end portion of R². The hydrocarbon group is not particularly limited; however, it is preferably an aliphatic hydrocarbon group, more preferably an aliphatic saturated hydrocarbon group (an alkyl group), and still more preferably a linear or branched alkyl group. It suffices that the hydrocarbon group has 4 or more carbon atoms, and the hydrocarbon group preferably has 6 or more carbon atoms and more preferably 8 or more carbon atoms, and it can be set to have 10 or more carbon atoms. The upper limit thereof is not particularly limited; however, it is preferably 20 or less, more preferably 18 or less, and still more preferably 14 or less.

The linking group is not particularly limited; however, examples thereof include an alkylene group (preferably having 1 to 12 carbon atoms, more preferably 1 to 6 carbon atoms, and still more preferably having 1 to 3 carbon atoms), an alkenylene group (preferably having 2 to 6 carbon atoms and more preferably having 2 or 3 carbon atoms), an arylene group (preferably having 6 to 24 carbon atoms and more preferably having 6 to 10 carbon atoms), an oxygen atom, a sulfur atom, an imino group (—NR^{N}—: R^{N} represents a hydrogen atom, an alkyl group having 1 to 6 carbon atoms or an aryl group having 6 to 10 carbon atoms), a carbonyl group, a phosphate linking group (—O—P(OH)(O)—O—), a phosphonate linking group (—P)(OH)(O)—O—), and a group involved in the combination thereof. It is also possible to form a polyalkyleneoxy chain by combining an alkylene group and an oxygen atom. The linking group is preferably a group composed of a combination of an alkylene group, an arylene group, a carbonyl group, an oxygen atom, a sulfur atom, and an imino group, more preferably a group composed of a combination of an alkylene group, an arylene group, a carbonyl group, an oxygen atom, and an imino group, still more preferably a group containing a —CO—O— group, a —CO—N(R^{N})— group (here, R^{N} is as described above), and particularly preferably a —CO—O— group or a —CO—N(R^{N})— group (here, R^{N} is as described above). The number of atoms that constitute the linking group and the number of linking atoms are as described later. However, the above does not apply to the polyalkyleneoxy chain that constitutes the linking group.

In the present invention, the number of atoms that constitute the linking group is preferably 1 to 36, more preferably 1 to 24, still more preferably 1 to 12, and particularly preferably 1 to 6. The number of linking atoms of the linking group is preferably 10 or less and more preferably 8 or less. The lower limit thereof is 1 or more. The number of linking atoms refers to the minimum number of atoms linking predetermined structural parts. For example, in a case of —CH₂—C(═O)—O—, the number of atoms that constitute the linking group is 6; however, the number of linking atoms is 3.

Each of the hydrocarbon group and the linking group may have or may not have a substituent. Examples of the substituent which may be contained therein include a substituent Z. A group other than the functional group selected from the group (a) of functional groups is preferable, and suitable examples thereof include a halogen atom.

In Formula (1-1), the carbon atom adjacent to the carbon atom to which R¹ is bonded has two hydrogen atoms; however, in the present invention, it may have one or two substituents. The substituent is not particularly limited; however, examples thereof include a substituent Z described later, and a group other than the functional group selected from the Group (a) of functional groups is preferable.

The compound from which a constitutional component represented by Formula (1-1) is derived is not particularly limited; however, examples thereof include a (meth)acrylic acid linear alkyl ester compound (here, linear alkyl means an alkyl group having 4 or more carbon atoms).

In Formula (1-2) to Formula (1-5), R³ represents a linking group having a mass average molecular weight of 500 or more and 200,000 or less, which contains a polybutadiene chain or a polyisoprene chain.

The terminal of the chain that can be adopted as R³ can be appropriately changed to a typical chemical structure that can be incorporated as R³ into the constitutional components represented by the above formulae.

In each of the formulae, R³ is a divalent molecular chain; however, it may be a trivalent or higher chain in which at least one hydrogen atom is substituted with —NH—CO—, —CO—, —O—, —NH—, or —N<.

Examples of the polybutadiene chain and the polyisoprene chain, which can be adopted as R³, include known chains respectively consisting of polybutadiene and polyisoprene as long as they satisfy the mass average molecular weight. Both the polybutadiene chain and the polyisoprene chain are diene polymers having double bonds in the main chain; however, in the present invention, they include a polymer in which double bonds are hydrogenated (reduced) (for example, a non-diene polymer which does not have double bonds in the main chain). In the present invention, a hydride of a polybutadiene chain or polyisoprene chain is preferable.

The polybutadiene chain and the polyisoprene chain preferably have a reactive group at the terminal thereof as a raw material compound, and more preferably have a polymerizable terminal reactive group. The polymerizable terminal reactive group forms a group that is bonded to R³ of each of the above formulae by polymerization. Examples of the terminal reactive group include a hydroxy group, a carboxy group, and an amino group. In particular, a hydroxy group is preferable. As the polybutadiene and the polyisoprene, which have a terminal reactive group, for example as product names, NISSO-PB series (manufactured by NIPPON SODA Co., Ltd.), Krasol series (manufactured by TOMOE Engineering Co., Ltd.), PolyVEST-HT series (manufactured by Evonik Industries AG), Poly-bd series (manufactured by Idemitsu Kosan Co., Ltd.), Poly-ip series (manufactured by Idemitsu Kosan Co., Ltd.), and EPOL (manufactured by Idemitsu Kosan Co., Ltd.) are suitably used.

The chain that can be adopted as R³ preferably has a mass average molecular weight (in terms of polystyrene conversion) of 500 to 200,000. The lower limit thereof is preferably 500 or more, more preferably 700 or more, and still more preferably 1,000 or more. The upper limit thereof is preferably 100,000 or less and more preferably 10,000 or less. The mass average molecular weight is measured by a method described later using a raw material compound before being incorporated into the main chain of the polymer.

The content of the constitutional component represented by any one of Formulae (1-1) to (1-5) in the polymer is not particularly limited; however, it is preferably 10% to 100% by mole. In terms of dispersion stability, bonding property, and the like, the content of the constitutional component represented by Formula (1-1) is more preferably 30% to 98% by mole and still more preferably 50% to 95% by mole. In terms of dispersion stability and the like, the content of the constitutional component represented by any one of Formulae (1-2) to (1-5) is more preferably 30% to 98% by mole and still more preferably 50% to 95% by mole. On the other hand, in terms of the improvement of bonding property, it is preferably 0% to 90% by mole, more preferably 10% to 80% by mole, and still more preferably 20% to 70% by mole.

### Constitutional Component Having Functional Group Selected From Group (a) of Functional Groups

The polymer that forms the polymer binder preferably contains a constitutional component having a functional group selected from the following Group (a) of functional groups as, for example, a substituent. The constitutional component having a functional group has a function of improving the adsorptivity of the binder with respect to the solid particles and may be any constitutional component that forms the polymer. The functional group may be incorporated into the main chain or the side chain of the polymer. In the case of being incorporated into the side chain, the functional group may be directly bonded to the main chain or may be bonded through the above-described linking group. The linking group is not particularly limited; however, examples thereof include a linking group described later.

### Group (a) of Functional Groups

A hydroxy group, an amino group, a carboxy group, a sulfo group, a phosphate group, a phosphonate group, a sulfanyl group, an ether bond (—O—), an imino group (═NR, or —NR—), an ester bond (—CO—O—), an amide bond (—CO—NR—), a urethane bond (—NR—CO—O—), a urea bond (—NR—CO—NR—), a heterocyclic group, an aryl group, and a carboxylic acid anhydride group

Each of the amino group, the sulfo group, the phosphate group (the phosphoryl group), the heterocyclic group, and the aryl group, which are included in the group (a) of functional groups, is not particularly limited; however, it has the same meaning as the corresponding group of the substituent Z described later. However, the amino group more preferably has 0 to 12 carbon atoms, still more preferably 0 to 6 carbon atoms, and particularly preferably 0 to 2 carbon atoms. The phosphonate group is not particularly limited; however, examples thereof include a phosphonate group having 0 to 20 carbon atoms. In a case where a ring structure contains an amino group, an ether bond, an imino group (—NR—), an ester bond, an amide bond, a urethane bond, a urea bond, or the like, it is classified as a heterocyclic ring. The hydroxy group, the amino group, the carboxy group, the sulfo group, the phosphate group, the phosphonate group, or the sulfanyl group may form a salt.

R in each bond represents a hydrogen atom or a substituent, and it is preferably a hydrogen atom. The substituent is not particularly limited. It is selected from a substituent Z described later, and an alkyl group is preferable.

The carboxylic acid anhydride group is not particularly limited; however, it includes a group obtained by removing one or more hydrogen atoms from a carboxylic acid anhydride (for example, a group represented by Formula (2a)), as well as a constitutional component itself (for example, a constitutional component represented by Formula (2b)) obtained by copolymerizing a polymerizable carboxylic acid anhydride as a copolymerizable compound. The group obtained by removing one or more hydrogen atoms from a carboxylic acid anhydride is preferably a group obtained by removing one or more hydrogen atoms from a cyclic carboxylic acid anhydride. The carboxylic acid anhydride group derived from a cyclic carboxylic acid anhydride also corresponds to a heterocyclic group; however, it is classified as a carboxylic acid anhydride group in the present invention. Examples thereof include acyclic carboxylic acid anhydrides such as acetic acid anhydride, propionic acid anhydride, and benzoic acid anhydride, and cyclic carboxylic acid anhydrides such as maleic acid anhydride, phthalic acid anhydride, fumaric acid anhydride, and succinic acid anhydride. The polymerizable carboxylic acid anhydride is not particularly limited; however, examples thereof include a carboxylic acid anhydride having an unsaturated bond in the molecule, and a polymerizable cyclic carboxylic acid anhydride is preferable. Specific examples thereof include maleic acid anhydride.

Examples of the carboxylic acid anhydride group include a group represented by Formula (2a) and a constitutional component represented by Formula (2b); however, the present invention is not limited thereto. In each of the formulae, * represents a bonding position.

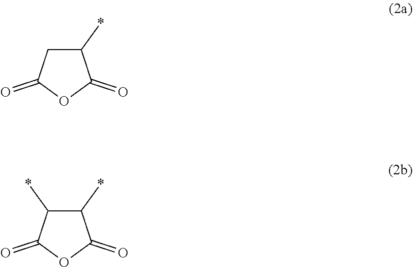 [SMILES: *C1CC(=O)OC1=O ; *C1C(=O)OC(=O)C1*]

In the sequential polymerization polymer, the ester bond (—CO—O—), the amide bond (—CO—NR—), the urethane bond (—NR—CO—O—), and the urea bond (—NR—CO—NR—) are represented by being divided into, a —CO— group and a —O— group, a —CO group and a —NR— group, a —NR—CO— group and a —O— group, and an —NR—CO— group and a —NR— group, respectively, in a case where the chemical structure of the polymer is represented by constitutional components derived from raw material compounds. As a result, in the present invention, the constitutional components having these bonds are regarded as constitutional components derived from the carboxylic acid compound or constitutional components derived from the isocyanate compound regardless of the notation of the polymer, and they do not include constitutional components derived from the polyol or polyamine compound.

In addition, in the chain polymerization polymer, the constitutional component having an ester bond (excluding an ester bond that forms a carboxy group) or an amide bond means a constitutional component in which an ester bond or an amide bond is not directly bonded to an atom that constitutes the main chain of a chain polymerization polymer or the main chain of a polymerized chain(for example, a polymerized chain contained in a macromonomer) that is incorporated into the chain polymerization polymer as a branched chain or a pendant chain, and it does not include, for example, a constitutional component derived from a (meth)acrylic acid alkyl ester.

In the present invention, an aspect in which the amino group, the ether bond, the imino group, the ester bond, the amide bond, the urethane bond, the urea bond, the heterocyclic group, and the aryl group are incorporated into a branched chain of the polymer is preferable.

The functional group contained in one constitutional component may be one kind or two or more kinds, and in a case where two or more kinds are contained, they may be or may not be bonded to each other. In addition, the number of functional groups contained in one constitutional component is not particularly limited and may be 1 or more, and it can be set to 1 to 4.

The linking group that binds a functional group to the main chain is not particularly limited; however, except for the particularly preferred linking group, it has the same meaning as the linking group in the group having a hydrocarbon group having 4 or more carbon atoms, which can be adopted as R² of Formula (1-1). As the linking group that binds a functional group to the main chain, a particularly preferred linking group is a group obtained by combining a —CO—O— group or —CO—N(R^{N})— group (here, RN is as described above) and an alkylene group or polyalkyleneoxy chain.

The constitutional component having the above-described functional group is not particularly limited as long as it has the above functional group. However, examples thereof include a constitutional component into which the above functional group is introduced into a constitutional component represented by any one of Formula (1-1) to Formula (1-5), a constitutional component into which the above functional group is introduced into a constitutional component represented by Formula (I-1) or Formula (I-2) described later, into a constitutional component derived from a compound represented by Formula (I-5) described later, into a constitutional component represented by Formula (I-3) or Formula (I-4) described later, or into a constitutional component derived from a compound represented by Formula (I-6), and furthermore, a constitutional component into which the above functional group is introduced into a (meth)acrylic compound (M1) or another polymerizable compound (M2) described later or into a constitutional component represented by any one of Formula (b-1) to Formula (b-3) described later.

The compound from which the constitutional component having the above-described functional group is derived is not particularly limited; however, examples thereof include a compound in which the above functional group is introduced into a (meth)acrylic acid short-chain alkyl ester compound (here, short-chain alkyl means an alkyl group having 3 or less of carbon atoms).

The content of the constitutional component having the above-described functional group in the polymer is not particularly limited.

The content thereof in the sequential polymerization polymer is preferably 0.01% to 50% by mole, more preferably 0.1% to 50% by mole, and still more preferably 0.3% to 50% by mole, in terms of the dispersion characteristics, the bonding property, and the like of the solid particles. The content thereof in the chain polymerization polymer is preferably 0.01% to 80% by mole, more preferably 0.01% to 70% by mole, still more preferably 0.1% to 50% by mole, particularly preferably 0.3% to 50% by mole, and most preferably 3% to 20% by mole, in terms of the dispersion characteristics, the bonding property, and the like of the solid particles. In the sequential polymerization polymer and the chain polymerization polymer, the lower limit value of the content can be 5% by mole or more or 20% by mole or more.

### Sequential Polymerization Polymer

The sequential polymerization polymer as a polymer that forms the above-described binder preferably has a constitutional component having a functional group selected from the Group (a) of functional groups described above or a constitutional component represented by any one of Formula (1-2) to Formula (1-5), and furthermore, it may have a constitutional component different from these constitutional components. Among the constitutional components shown below, the constitutional component represented by Formula (I-1) or Formula (I-2) and the constitutional component derived from the compound represented by Formula (I-5) correspond to the constitutional component having a functional group selected from the Group (a) of functional groups; however, they will be described together with other constitutional components. Examples of the other constitutional components include a constitutional component represented by Formula (I-1) or (I-2) and furthermore, a constitutional component obtained by sequentially polymerizing one or more kinds (preferably 1 to 8 kinds and more preferably 1 to 4 kinds) of constitutional components represented by Formula (I-3) or (I-4) or a carboxylic acid dianhydride represented by Formula (I-5) with a diamine compound from which a constitutional component represented by Formula (I-6) is derived. The combination of each of the constitutional components is appropriately selected depending on the kind of polymer. One kind of constitutional component that is used in the combination of the constitutional components refers to the constitutional component represented by any one of the following formulae. Even in a case where two kinds of constitutional components represented by one of the following formulae are contained, it is not interpreted as two constitutional components.

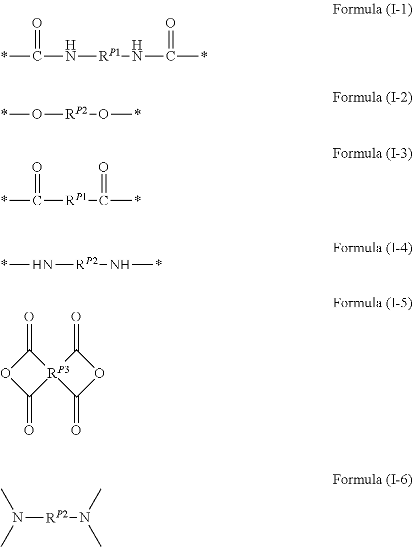

In the formulae, R^{P1} and R^{P2} each independently represent a molecular chain having a (mass-average) molecular weight of 20 to 200,000. The molecular weight of the molecular chain cannot be unambiguously determined because it depends on the kind thereof and the like, and is, for example, preferably 30 or higher, more preferably 50 or higher, still more preferably 100 or higher, and still more preferably 150 or higher. The upper limit thereof is preferably 100,000 or less and more preferably 10,000 or less. The molecular weight of the molecular chain is measured for a raw material compound before being incorporated into the main chain of the polymer.

The molecular chain which can be adopted as R^{P1} and R^{P2} is not particularly limited and is preferably a hydrocarbon chain, a polyalkylene oxide chain, a polycarbonate chain, or a polyester chain, more preferably a hydrocarbon chain or a polyalkylene oxide chain, and still more preferably a hydrocarbon chain, a polyethylene oxide chain, or a polypropylene oxide chain.

The hydrocarbon chain which can be adopted as R^{P1} and R^{P2} means a chain of hydrocarbon including a carbon atom and a hydrogen atom, and more specifically means a structure in which at least two atoms (for example, hydrogen atoms) or a group (for example, a methyl group) is desorbed from the compound including a carbon atom and a hydrogen atom. However, in the present invention, the hydrocarbon chain also includes a chain that includes a group having an oxygen atom, a sulfur atom, or a nitrogen atom in the chain, for example, as in a hydrocarbon group represented by Formula (M2). A terminal group that may be present in a terminal of the hydrocarbon chain is not included in the hydrocarbon chain. This hydrocarbon chain may include a carbon-carbon unsaturated bond or may include a ring structure of an aliphatic ring and/or an aromatic ring. That is, the hydrocarbon chain may be a hydrocarbon chain including a hydrocarbon selected from an aliphatic hydrocarbon or an aromatic hydrocarbon.

It suffices that such a hydrocarbon chain satisfies the above molecular weight, and the hydrocarbon chain includes a double hydrocarbon chain including a chain consisting of a hydrocarbon group having a low molecular weight and a hydrocarbon chain (also referred to as the “hydrocarbon polymer chain”) consisting of a hydrocarbon polymer.

The hydrocarbon chain having a low molecular weight is a chain consisting of a typical (non-polymerizable) hydrocarbon group, and examples of the hydrocarbon group include an aliphatic or aromatic hydrocarbon group. Specifically, an alkylene group (having preferably 1 to 12 carbon atoms, more preferably 1 to 6 carbon atoms, and still more preferably 1 to 3 carbon atoms), an arylene group (having preferably 6 to 22 carbon atoms, more preferably 6 to 14 carbon atoms, and still more preferably 6 to 10 carbon atoms), or a group consisting of a combination of the above-described groups is preferable. As the hydrocarbon group that forms the hydrocarbon chain having a low molecular weight which can be adopted as R^{P2}, an alkylene group is more preferable, an alkylene group having 2 to 6 carbon atoms is still more preferable, and an alkylene group having 2 or 3 carbon atoms is still more preferable. This hydrocarbon chain may have a polymerized chain (for example, a (meth)acrylic polymer) as a substituent.

The aliphatic hydrocarbon group is not particularly limited, and examples thereof include a hydrogen reduced form of an aromatic hydrocarbon group represented by Formula (M2) and a partial structure (for example, a group consisting of isophorone) in a known aliphatic diisocyanate compound.

Examples of the aromatic hydrocarbon group include a hydrocarbon group contained in each of the exemplary constitutional components described below, and an arylene group (for example, a group obtained by removing one or more hydrogen atoms from the aryl group mentioned in the substituent Z described later; specifically, a phenylene group, a tolylene group, or a xylylene group) or a hydrocarbon group represented by Formula (M2) is preferable.

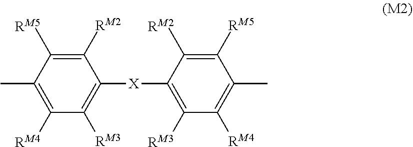

In Formula (M2), X represents a single bond, —CH₂—, —C(CH₃)₂—, —SO₂—, —S—, —CO—, or —O— and is preferably —CH₂— or —O—, and more preferably —CH₂— from the viewpoint of bonding property. The alkylene group and the methyl group, which are exemplified herein, may be substituted with a substituent Z and preferably a halogen atom (more preferably a fluorine atom).

R^{M2} to R^{M5} each independently represent a hydrogen atom or a substituent and preferably a hydrogen atom. The substituent which can be adopted as R^{M2} to R^{M5} is not particularly limited; however, examples thereof include an alkyl group having 1 to 20 carbon atoms, an alkenyl group having 1 to 20 carbon atoms, —OR^{M6}, —N(R^{M6})₂, —SR^{M6} (R^{M6} represents a substituent and preferably an alkyl group having 1 to 20 carbon atoms or an aryl group having 6 to 10 carbon atoms), and a halogen atom (for example, a fluorine atom, a chlorine atom, or a bromine atom). Examples of —N(R^{M6})₂ include an alkylamino group (having preferably 1 to 20 carbon atoms and more preferably 1 to 6 carbon atoms) and an arylamino group (having preferably 6 to 40 carbon atoms and more preferably 6 to 20 carbon atoms).

The hydrocarbon polymer chain is not particularly limited as long as it is a polymer chain obtained by polymerizing (at least two) polymerizable hydrocarbons and a chain consisting of a hydrocarbon polymer having a larger number of carbon atoms than the above-described hydrocarbon chain having a low molecular weight; however, it is preferably a chain consisting of a hydrocarbon polymer consisting of 30 or more carbon atoms and more preferably 50 or more carbon atoms. The upper limit of the number of carbon atoms that constitute the hydrocarbon polymer is not particularly limited and may be, for example, 3,000. The hydrocarbon polymer chain is preferably a chain consisting of a hydrocarbon polymer composed of an aliphatic hydrocarbon in which the main chain satisfies the above-described number of carbon atoms and more preferably a chain consisting of a polymer (preferably an elastomer) composed of an aliphatic saturated hydrocarbon or an unsaturated aliphatic hydrocarbon. Specific examples of the polymer include a diene polymer having double bonds in the main chain and a non-diene polymer not having double bonds in the main chain. Examples of the diene polymer include a styrene-butadiene copolymer, a styrene-ethylene-butadiene copolymer, a copolymer (preferably butyl rubber (IIR)) of isobutylene and isoprene, and an ethylene-propylene-diene copolymer. Examples of the non-diene polymer include an olefin polymer such as an ethylene-propylene copolymer or a styrene-ethylene-butylene copolymer and a hydrogen reduced form of the above-described diene polymer.

The hydrocarbon forming the hydrocarbon chain preferably has a reactive group at a terminal and more preferably has a terminal reactive group capable of polycondensation. The terminal reactive group capable of polycondensation or polyaddition forms a group bonded to R^{P1} or R^{P2} in each of the formulae by polycondensation or polyaddition. Examples of the terminal reactive group include an isocyanate group, a hydroxy group, a carboxy group, an amino group, and an acid anhydride. In particular, a hydroxy group is preferable.

As the hydrocarbon polymer having a terminal reactive group, for example as product names, NISSO-PB series (manufactured by NIPPON SODA Co., Ltd.), Krasol series (manufactured by TOMOE Engineering Co., Ltd.), PolyVEST-HT series (manufactured by Evonik Industries AG), Poly-bd series (manufactured by Idemitsu Kosan Co., Ltd.), Poly-ip series (manufactured by Idemitsu Kosan Co., Ltd.), EPOL (manufactured by Idemitsu Kosan Co., Ltd.), and POLYTAIL series (manufactured by Mitsubishi Chemical Corporation) are suitably used.

Examples of the polyalkylene oxide chain (the polyalkyleneoxy chain) include a chain consisting of a known polyalkyleneoxy group. The number of carbon atoms in the alkyleneoxy group of the polyalkyleneoxy chain is preferably 1 to 10, more preferably 1 to 6, and still more preferably 2 or 3 (a polyethyleneoxy chain or a polypropyleneoxy chain). The polyalkyleneoxy chain may be a chain consisting of one alkyleneoxy group or may be a chain consisting of two or more alkyleneoxy groups (for example, a chain consisting of an ethyleneoxy group and a propyleneoxy group).

Examples of the polycarbonate chain or the polyester chain include a chain consisting of a known polycarbonate or polyester.

It is preferable that the polyalkyleneoxy chain, the polycarbonate chain, or the polyester chain includes an alkyl group (having preferably 1 to 12 carbon atoms and more preferably 1 to 6 carbon atoms) at a terminal.

The terminal of the polyalkyleneoxy chain, the polycarbonate chain, or the polyester chain, which can be adopted as R^{P1} and R^{P2}, can be appropriately changed to a typical chemical structure that can be incorporated into the constitutional component represented by each of the formulae as R^{P1} and R^{P2}. For example, a polyalkyleneoxy chain from which the terminal oxygen atom has been removed is incorporated as R^{P1} or R^{P2} of the above constitutional component. In the alkyl group in the molecular chain or at a terminal thereof, an ether group (—O—), a thioether group (—S—), a carbonyl group (>C═O), or an imino group (>NR^{N}: R^{N} represents a hydrogen atom, an alkyl group having 1 to 6 carbon atoms, or an aryl group having 6 to 10 carbon atoms) may be present.

In each of the formulae, R^{P1} and R^{P2} represent a divalent molecular chain but may represent a trivalent or higher molecular chain in which at least one hydrogen atom is substituted with —NH—CO—, —CO—, —O—, —NH—, or —N<.

Among the above molecular chains, R^{P1} is preferably a hydrocarbon chain, more preferably a hydrocarbon chain having a low molecular weight, still more preferably a hydrocarbon chain consisting of an aliphatic or aromatic hydrocarbon group, and particularly preferably a hydrocarbon chain consisting of an aliphatic hydrocarbon group.

Among the above molecular chains, R^{P2} is preferably a low molecular weight hydrocarbon chain (more preferably an aliphatic hydrocarbon group) or a molecular chain other than the hydrocarbon chain having a low molecular weight (more preferably, a polyalkylene oxide chain).

Specific examples of the constitutional component represented by Formula (I-1) are shown below and in the exemplary polymer described later. Examples of the raw material compound (the diisocyanate compound) from which the constitutional component represented by Formula (I-1) is derived include the diisocyanate compound represented by Formula (M1) described in WO2018/020827A and the specific example thereof and further include a polymeric 4,4′-diphenylmethane diisocyanate. In the present invention, the constitutional component represented by Formula (I-1) and the raw material compound derived from the constitutional component are not limited to those described in the following specific examples and the above documents.

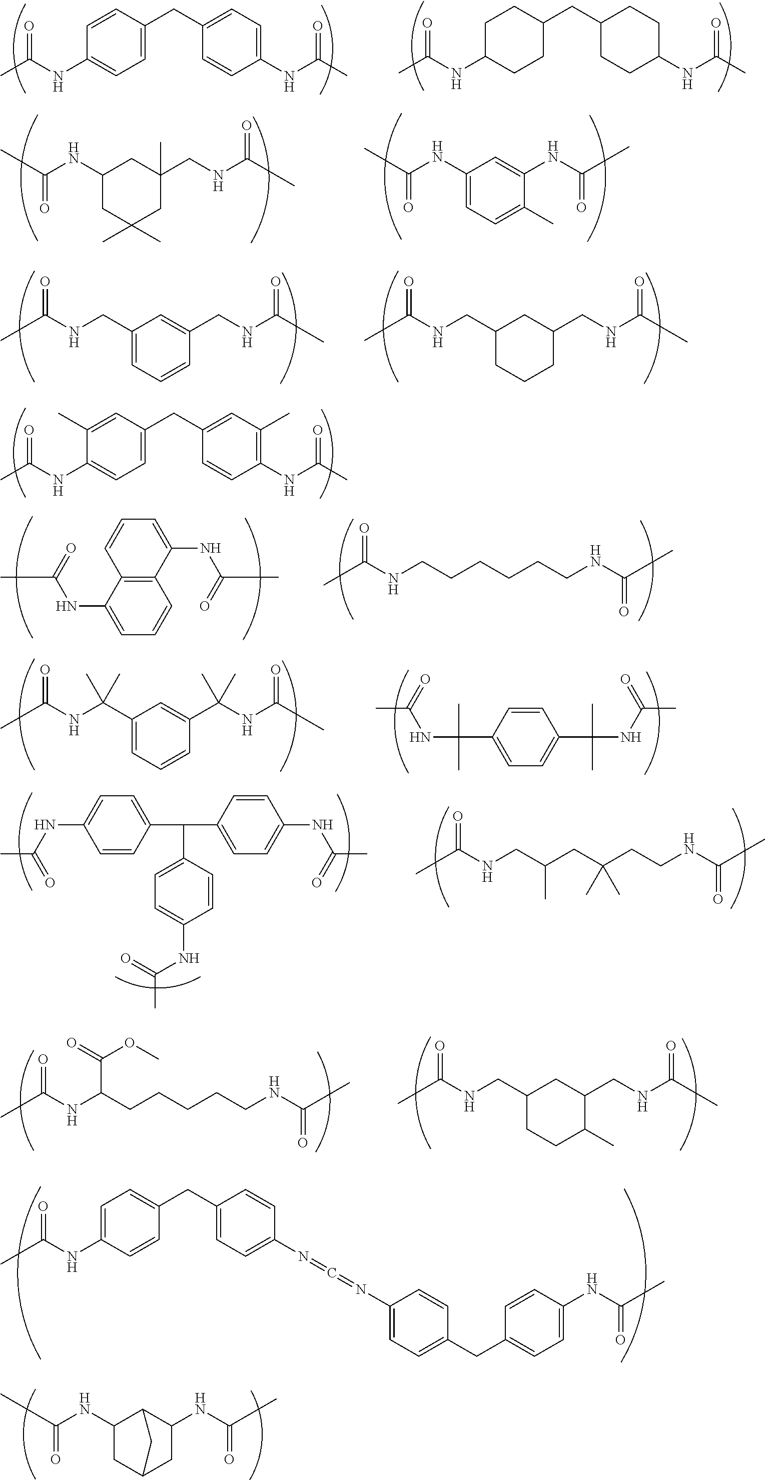

The raw material compound (a carboxylic acid, an acid chloride thereof, or the like) from which the constitutional components represented by Formula (I-2) are derived is not particularly limited, and examples of the raw material compound include the carboxylic acid or the compound of the acid chloride, and the specific examples thereof (for example, adipic acid or an esterified product thereof), which are described in paragraph of WO2018/020827A.

Specific examples of the constitutional components represented by Formula (1-3) or Formula (1-4) are shown below and in Examples. The raw material compound (the diol compound or the diamine compound) from which the constitutional component represented by Formula (I-3) or Formula (I-4) is derived is not particularly limited. Examples thereof include the respective compounds and the specific examples thereof, which are described in WO2018/020827A, and further include dihydroxyoxamide. In the present invention, the constitutional components represented by Formula (I-3) or Formula (I-4) and the raw material compounds from which the compounds are derived are not limited to those described in the following specific examples, the exemplary polymer described later, and those described in the above documents.

In the following specific examples, in a case where the constitutional component has a repeating structure, the repetition number is an integer of 1 or more and is appropriately set within a range that satisfies the molecular weight or the number of carbon atoms of the molecular chain.

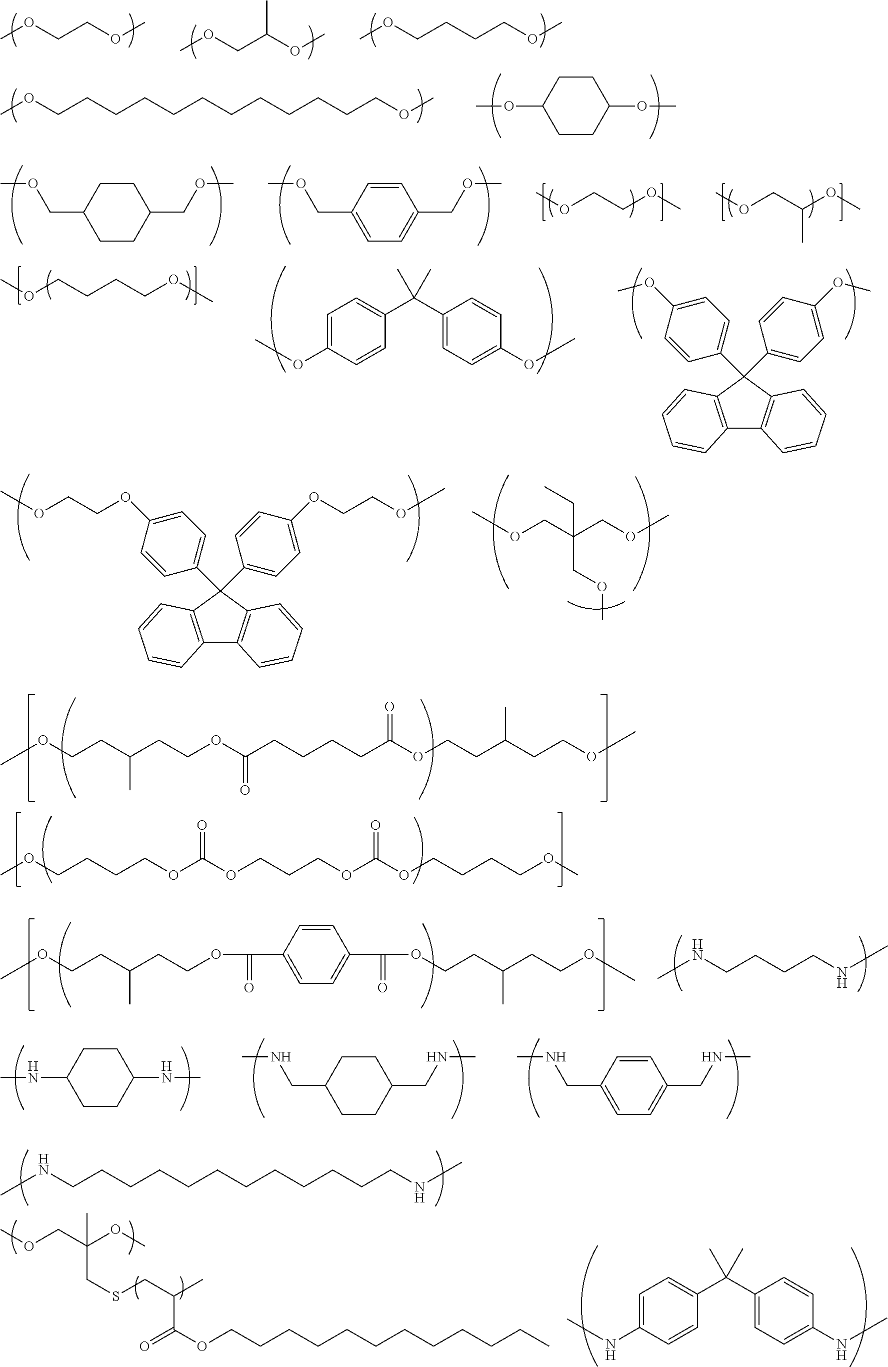

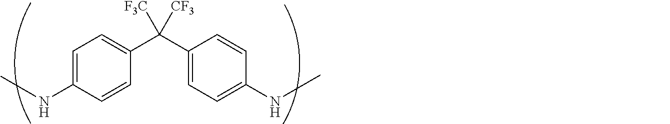

In Formula (I-5), R^{P3} represents an aromatic or aliphatic linking group (tetravalent) and preferably a linking group represented by any one of Formulae (i) to (iix).

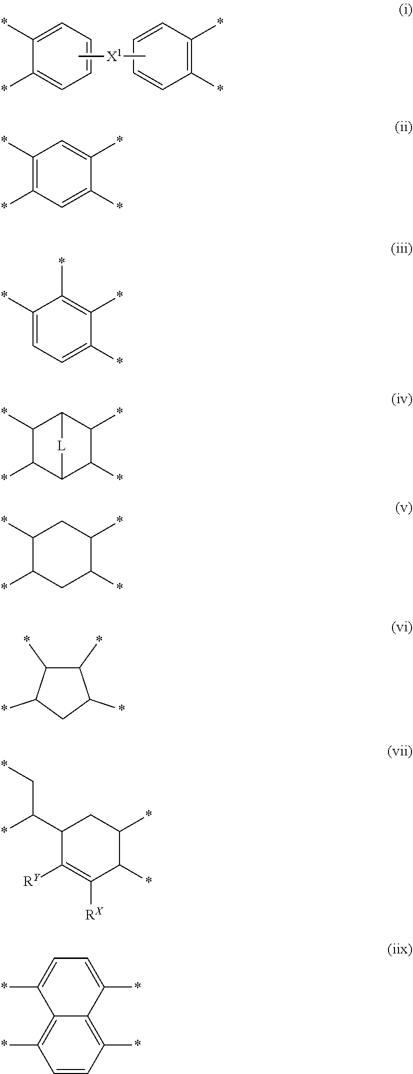

In Formulae (i) to (iix), X¹ represents a single bond or a divalent linking group. As the divalent linking group, an alkylene group having 1 to 6 carbon atoms (for example, methylene, ethylene, or propylene) is preferable. The propylene is preferably 1,3-hexafluoro-2,2-propanediyl. L represents —CH₂═CH₂— or —CH₂—. R^{X} and R^{Y} each independently represent a hydrogen atom or a substituent. In each of the formulae, * represents a binding portion to the carbonyl group in Formula (I-5). The substituent that can be adopted as R^{X} and R^{Y} is not particularly limited, and examples thereof include the substituent Z described below. In particular, an alkyl group (having preferably 1 to 12 carbon atoms, more preferably 1 to 6 carbon atoms, still more preferably 1 to 3 carbon atoms) or an aryl group (having preferably 6 to 22 carbon atoms, more preferably 6 to 14 carbon atoms, still more preferably 6 to 10 carbon atoms) is preferable.

The carboxylic acid dianhydride represented by Formula (I-5) and the raw material compound (the diamine compound) from which the constitutional components represented by Formula (I-6) are respectively derived are not particularly limited, and examples thereof include the respective compounds and the specific examples thereof, which are described in WO2018/020827A and WO2015/046313A.

R^{P1}, R^{P2}, and R^{P3} may each independently have a substituent. The substituent is not particularly limited, and examples thereof include the substituent Z described below or each group included in the Group (a) of functional groups described above. In particular, suitable examples thereof include the substituent that can be adopted as R^{M2}.

In a case where the polymer that forms the above-described binder is a sequential polymerization polymer, it may have a constitutional component represented by any one of Formulae (1-1) to (1-5) described above, preferably a constitutional component having a functional group selected from the Group (a) of functional groups (including a constitutional component represented by Formula (I-1)), and may further have a constitutional component represented by Formula (I-3), formula (I-4), or formula (I-5). Examples of the constitutional component represented by Formula (I-3) include a constitutional component represented by at least one of Formula (I-3A) to Formula (I-3C). The case of the constitutional component represented by Formula (I-3) applies similarly to the constitutional component represented by Formula (I-4) as well; however, in each of Formula (I-3A) to Formula (I-3C), the oxygen atom is substituted with a nitrogen atom.

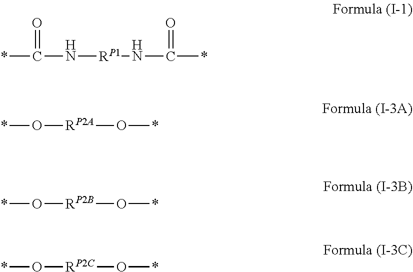

In Formula (I-1), R^{P1} is as described above. In formula (I-3A), R^{P2A} represents a chain consisting of a hydrocarbon group having a low molecular weight (preferably, an aliphatic hydrocarbon group). In Formula (I-3B), R^{P2B} represents a polyalkyleneoxy chain. In Formula (I-3C), R^{P2C} represents a hydrocarbon polymer chain. The chain consisting of a hydrocarbon group having a low molecular weight, which can be adopted as R^{P2A}, the polyalkyleneoxy chain which can be adopted as R^{P2C}, and the hydrocarbon polymer chain which can be adopted as R^{P2B} are respectively the same as the aliphatic hydrocarbon group, the polyalkyleneoxy chain, and the hydrocarbon polymer chain, each of which can be adopted as R^{P2} in Formula (I-3), and the same is applied to the preferred ones thereof.

The polymer (sequential polymerization polymer) that forms the above-described binder may have a constitutional component other than the constitutional component represented by the above formulae. Such a constitutional component is not particularly limited as long as it can be subjected to sequential polymerization with a raw material compound from which the constitutional component represented by each of the above formulae is derived.

In the polymer that forms the above-described binder, the (total) content of the constitutional components represented by Formula (I-1) to Formula (I-6) is not particularly limited; however, it is preferably 5% to 100% by mole, more preferably 5% to 80% by mole, and still more preferably 10% to 60% by mole. The upper limit value of the content thereof may be, for example, 100% by mole or less regardless of the above 60% by mole.

In the polymer that forms the above-described binder, the content of the constitutional component other than the constitutional component represented by each of the above formulae is not particularly limited; however, it is preferably 50% by mole or less.

In a case where the polymer that forms the above-described binder has a constitutional component represented by any of Formula (I-1) to Formula (I-6), the content thereof is not particularly limited, and it can be appropriately selected. For example, it can be set in the following range.

That is, in the polymer that forms the above-described binder, the content of the constitutional component represented by Formula (I-1) or Formula (I-2) or the constitutional component derived from the carboxylic acid dianhydride represented by Formula (I-5) is not particularly limited; however, it is preferably the same as the above-described content of the constitutional component having a functional group.

In the polymer that forms the above-described binder, the content of the constitutional component represented by Formula (I-3), Formula (I-4), or Formula (I-6) is not particularly limited, and it is preferably 10% to 85% by mole, more preferably 20% to 70% by mole, and still more preferably 30% to 60% by mole.

The content of each constitutional component represented by any one of Formula (I-3A) to Formula (I-3C) can be appropriately set in consideration of the content of each constitutional component represented by Formula (I-3). For example, the content of the constitutional component represented by Formula (I-3A) is preferably 0% to 85% by mole and more preferably 10% to 30% by mole. The content of the constitutional component represented by Formula (I-3B) is preferably 0% to 85% by mole and more preferably 10% to 45% by mole. The content of the constitutional component represented by Formula (I-3C) is preferably 0% to 85% by mole and more preferably 30% to 60% by mole.

It is noted that in a case where the polymer that forms the above-described binder has a plurality of constitutional components represented by the respective formulae, the above-described content of each of the constitutional components shall be in terms of the total content thereof.

The polymer (each constitutional component and raw material compound) that forms the above-described binder may have a substituent. The substituent is not particularly limited; however, examples thereof preferably include a group selected from the following substituent Z.

The polymer that forms the above-described binder can be synthesized with a known method by selecting a raw material compound depending on the kind of bond of the main chain and subjecting the raw material compound to polyaddition or polycondensation. As the synthesis method, for example, WO2018/151118A can be referenced.

The method of incorporating a functional group is not particularly limited, and examples thereof include a method of copolymerizing a compound having a functional group selected from the Group (a) of functional groups, a method of using a polymerization initiator having (generating) the above functional group, and a method of using a polymeric reaction.

Examples of each of the polymers of polyurethane, polyurea, polyamide, and polyimide, which can be adopted as the binder-forming polymer include each of the polymers described in WO2018/020827A and WO2015/046313A as well as each of the polymers described in JP2015-088480A.

### Substituent Z

The examples are an alkyl group (preferably an alkyl group having 1 to 20 carbon atoms, for example, methyl, ethyl, isopropyl, t-butyl, pentyl, heptyl, 1-ethylpentyl, benzyl, 2-ethoxyethyl, and 1-carboxymethyl), an alkenyl group (preferably an alkenyl group having 2 to 20 carbon atoms, such as vinyl, allyl, andoleyl), an alkynyl group (preferably an alkynyl group having 2 to 20 carbon atoms, for example, ethynyl, butadynyl, and phenylethynyl), a cycloalkyl group (preferably a cycloalkyl group having 3 to 20 carbon atoms, such as cyclopropyl, cyclopentyl, cyclohexyl, and 4-methylcyclohexyl; in the present invention, the alkyl group generally has a meaning including a cycloalkyl group therein in a case of being referred to, however, it will be described separately here), an aryl group (preferably an aryl group having 6 to 26 carbon atoms, such as phenyl, 1-naphthyl, 4-methoxyphenyl, 2-chlorophenyl, and 3-methylphenyl), an aralkyl group (preferably an aralkyl group having 7 to 23 carbon atoms, for example, benzyl or phenethyl), and a heterocyclic group (preferably a heterocyclic group having 2 to 20 carbon atoms and more preferably a 5- or 6-membered heterocyclic group having at least one oxygen atom, one sulfur atom, or one nitrogen atom. The heterocyclic group includes an aromatic heterocyclic group and an aliphatic heterocyclic group. Examples thereof include a tetrahydropyran ring group, a tetrahydrofuran ring group, a 2-pyridyl group, a 4-pyridyl group, a 2-imidazolyl group, a 2-benzimidazolyl group, a 2-thiazolyl group, a 2-oxazolyl group, or a pyrrolidone group); an alkoxy group (preferably an alkoxy group having 1 to 20 carbon atoms, for example, a methoxy group, an ethoxy group, an isopropyloxy group, or a benzyloxy group); an aryloxy group (preferably an aryloxy group having 6 to 26 carbon atoms, for example, a phenoxy group, a 1-naphthyloxy group, a 3-methylphenoxy group, or a 4-methoxyphenoxy group); a heterocyclic oxy group (a group in which an —O— group is bonded to the above-described heterocyclic group), an alkoxycarbonyl group (preferably an alkoxycarbonyl group having 2 to 20 carbon atoms, for example, an ethoxycarbonyl group, a 2-ethylhexyloxycarbonyl group, or a dodecyloxycarbonyl group); an aryloxycarbonyl group (preferably an aryloxycarbonyl group having 6 to 26 carbon atoms, for example, a phenoxycarbonyl group, a 1-naphthyloxycarbonyl group, a 3-methylphenoxycarbonyl group, or a 4-methoxyphenoxycarbonyl group); a heterocyclic oxycarbonyl group (a group in which an —O—CO— group is bonded to the above-described heterocyclic group); an amino group (preferably an amino group having 0 to 20 carbon atoms, an alkylamino group, or an arylamino group, for example, an amino (—NH₂) group, an N,N-dimethylamino group, an N,N-diethylamino group, an N-ethylamino group, or an anilino group); a sulfamoyl group (preferably a sulfamoyl group having 0 to 20 carbon atoms, for example, an N,N-dimethylsulfamoyl group or an N-phenylsufamoyl group); an acyl group (an alkylcarbonyl group, an alkenylcarbonyl group, an alkynylcarbonyl group, an arylcarbonyl group, or a heterocyclic carbonyl group, preferably an acyl group having 1 to 20 carbon atoms, for example, an acetyl group, a propionyl group, a butyryl group, an octanoyl group, a hexadecanoyl group, an acryloyl group, a methacryloyl group, a crotonoyl group, a benzoyl group, a naphthoyl group, or a nicotinoyl group); an acyloxy group (analkylcarbonyloxy group, an alkenylcarbonyloxy group, an alkynylcarbonyloxy group, or a heterocyclic carbonyloxy group, preferably an acyloxy group having 1 to 20 carbon atoms, for example, an acetyloxy group, a propionyloxy group, a butyryloxy group, an octanoyloxy group, a hexadecanoyloxy group, an acryloyloxy group, a methacryloyloxy group, a crotonoyloxy group, or a nicotinoyloxy group); an aryloyloxy group (preferably an aryloyloxy group having 7 to 23 carbon atoms, for example, a benzoyloxy group or a naphthoyloxy group);a carbamoyl group (preferably a carbamoyl group having 1 to 20 carbon atoms, for example, an N,N-dimethylcarbamoyl group or an N-phenylcarbamoyl group); an acylamino group (preferably an acylamino group having 1 to 20 carbon atoms, for example, an acetylamino group or a benzoylamino group); an alkylthio group (preferably an alkylthio group having 1 to 20 carbon atoms, for example, a methylthio group, an ethylthio group, an isopropylthio group, or a benzylthio group); an arylthio group (preferably an arylthio group having 6 to 26 carbon atoms, for example, a phenylthio group, a 1-naphthylthio group, a 3-methylphenylthio group, or a 4-methoxyphenylthio group); a heterocyclic thio group (a group in which an —S— group is bonded to the above-described heterocyclic group); an alkylsulfonyl group (preferably an alkylsulfonyl group having 1 to 20 carbon atoms, for example, a methylsulfonyl group or an ethylsulfonyl group), an arylsulfonyl group (preferably an arylsulfonyl group having 6 to 22 carbon atoms, for example, a benzenesulfonyl group); an alkylsilyl group (preferably an alkylsilyl group having 1 to 20 carbon atoms, for example, a monomethylsilyl group, a dimethylsilyl group, a trimethylsilyl group, or a triethylsilyl group); an arylsilyl group (preferably an arylsilyl group having 6 to 42 carbon atoms, for example, a triphenylsilyl group), an alkoxysilyl group (preferably an alkoxysilyl group having 1 to 20 carbon atoms, for example, a monomethoxysilyl group, a dimethoxysilyl group, a trimethoxysilyl group, or a triethoxysilyl group); an aryloxysilyl group (preferably an aryloxysilyl group having 6 to 42 carbon atoms, for example, a triphenyloxysilyl group), a phosphoryl group (preferably a phosphate group having 0 to 20 carbon atoms, for example, —OP(═O)(R^{P})₂), a phosphonyl group (preferably a phosphonyl group having 0 to 20 carbon atoms, for example, —P(═O)(R^{P})₂), a phosphinyl group (preferably a phosphinyl group having 0 to 20 carbon atoms, for example, —P(R^{P})₂), a phosphonate group (preferably a phosphonate group having 0 to 20 carbon atoms, for example, —PO(OR^{P})₂), a sulfo group (a sulfonate group), a carboxy group, a hydroxy group, a sulfanyl group, a cyano group, and a halogen atom (for example, a fluorine atom, a chlorine atom, a bromine atom, or an iodine atom). R^{P} represents a hydrogen atom or a substituent (preferably a group selected from the substituent Z).

In addition, each group exemplified in the substituent Z may be further substituted with the substituent Z.

The alkyl group, the alkylene group, the alkenyl group, the alkenylene group, the alkynyl group, the alkynylene group, and/or the like may be cyclic or chained, may be linear or branched.

### Chain Polymerization Polymer

The chain polymerization polymer as a polymer that forms the above-described binder will be described.

The chain polymerization polymer preferably has the above-described constitutional component having a functional group selected from the Group (a) of functional groups or the above-described constitutional component represented by Formula (1-1) and more preferably has the constitutional component having the above-described functional group and the constitutional component represented by Formula (1-1), and further, it may have a constitutional component different from these constitutional components. The chain polymerization polymer may not have the constitutional component having a functional group selected from the Group (a) of functional groups or the above-described constitutional component represented by Formula (1-1) and may be a polymer consisting of another constitutional component. Examples of the fluorine-containing polymer include polytetrafluoroethylene (PTFE), polyvinylidene difluoride (PVdF), a copolymer of polyvinylidene difluoride and hexafluoropropylene (PVdF-HFP), and a copolymer (PVdF-HFP-TFE) of polyvinylidene difluoride, hexafluoropropylene, and tetrafluoroethylene. In PVdF-HFP, the copolymerization ratio [PVdF:HFP] (mass ratio) of PVdF to HFP is not particularly limited; however, it is preferably 9:1 to 5:5 and more preferably 9:1 to 7: 3 from the viewpoint of adhesiveness. In PVdF-HFP-TFE, the copolymerization ratio [PVdF:HFP:TFE] (mass ratio) of PVdF, HFP, and TFE is not particularly limited; however, it is preferably 20 to 60:10 to 40: 5 to 30, and more preferably 25 to 50:10 to 35:10 to 25.

Examples of the hydrocarbon polymer include polyethylene, polypropylene, natural rubber, polybutadiene, polyisoprene, polystyrene, a polystyrene butadiene copolymer, a styrene-based thermoplastic elastomer, polybutylene, an acrylonitrile butadiene copolymer, and hydrogen-added (hydrogenated) polymers thereof. The styrene-based thermoplastic elastomer or the hydride thereof is not particularly limited. However, examples thereof include a styrene-ethylene-butylene-styrene block copolymer (SEBS), a styrene-isoprene-styrene block copolymer (SIS), a hydrogenated SIS, a styrene-butadiene-styrene block copolymer (SBS), a hydrogenated SBS, a styrene-ethylene-ethylene-propylene-styrene block copolymer (SEEPS), a styrene-ethylene-propylene-styrene block copolymer (SEP S), a styrene-butadiene rubber (SBR), a hydrogenated a styrene-butadiene rubber (HSBR), and furthermore, a random copolymer corresponding to each of the above-described block copolymers such as SEBS. In the present invention, the hydrocarbon polymer preferably has no unsaturated group (for example, a 1,2-butadiene constitutional component) that is bonded to the main chain from the viewpoint that the formation of chemical crosslink can be suppressed.

Examples of the vinyl polymer include a polymer containing a vinyl monomer other than the (meth)acrylic compound (M1), where the content of the vinyl polymer is, for example, 50% by mole or more. Examples of the vinyl monomer include vinyl compounds described later. Specific examples of the vinyl polymer include polyvinyl alcohol, polyvinyl acetal, polyvinyl acetate, and a copolymer containing these.

In addition to the constitutional component derived from the vinyl monomer, this vinyl polymer preferably has a constitutional component derived from the (meth)acrylic compound (M1) that forms a (meth)acrylic polymer described later. The content of the constitutional component derived from the vinyl monomer is preferably the same as the content of the constitutional component derived from the (meth)acrylic compound (M1) in the (meth)acrylic polymer. The content of the constitutional component derived from the (meth)acrylic compound (M1) in the polymer is not particularly limited as long as it is less than 50% by mole; however, it is preferably 0% to 30% by mole.

The (meth)acrylic polymer is preferably, as another constitutional component, a polymer obtained by copolymerizing at least one (meth)acrylic compound (M1) selected from a (meth)acrylic acid compound, a (meth)acrylic acid ester compound, a (meth)acrylamide compound, or a (meth)acrylonitrile compound. Further, a (meth)acrylic polymer consisting of a copolymer of the (meth)acrylic compound (M1) and another polymerizable compound (M2) is also preferable. Further, as another constitutional component, a (meth)acrylic polymer having a constitutional component derived from a macromonomer is also preferable. The macromonomer is not particularly limited as long as it is a monomer that is copolymerizable with the (meth)acrylic compound (M1); however, examples thereof include a (meth)acrylic compound having a polymerized chain of the above-described chain polymerization polymer. The chain polymerization polymer that can be adopted as the polymerized chain is preferably a (meth)acrylic polymer. The number average molecular weight of the macromonomer is not particularly limited; however, it is preferably 500 to 100,000 and more preferably 2,000 to 20,000.

The other polymerizable compound (M2) is not particularly limited, and examples thereof include vinyl compounds such as a styrene compound, a vinyl naphthalene compound, a vinyl carbazole compound, an allyl compound, a vinyl ether compound, a vinyl ester compound, a dialkyl itaconate compound, and an unsaturated carboxylic acid anhydride, and fluorinated compounds thereof. Examples of the vinyl compound include the “vinyl-based monomer” disclosed in JP2015-88486A.

The (meth)acrylic compound (M1) and another polymerizable compound (M2) may have a substituent. The substituent is not particularly limited as long as it is a group other than the functional group included in the above-described group (a) of functional groups, and preferred examples thereof include a group selected from the substituent Z described above.

In the (meth)acrylic polymer, the content of the constitutional component derived from the macromonomer is not particularly limited; however, it can be set to, for example, 10% by mole or less. The content of the constitutional component derived from the other polymerizable compound (M2) in the (meth)acrylic polymer is not particularly limited; however, it can be, for example, 50% by mole or less.

The (meth)acrylic compound (M1) and the vinyl compound (M2), from which the constitutional components of the (meth)acrylic polymer and the vinyl polymer are derived, are preferably a compound represented by Formula (b-1). This compound is different from the constitutional component having a functional group included in the above-described Group (a) of functional groups and the compound from which the constitutional component represented by Formula (1-1) is derived.

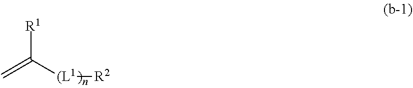

In the formula, R¹ represents a hydrogen atom, a hydroxy group, a cyano group, a halogen atom, an alkyl group (preferably having 1 to 24 carbon atoms, more preferably 1 to 12 carbon atoms, and particularly preferably 1 to 6 carbon atoms), an alkenyl group (preferably having 2 to 24 carbon atoms, more preferably 2 to 12 carbon atoms, and particularly preferably 2 to 6 carbon atoms), an alkynyl group (preferably having 2 to 24 carbon atoms, more preferably 2 to 12 carbon atoms, and particularly preferably 2 to 6 carbon atoms), or an aryl group (preferably having 6 to 22 carbon atoms and more preferably 6 to 14 carbon atoms). Among the above, a hydrogen atom or an alkyl group is preferable, and a hydrogen atom or a methyl group is more preferable.

R² represents a hydrogen atom or a substituent. The substituent that can be adopted as R² is not particularly limited. However, examples thereof include an alkyl group (preferably a linear chain although it may be a branched chain), an alkenyl group (preferably having 2 to 12 carbon atoms, more preferably 2 to 6 carbon atoms, and particularly preferably 2 or 3 carbon atoms), an aryl group (preferably having 6 to 22 carbon atoms and more preferably 6 to 14 carbon atoms), an aralkyl group (preferably having 7 to 23 carbon atoms and more preferably 7 to 15 carbon atoms), and a cyano group.

The alkyl group preferably has 1 to 3 carbon atoms. The alkyl group may have, for example, a group other than the functional group included in the group (a) of functional groups, among the above-described substituent Z.

L¹ is a linking group and is not particularly limited. However, examples thereof include an alkylene group having 1 to 6 carbon atoms (preferably 1 to 3 carbon atoms), an alkenylene group having 2 to 6 carbon atoms (preferably 2 or 3 carbon atoms), an arylene group having 6 to 24 carbon atoms (preferably 6 to 10 carbon atoms), an oxygen atom, a sulfur atom, an imino group (—NR^{N}—: here, R^{N} is as described above), a carbonyl group, and a phosphate linking group (—O—P(OH)(O)—O—), a phosphonate linking group (—P(OH)(O)—O—), and a group involved in the combination thereof, and a —CO—O— group or a —CO—N(R^{N})— group (R^{N} is as described above) is preferable. The above linking group may have any substituent. The number of atoms that constitute the linking group and the number of linking atoms are as described later. Examples of any substituent include a substituent Z described above, and examples thereof include an alkyl group and a halogen atom.

n is 0 or 1 and preferably 1. However, in a case where-(L¹)ₙ-R² represents one kind of substituent (for example, an alkyl group), n is set to 0, and R² is set to a substituent (an alkyl group).

Examples of the preferred (meth)acrylic compound (M1) include a compound represented by Formula (b-2) or (b-3). This compound is different from the constitutional component having a functional group included in the above-described Group (a) of functional groups and the compound from which the constitutional component represented by Formula (1-1) is derived.

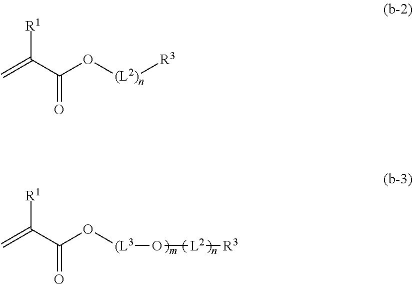

R¹ and n respectively have the same meanings as those in Formula (b-1).
R³ has the same meaning as R².
L² is a linking group and has the same meaning as the above L¹.
L³ is a linking group and has the same meaning as the above L¹; however, it is preferably an alkylene group having 1 to 6 carbon atoms (preferably 1 to 3 carbon atoms).
m is an integer of 1 to 200, and it is preferably an integer of 1 to 100 and more preferably an integer of 1 to 50.

In Formulae (b-1) to (b-3), the carbon atom which forms a polymerizable group and to which R¹ is not bonded is represented as an unsubstituted carbon atom (H₂C═); however, it may have a substituent. The substituent is not particularly limited; however, examples thereof include the above group that can be adopted as R¹.

Further, in Formulae (b-1) to (b-3), the group which may take a substituent such as an alkyl group, an aryl group, an alkylene group, or an arylene group may have a substituent within a range where the effect of the present invention is not impaired. It suffices that the substituent is a substituent other than the functional group selected from the Group (a) of functional groups. Examples thereof include a group selected from the substituent Z described later, and specific examples thereof include a halogen atom.

The (meth)acrylic polymer preferably has the above-described constitutional component having a functional group selected from the Group (a) of functional groups or the above-described constitutional component represented by Formula (1-1) and it can have a constitutional component derived from the (meth)acrylic compound (M1), a constitutional component derived from the vinyl compound (M2), and another constitutional component that is copolymerizable with a compound from which these constitutional components are derived. A case where the above-described constitutional component represented by Formula (1-1) and a constitutional component having a functional group selected from the group (a) of functional groups among the (meth)acrylic compounds (M1) is contained is preferable in terms of dispersion stability and bonding property.

The chain polymerization polymer (each constitutional component and raw material compound) may have a substituent. The substituent is not particularly limited, and preferred examples thereof include a group selected from the above-described substituent Z. However, a group other than the functional group included in the above-described group (a) of functional groups is preferable.

The content of the constitutional component in the (meth)acrylic polymer is not particularly limited, and it is, for example, appropriately selected and set in the following range. The contents of the constitutional component represented by Formula (1-1) and the constitutional component having a functional group selected from the Group (a) of functional groups are as described above.

The content of the constitutional component derived from the (meth)acrylic compound (M1) in the (meth)acrylic polymer is not particularly limited and may be set to 100% by mole; however, it is preferably 1% to 90% by mole, more preferably 10% to 80% by mole, and particularly preferably 20% to 70% by mole.

The content of the constitutional component derived from the vinyl compound (M2), in the (meth)acrylic polymer, is not particularly limited; however, it is preferably 1% to 50% by mole, more preferably 10% to 50% by mole, still more preferably 20% to 50% by mole, and even still more preferably 23% to 35% by mole.

The chain polymerization polymer (each constitutional component and raw material compound) may have a substituent. The substituent is not particularly limited as long as it is a group other than the functional group included in the above-described group (a) of functional groups, and preferred examples thereof include a group selected from the substituent Z described above.

The chain polymerization polymer can be synthesized by selecting a raw material compound and polymerizing the raw material compound according to a known method.

The method of incorporating a functional group is not particularly limited, and examples thereof include a method of copolymerizing a compound having a functional group selected from the group (a) of functional groups, a method of using a polymerization initiator having (generating) the above functional group or a chain transfer agent, a method of using a polymeric reaction, an ene reaction or ene-thiol reaction with a double bond (which is formed by a dehydrofluorination reaction of a VDF constitutional component, for example, in a case of a fluoropolymer), and an atom transfer radical polymerization (ATRP) method using a copper catalyst. In addition, a functional group can be introduced by using a functional group that is present in the main chain, the side chain, or the terminal of the polymer, as a reaction point. For example, a functional group selected from the group (a) of functional groups can be introduced by various reactions with a carboxylic acid anhydride group in a polymerized chain using a compound having a functional group.

Specific examples of the polymer that forms the polymer binder include those shown below in addition to those synthesized in Examples; however, the present invention is not limited thereto. In each specific example, the number attached at the bottom right of the constitutional component indicates the content in the polymer, where the unit thereof is % by mole.

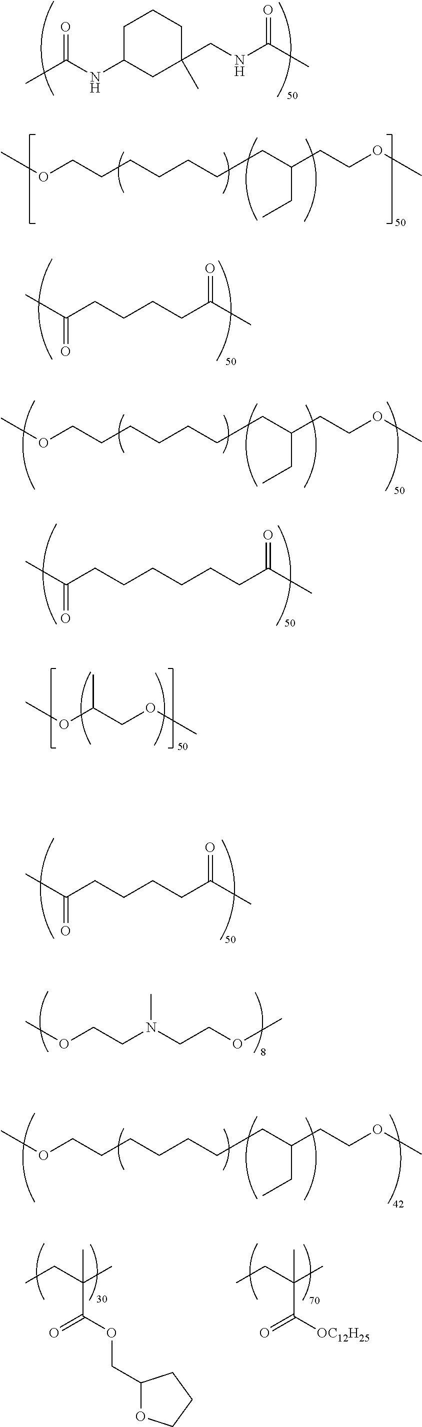

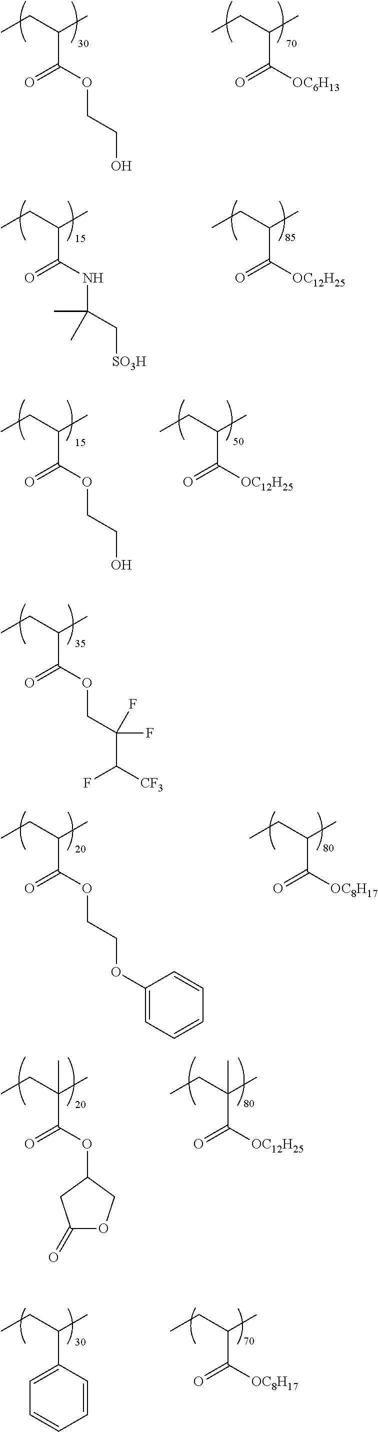

As the polymer binder, an appropriate polymer can be selected, and for example, a chain polymerization polymer is preferable, and a hydrocarbon polymer or a (meth)acrylic polymer is more preferable.

### Physical Properties, Characteristics, or Like of Polymer Binder or Polymer That Forms This Polymer Binder

The true density (g/cm³) of the polymer binder contained in the active material layer precursor layer is not particularly limited and is set appropriately. From the viewpoint that the filling rate is easily set in the above range, the true density of the polymer binder is preferably 0.5 to 2.5 g/cm³ and more preferably 0.8 to 2.2 g/cm³. The true density of the polymer binder shall be a value measured according to the above-described gas replacement method. It is noted that the true volume (cm³) of the polymer binder is not particularly limited and is set appropriately.

The polymer binder may be a polymer binder that is dissolved in a dispersion medium described later (also referred to as a soluble binder) or may be a polymer binder that is present in a particle shape without being dissolved (also referred to as a particulate binder). In the present invention, a soluble binder is preferable, where the soluble binder generally is present in a state of being dissolved in a dispersion medium in the electrode composition described later, which depends on the content thereof, the solubility thereof, the content of the dispersion medium, and the like. Here, the description that the polymer binder is dissolved in a dispersion medium refers to that, for example, the solubility is 10% by mass or more in the solubility measurement. On the other hand, the description that the polymer binder is not dissolved (is insoluble) in a dispersion medium means that the solubility in the solubility measurement is less than 10% by mass. The particle diameter of the particulate binder is not particularly limited; however, it is, for example, preferably 0.01 to 10 μm and more preferably 0.05 to 0.5 The particle diameter of the binder particle shall be a value measured using the same method as that of the particle diameter of the inorganic solid electrolyte.

The measuring method for solubility is as follows.

A specified amount of a polymer binder serving as a measurement target is weighed in a glass bottle, 100 g of the same dispersion medium as the dispersion medium contained in the electrode composition is added thereto, and stirring is carried out at a temperature of 25° C. on a mix rotor at a rotation speed of 80 rpm for 24 hours. After stirring for 24 hours, the mixed solution obtained in this way is subjected to the transmittance measurement under the following conditions. This test (the transmittance measurement) is carried out by changing the amount of the polymer binder dissolved (the above-described specified amount), and the upper limit concentration X (% by mass) at which the transmittance is 99.8% is defined as the solubility of the polymer binder in the above dispersion medium.

### Transmittance Measurement Conditions

Dynamic light scattering (DLS) measurement
Device: DLS measuring device DLS-8000 manufactured by Otsuka Electronics Co., Ltd.
Laser wavelength, output: 488 nm/100 mW
Sample cell: NMR tube

The mass average molecular weight of the polymer that forms the polymer binder is not particularly limited; however, it is, for example, preferably 15,000 or more, more preferably 30,000 or more, still more preferably 50,000 or more. The upper limit is practically 5,000,000 or lower; however, it is preferably 4,000,000 or lower, more preferably 3,000,000 or lower, still more preferably 700,000 or lower, still more preferably 500,000 or lower, and most preferably 200,000 or lower.

The mass average molecular weight of the polymer can be appropriately adjusted by changing the kind, content, polymerization time, polymerization temperature, and the like of the polymerization initiator.

### Measurement of Molecular Weight

In the present invention, unless specified otherwise, molecular weights of the polymer, the polymer chain, the polymerized chain, and a macromonomer refer to a mass average molecular weight and number average molecular weight in terms of standard polystyrene conversion, which are determined by gel permeation chromatography (GPC). The measuring method thereof includes, basically, a method in which conditions are set to Conditions 1 or Conditions 2 (preferential) described below. However, depending on the kind of polymer, polymer chain, or macromonomer, an appropriate eluent may be suitably selected and used.

### Condition 1

Column: Connect two TOSOH TSKgel Super AWM-H (product name, manufactured by Tosoh Corporation)
Carrier: 10 mM LiBr/N-methylpyrrolidone
Measurement temperature: 40° C.
Carrier flow rate: 1.0 ml/min
Sample concentration: 0.1% by mass
Detector: refractive index (RI) detector

### Condition 2

Column: A column obtained by connecting TOSOH TSKgel Super HZM-H, TOSOH TSKgel Super HZ4000, and TOSOH TSKgel Super HZ2000 (all of which are product names, manufactured by Tosoh Corporation)
Carrier: tetrahydrofuran
Measurement temperature: 40° C.
Carrier flow rate: 1.0 ml/min
Sample concentration: 0.1% by mass
Detector: refractive index (RI) detector

The watery moisture concentration of the polymer is preferably 100 ppm (in terms of mass) or lower. In addition, as the polymer binder, those obtained by crystalizing and drying polymers may be used, or a polymer solution may be used as it is.

The polymer that forms a polymer binder is preferably noncrystalline. In the present invention, the description that a polymer is “noncrystalline” typically refers to that no endothermic peak due to crystal melting is observed in a case where the measurement is carried out at the glass transition temperature.

The polymer that forms a polymer binder may be a non-crosslinked polymer or a crosslinked polymer. In addition, in a case where the crosslinking of the polymer progresses due to heating or voltage application, the molecular weight may be higher than the above-described molecular weight. Preferably, the polymer has a mass average molecular weight in the above range at the start of use of the all-solid state secondary battery.

The content of the polymer binder in the active material layer precursor layer is 3% by mass or less. This makes it possible to realize the reduction of the resistance of the all-solid state secondary battery while maintaining the adhesion and binding of the solid particles, and an excellent transportability is also obtained. From the viewpoint that both transportability and battery characteristics can be at a higher level, the content of the polymer binder is preferably 0.5% to 2.5% by mass, more preferably 0.7% to 2.0% by mass, and still more preferably 0.8% to 1.5% by mass.

In the present invention, the mass ratio of the total mass of the inorganic solid electrolyte and the active material to the total mass of the polymer binder [(mass of inorganic solid electrolyte+mass of active material)/(total mass of polymer binder)] in 100% by mass of the active material layer precursor layer is preferably in a range of 1,000 to 1. Furthermore, this ratio is more preferably 500 to 2 and still more preferably 100 to 10.

### Conductive Auxiliary Agent

The active material layer precursor layer preferably contains a conductive auxiliary agent.

The conductive auxiliary agent is not particularly limited, and a conductive auxiliary agent that is known as an ordinary conductive auxiliary agent can be used. It may be, for example, graphite such as natural graphite and artificial graphite, carbon black such as acetylene black, Ketjen black, and furnace black, amorphous carbon such as needle cokes, carbon fibers such as a vapor-grown carbon fiber and a carbon nanotube, or a carbonaceous material such as graphene or fullerene, which are electron-conductive materials, and it may be also a metal powder or metal fiber of copper, nickel, or the like. A conductive polymer such as polyaniline, polypyrrole, polythiophene, polyacetylene, or a polyphenylene derivative may also be used.

In the present invention, in a case where the active material is used in combination with the conductive auxiliary agent, among the above-described conductive auxiliary agents, a conductive auxiliary agent that does not intercalate and deintercalate ions (preferably Li ions) of a metal belonging to Group 1 or Group 2 in the periodic table and does not function as an active material at the time of charging and discharging of the battery is classified as the conductive auxiliary agent. Therefore, among the conductive auxiliary agents, a conductive auxiliary agent that can function as the active material in the active material layer at the time of charging and discharging of the battery is classified as an active material but not as a conductive auxiliary agent. Whether or not the conductive auxiliary agent functions as the active material at the time of charging and discharging of a battery is not unambiguously determined but is determined by the combination with the active material.

The conductive auxiliary agent contained in the active material layer precursor layer preferably has a particle shape in the electrode composition. The shape of the particle is not particularly limited and may be a flat shape, an amorphous shape, or the like; however, a spherical shape or a granular shape is preferable. In a case where the conductive auxiliary agent has a particle shape, the particle diameter (volume average particle diameter) of the conductive auxiliary agent is not particularly limited; however, it is, for example, preferably 0.02 to 1.0 μm and more preferably 0.03 to 0.5 μm. The particle diameter of the conductive auxiliary agent can be adjusted in the same manner as in the adjustment of the particle diameter of the inorganic solid electrolyte, and the particle diameter thereof can be measured by the same measuring method as the method for the particle diameter of the inorganic solid electrolyte.

The true density (g/cm³) of the conductive auxiliary agent contained in the active material layer precursor layer is not particularly limited and is set appropriately. From the viewpoint that the filling rate is easily set in the above range, the true density of the conductive auxiliary agent is preferably 1 to 3 g/cm³ and more preferably 1.5 to 2 g/cm³. The true density of the conductive auxiliary agent shall be a value measured according to the above-described gas replacement method. It is noted that the true volume (cm³) of the conductive auxiliary agent is not particularly limited and is set appropriately.

The conductive auxiliary agent contained in the active material layer precursor layer may be one kind or two or more kinds.

The content of the conductive auxiliary agent in the active material layer precursor layer is not particularly limited and is appropriately determined. For example, it is preferably 10% by mass or less and more preferably 1.0% to 5.0% by mass in the active material layer precursor layer.

### Lithium Salt

The active material layer precursor layer can also contain a lithium salt (supporting electrolyte). Generally, the lithium salt is preferably a lithium salt that is used for this kind of product and is not particularly limited. For example, lithium salts described in paragraphs 0082 to 0085 of JP2015-088486A are preferable. In a case where the active material layer precursor layer contains a lithium salt, the content of the lithium salt is preferably 0.1 parts by mass or more and more preferably 5 parts by mass or more with respect to 100 parts by mass of the inorganic solid electrolyte. The upper limit thereof is preferably 50 parts by mass or less and more preferably 20 parts by mass or less.

### Dispersing Agent

Since the above-described polymer binder also functions as a dispersing agent, the active material layer precursor layer does not have to contain a dispersing agent other than the polymer binder. In a case where the active material layer precursor layer contains a dispersing agent other than the polymer binder, a dispersing agent that is generally used for an all-solid state secondary battery can be appropriately selected and used as the dispersing agent. Generally, a compound intended for particle adsorption and steric repulsion and/or electrostatic repulsion is suitably used.

### Other Additives

As a component other than each of the components described above, the active material layer precursor layer may appropriately contain an ionic liquid, a thickener, a crosslinking agent (an agent causing a crosslinking reaction by radical polymerization, condensation polymerization, or ring-opening polymerization), a polymerization initiator (an agent that generates an acid or a radical by heat or light), an anti-foaming agent, a leveling agent, a dehydrating agent, or an antioxidant. The ionic liquid is contained in order to further improve the ion conductivity, and the known one in the related art can be used without particular limitation. In addition, a polymer other than the above-described polymer that forms a polymer binder, a binding agent that is typically used, or the like may be contained.

### Electrode Sheet

The electrode sheet (may be also referred to as an electrode sheet for an all-solid state secondary battery) is a sheet that is produced by pressing the active material layer precursor layer of the sheet for an electrode according to the embodiment of the present invention, where the electrode sheet is suitably used as a material sheet for manufacturing an active material layer of an all-solid state secondary battery or a laminate of a collector and an active material layer. Therefore, the electrode sheet includes various aspects depending on the use application thereof. For example, it may be a sheet in which the active material layer is formed on a base material (collector) or may be a sheet which does not have a base material and is formed from an active material layer. The electrode sheet is typically a sheet including the base material (collector) and the active material layer, and examples of an aspect thereof include an aspect including the base material (collector), the active material layer, and the solid electrolyte layer in this order and an aspect including the base material (collector), the active material layer, the solid electrolyte layer, and the active material layer in this order. In addition, the electrode sheet may have another layer in addition to each of the above-described layers. Examples of the other layer include a protective layer (a peeling sheet) and a coating layer.

In the present invention, each layer that constitutes the electrode sheet may have a monolayer structure or a multilayer structure. The electrode sheet may be a long-sheet type sheet or may be a single-sheet type sheet.

In the electrode sheet, the active material layer that is formed by pressing the active material layer precursor layer is not particularly limited; however, it has a filling rate of 60% or more, which is generally required for an active material layer of an all-solid state secondary battery. In terms of the battery characteristics (the suppression of the increase in resistance), the filling rate of the active material layer is preferably 70% or more, more preferably 80% or more, and still more preferably 90% or more. The upper limit of the filling rate is ideally 100%; however, it can be practically set to 97% or less. The filling rate of the active material layer shall be a value calculated in the same manner as the filling rate of the active material layer precursor layer.

The film density of the active material layer is not particularly limited and is appropriately determined depending on the filling rate of the active material layer precursor layer, the compression rate by pressing, and the like. It can be set to, for example, 1.5 to 4.6 g/cm³, and it is preferably set to 3.0 to 4.0 g/cm³ and more preferably set to 3.5 to 4.0 g/cm³. In a case where the electrode sheet is a sheet for a positive electrode, the film density of the positive electrode active material layer is preferably 2.5 to 4.6 g/cm³, and in a case where the electrode sheet is a sheet for a negative electrode, the film density of the negative electrode active material layer is preferably 1.2 to 2.2 g/cm³.

It is preferable that at least one active material layer included in the electrode sheet, for example, the positive electrode active material layer, is formed of the active material layer precursor layer of the sheet for an electrode according to the embodiment of the present invention.

The content of each component in the active material layer formed of the active material layer precursor layer of the sheet for an electrode according to the embodiment of the present invention is not particularly limited; however, it preferably has the same meaning as the content of each component in the active material layer precursor layer. The layer thickness of each of the layers that form the electrode sheet is appropriately determined, and it is the same as the layer thickness of each of the layers described later regarding the all-solid state secondary battery.

It is noted that the solid electrolyte layer or an active material layer that is not formed of the active material layer precursor layer is formed of a general constitutional layer forming material.

In the electrode sheet, at least one active material layer is formed of the sheet for an electrode according to the embodiment of the present invention, and in a case of being used as an active material layer of an all-solid state secondary battery, it is possible to manufacture an all-solid state secondary battery that has low resistance and exhibits excellent battery characteristics, even in the industrial manufacturing method. In particular, in a case of using a sheet for an electrode, in which the active material layer precursor layer is formed on a collector, the active material layer precursor layer and the collector exhibit a firm bonding property, which makes it possible to realize the further improvement of the battery characteristics, and moreover, an electrode consisting of a collector and an active material layer can be formed at one time, which improves productivity. As described above, the sheet for an electrode according to the embodiment of the present invention is suitably used as an active material layer of an all-solid state secondary battery and preferably as a sheet-shape member that forms an electrode (that is incorporated as an active material layer or an electrode).

### All-Solid State Secondary Battery

The all-solid state secondary battery according to the embodiment of the present invention includes a positive electrode active material layer, a negative electrode active material layer facing the positive electrode active material layer, and a solid electrolyte layer disposed between the positive electrode active material layer and the negative electrode active material layer. The all-solid state secondary battery according to the embodiment of the present invention is not particularly limited in the configuration as long as it has a solid electrolyte layer between the positive electrode active material layer and the negative electrode active material layer, and for example, a known configuration for an all-solid state secondary battery can be employed. In a preferred all-solid state secondary battery, a positive electrode collector is laminated on a surface of the positive electrode active material layer opposite to the solid electrolyte layer to constitute a positive electrode, and a negative electrode collector is laminated on a surface of the negative electrode active material layer opposite to the solid electrolyte layer to constitute a negative electrode. In the present invention, each constitutional layer (including a collector and the like) that constitutes an all-solid state secondary battery may have a monolayer structure or a multilayer structure.

The all-solid state secondary battery according to the embodiment of the present invention is preferably an all-solid state secondary battery manufactured by the manufacturing method for an all-solid state secondary battery described later. For example, the all-solid state secondary battery according to the embodiment of the present invention is such that at least one of the positive electrode active material layer or the negative electrode active material layer, preferably the positive electrode active material layer is preferably composed (formed) of an active material layer (an electrode sheet produced by pressing the sheet for an electrode according to the embodiment of the present invention) obtained by compressing (pressing) the active material layer precursor layer in the sheet for an electrode according to the embodiment of the present invention to a filling rate of 60% or more. In the present invention, an aspect, in which both the negative electrode active material layer and the positive electrode active material layer are composed of an active material layer obtained by compressing the sheet for an electrode according to the embodiment of the present invention, is also one of the preferred aspects. In addition, it is preferable that any one of the negative electrode (a laminate of a negative electrode collector and a negative electrode collector) and the positive electrode (a laminate of a positive electrode collector and a positive electrode collector), preferably the positive electrode is formed of an active material layer obtained by compressing the active material layer precursor layer of the sheet for an electrode according to the embodiment of the present invention, and an aspect, in which both of them are formed of an active material layer obtained by compressing the active material layer precursor layer of the sheet for an electrode according to the embodiment of the present invention, is also one of the preferred aspects. In the present invention, constituting the active material layer of the all-solid state secondary battery with an active material layer obtained by compressing the active material layer precursor layer of the sheet for an electrode according to the embodiment of the present invention includes an aspect in which a laminate of an active material layer and a solid electrolyte layer is constituted by laminating an active material layer obtained by compressing an active material layer precursor layer, with a solid electrolyte layer in addition to an aspect in which only an active material layer is composed of an active material layer obtained by compressing an active material layer precursor layer (however, in a case where an electrode sheet has a layer other than the active material layer, a sheet from which this layer has been removed). The active material layer formed by compressing the active material layer precursor layer of the sheet for an electrode according to the embodiment of the present invention is preferably such that the kinds of components to be contained and the contents thereof are the same as the kinds of components and the contents thereof in the active material layer precursor layer.

It is noted that in a case where the active material layer is not composed of an active material layer obtained by compressing the active material layer precursor layer of the sheet for an electrode according to the embodiment of the present invention, this active material layer can be produced using a known material.

In the present invention, each constitutional layer (including a collector and the like) that constitutes an all-solid state secondary battery may have a monolayer structure or a multilayer structure.

### Positive Electrode Active Material Layer and Negative Electrode Active Material Layer

Each of the negative electrode active material layer and the positive electrode active material layer has the same meaning as the active material layer of the electrode sheet.

The thickness of each of the negative electrode active material layer and the positive electrode active material layer is not particularly limited. In case of taking a dimension of a general all-solid state secondary battery into account, the thickness of each of the layers is preferably 10 to 1,000 μm and more preferably 20 μm or more and less than 500 μm. In the all-solid state secondary battery according to the embodiment of the present invention, the thickness of at least one layer of the positive electrode active material layer or the negative electrode active material layer is still more preferably 50 μm or more and less than 500 μm and particularly preferably 50 μm or more and 250 μm or less.

In the present invention, in a case of constituting the active material layer with an active material layer obtained by compressing the active material layer precursor layer of the sheet for an electrode according to the embodiment of the present invention, it is possible to manufacture an all-solid state secondary battery having low resistance even in the industrial manufacturing method.

### Solid Electrolyte Layer

The solid electrolyte layer is formed of a known material that is capable of forming a solid electrolyte layer of an all-solid state secondary battery. The thickness thereof is not particularly limited; however, it is preferably 10 to 1,000 μm, and more preferably 20 μm or more and less than 500 μm.

### Collector

It is preferable that each of the positive electrode active material layer and the negative electrode active material layer includes a collector on the side opposite to the solid electrolyte layer. Such a positive electrode collector and such a negative electrode collector are preferably an electron conductor.

In the present invention, either or both of the positive electrode collector and the negative electrode collector will also be simply referred to as the collector.

As a material that forms the positive electrode collector, not only aluminum, an aluminum alloy, stainless steel, nickel, or titanium but also a material (a material on which a thin film has been formed) obtained by treating the surface of aluminum or stainless steel with carbon, nickel, titanium, or silver is preferable. Among these, aluminum or an aluminum alloy is more preferable.

The material that forms the negative electrode collector is preferably, in addition to aluminum, copper, a copper alloy, stainless steel, nickel, titanium, and the like, a material obtained by treating the surface of aluminum, copper, a copper alloy, or stainless steel with carbon, nickel, titanium, or silver, and it is more preferably aluminum, copper, a copper alloy, or stainless steel.

Regarding the shape of the collector, a film sheet shape is typically used; however, it is also possible to use shapes such as a net shape, a punched shape, a lath body, a porous body, a foaming body, and a molded body of a fiber group.

The thickness of the collector is not particularly limited; however, it is preferably 1 to 500 μm. In addition, protrusions and recesses are preferably provided on the surface of the collector by carrying out a surface treatment.

### Other Configurations

In the present invention, a functional layer, a functional member, or the like may be appropriately interposed or disposed between or on the outside of the respective layers of the negative electrode collector, the negative electrode active material layer, the solid electrolyte layer, the positive electrode active material layer, and the positive electrode collector.

### Housing

Depending on the use application, the all-solid state secondary battery according to the embodiment of the present invention may be used as the all-solid state secondary battery having the above-described structure as it is; however, it is preferably further sealed in an appropriate housing to be used in the form of a dry cell. The housing may be a metallic housing or a resin (plastic) housing. In a case where a metallic housing is used, examples thereof include an aluminum alloy housing and a stainless steel housing. It is preferable that the metallic housing is divided into a positive electrode-side housing and a negative electrode-side housing and that the positive electrode-side housing and the negative electrode-side housing are electrically connected to the positive electrode collector and the negative electrode collector, respectively. The positive electrode-side housing and the negative electrode-side housing are preferably integrated by being joined together through a gasket for short circuit prevention.

Hereinafter, an all-solid state secondary battery according to a preferred embodiment of the present invention will be described with reference to FIG. 2, but the present invention is not limited thereto.

FIG. 2 is a cross-sectional view schematically illustrating the all-solid state secondary battery (lithium ion secondary battery) according to the preferred embodiment of the present invention. In a case of being seen from the negative electrode side, an all-solid state secondary battery 10 of the present embodiment includes a negative electrode collector 1, a negative electrode active material layer 2, a solid electrolyte layer 3, a positive electrode active material layer 4, and a positive electrode collector 5 in this order. The respective layers are in contact with each other, and thus structures thereof are adjacent. In a case in which the above-described structure is employed, during charging, electrons (e⁻) are supplied to the negative electrode side, and lithium ions (Li⁺) are accumulated on the negative electrode side. On the other hand, during discharging, the lithium ions (Li⁺) accumulated in the negative electrode return to the positive electrode side, and electrons are supplied to an operation portion 6. In an example illustrated in the drawing, an electric bulb is employed as a model at the operation portion 6 and is lit by discharging.

In a case where the all-solid state secondary battery having a layer configuration illustrated in FIG. 2 is placed in a 2032-type coin case, the all-solid state secondary battery will be referred to as a laminate for an all-solid state secondary battery, and a battery produced by placing this laminate for an all-solid state secondary battery in a 2032-type coin case will be referred to as a (coin-type) all-solid state secondary battery, whereby both batteries may be distinctively referred to in some cases.

### Positive Electrode Active Material Layer and Negative Electrode Active Material Layer

In the all-solid state secondary battery 10, both the positive electrode active material layer and the negative electrode active material layer are composed of an active material layer obtained by compressing the active material layer precursor layer of the sheet for an electrode according to the embodiment of the present invention. Preferably, the positive electrode in which the positive electrode active material layer and the positive electrode collector are laminated, and the negative electrode in which the negative electrode active material layer and the negative electrode collector are laminated are composed of an active material layer obtained by compressing the active material layer precursor layer of the sheet for an electrode according to the embodiment of the present invention, to which a collector is applied as a base material.

The positive electrode active material layer has the same meaning as the positive electrode active material layer of the electrode sheet, and it contains an inorganic solid electrolyte having an ion conductivity of a metal belonging to Group 1 or Group 2 in the periodic table, a positive electrode active material, a polymer binder, any component described above, and the like within a range where the effect of the present invention is not impaired.

The negative electrode active material layer has the same meaning as the negative electrode active material layer of the electrode sheet, and it contains an inorganic solid electrolyte having an ion conductivity of a metal belonging to Group 1 or Group 2 in the periodic table, a negative electrode active material, a polymer binder, any component described above, and the like within a range where the effect of the present invention is not impaired. It is noted that in the all-solid state secondary battery 10, the negative electrode active material layer can be a lithium metal layer. Examples of the lithium metal layer include a layer formed by depositing or molding a lithium metal powder, a lithium foil, and a lithium vapor deposition film. The thickness of the lithium metal layer can be, for example, 1 to 500 μm regardless of the above-described thickness of the above negative electrode active material layer.

### Solid Electrolyte Layer

As the solid electrolyte layer, a solid electrolyte layer in the related art, which is applied to an all-solid state secondary battery, can be used without particular limitation. This solid electrolyte layer appropriately contains an inorganic solid electrolyte having an ion conductivity of a metal belonging to Group 1 or Group 2 in the periodic table, any component described above, and the like, and it generally does not contain an active material.

The kinds of the respective components contained in the positive electrode active material layer 4, the solid electrolyte layer 3, and the negative electrode active material layer 2, particularly the kinds of the inorganic solid electrolyte, the conductive auxiliary agent, and the polymer binder may be the same or different from each other.

### Collector

The positive electrode collector 5 and the negative electrode collector 1 are as described above.

### Use Application of All-Solid State Secondary Battery

The all-solid state secondary battery according to the embodiment of the present invention can be applied to a variety of use applications. The application aspect thereof is not particularly limited, and in a case of being mounted in an electronic apparatus, examples thereof include a notebook computer, a pen-based input personal computer, a mobile personal computer, an e-book player, a mobile phone, a cordless phone handset, a pager, a handy terminal, a portable fax, a mobile copier, a portable printer, a headphone stereo, a video movie, a liquid crystal television, a handy cleaner, a portable CD, a mini disc, an electric shaver, a transceiver, an electronic notebook, a calculator, a memory card, a portable tape recorder, a radio, and a backup power supply. Additionally, examples of consumer usages include automobiles (electric vehicles and the like), electric vehicles, motors, lighting equipment, toys, game devices, road conditioners, watches, strobes, cameras, medical devices (pacemakers, hearing aids, and shoulder massage devices, and the like). Further, the all-solid state secondary battery can be used for a variety of military usages and universe usages. In addition, the all-solid state secondary battery can also be combined with a solar battery.

### Manufacturing Method for Sheet for Electrode

The manufacturing method for a sheet for an electrode according to the embodiment of the present invention is not particularly limited as long as it is a method that makes it possible to form an active material layer precursor layer by setting the content of the polymer binder and the filling rate of the active material layer precursor layer in the above range. Preferred examples thereof include a method in which in a case where an electrode composition containing an inorganic solid electrolyte, an active material, a polymer binder, and a dispersion medium is applied onto a base material and dried to form an active material layer precursor layer, a step of setting a content of solid contents of the polymer binder to 3% by mass or less to prepare the electrode composition and a step of setting a filling rate of the active material layer precursor layer to 35% to 50% are carried out (operated) (hereinafter, may be referred to as the manufacturing method for a sheet for an electrode according to the embodiment of the present invention). It is noted that in the present invention, in a case where the active material layer precursor layer formed by subjecting the electrode composition to coating and drying has a filling rate of 35% to 50%, it suffices that in a case of forming the active material layer precursor layer, the manufacturing method for a sheet for an electrode according to the embodiment of the present invention has a step of setting a content of solid contents of the polymer binder to 3% by mass or less to prepare the electrode composition. Since the sheet for an electrode according to the embodiment of the present invention has excellent transportability, it can also be manufactured by applying an industrial manufacturing method.

### Preparation of Electrode Composition

In the manufacturing of a sheet for an electrode, first, an electrode composition is prepared.

This electrode composition contains an inorganic solid electrolyte, an active material, a polymer binder, and a dispersion medium, and it appropriately contains preferably a conductive auxiliary agent, as well as the above-described lithium salt and dispersing agent, and other additives.

The electrode composition is preferably a slurry in which an inorganic solid electrolyte, an active material, and the like are dispersed in a dispersion medium.

This electrode composition is preferably a non-aqueous composition. In the present invention, the non-aqueous composition includes not only an aspect including no watery moisture but also an aspect where the water content (also referred to as the “watery moisture content”) is preferably 500 ppm or less. In the non-aqueous composition, the water content is more preferably 200 ppm or less, still more preferably 100 ppm or less, and particularly preferably 50 ppm or less. In a case where the electrode composition is a non-aqueous composition, it is possible to suppress the deterioration of the inorganic solid electrolyte. The water content refers to the amount of water (the mass proportion thereof to the electrode composition) in the electrode composition and specifically is a value measured by Karl Fischer titration after carrying out filtering through a membrane filter having a pore size of 0.02

Each component other than the dispersion medium, which is contained in the electrode composition, is as described above, and the content of each component in 100% by mass of the solid content of the electrode composition is the same as the content in the active material layer precursor layer. In particular, the content of the polymer binder is set to 3% by mass or less in 100% by mass of the solid content of the electrode composition.

In the present invention, the solid content (solid component) refers to components that neither volatilize nor evaporate and disappear in a case where the electrode composition is subjected to drying treatment at 150° C. for 6 hours in a nitrogen atmosphere at a pressure of 1 mmHg. Typically, the solid content refers to a component other than a dispersion medium described later. In addition, the content in the total solid content indicates the content in 100% by mass of the total mass of the solid content.

### Dispersion Medium

It suffices that the dispersion medium contained in the electrode composition is an organic compound that is in a liquid state in the use environment, examples thereof include various organic solvents, and specific examples thereof include an alcohol compound, an ether compound, an amide compound, an amine compound, a ketone compound, an aromatic compound, an aliphatic compound, a nitrile compound, and an ester compound.

The dispersion medium may be a non-polar dispersion medium (a hydrophobic dispersion medium) or a polar dispersion medium (a hydrophilic dispersion medium); however, a non-polar dispersion medium is preferable from the viewpoint that excellent dispersion characteristics can be exhibited. The non-polar dispersion medium generally means a dispersion medium having a property of a low affinity to water; however, in the present invention, examples thereof include an ester compound, a ketone compound, an ether compound, an aromatic compound, and an aliphatic compound.

Examples of the alcohol compound include methyl alcohol, ethyl alcohol, 1-propyl alcohol, 2-propyl alcohol, 2-butanol, ethylene glycol, propylene glycol, glycerin, 1,6-hexanediol, cyclohexanediol, sorbitol, xylitol, 2-methyl-2,4-pentanediol, 1,3-butanediol, and 1,4-butanediol.

Examples of the ether compound include an alkylene glycol (diethylene glycol, triethylene glycol, polyethylene glycol, dipropylene glycol, or the like), an alkylene glycol monoalkyl ether (ethylene glycol monomethyl ether, ethylene glycol monobutyl ether, propylene glycol monomethyl ether, diethylene glycol monomethyl ether, dipropylene glycol monomethyl ether, tripropylene glycol monomethyl ether, diethylene glycol monobutyl ether, or the like), alkylene glycol dialkyl ether (ethylene glycol dimethyl ether or the like), a dialkyl ether (dimethyl ether, diethyl ether, diisopropyl ether, dibutyl ether, or the like), and a cyclic ether (tetrahydrofuran, dioxane (including 1,2-, 1,3- or 1,4-isomer), or the like).

Examples of the amide compound include N,N-dimethylformamide, N-methyl-2-pyrrolidone, 2-pyrrolidinone, 1,3-dimethyl-2-imidazolidinone, ε-caprolactam, formamide, N-methylformamide, acetamide, N-methylacetamide, N,N-dimethylacetamide, N-methylpropanamide, and hexamethylphosphoric triamide.

Examples of the amine compound include triethylamine, diisopropylethylamine, and tributylamine.

Examples of the ketone compound include acetone, methyl ethyl ketone, methyl isobutyl ketone (MIBK), cyclopentanone, cyclohexanone, cycloheptanone, dipropyl ketone, dibutyl ketone, diisopropyl ketone, diisobutyl ketone (DIBK), isobutyl propyl ketone, sec-butyl propyl ketone, pentyl propyl ketone, and butyl propyl ketone.

Examples of the aromatic compound include benzene, toluene, xylene, and perfluorotoluene.

Examples of the aliphatic compound include hexane, heptane, octane, nonane, decane, dodecane, cyclohexane, methylcyclohexane, ethylcyclohexane, cycloheptane, cyclooctane, decalin, paraffin, gasoline, naphtha, kerosene, and light oil.

Examples of the nitrile compound include acetonitrile, propionitrile, and isobutyronitrile.

Examples of the ester compound include ethyl acetate, propyl acetate, propyl butyrate, butyl acetate, ethyl butyrate, isopropyl butyrate, butyl butyrate, isobutyl butyrate, butyl pentanoate, pentyl pentanoate, ethyl isobutyrate, propyl isobutyrate, isopropyl isobutyrate, isobutyl isobutyrate, propyl pivalate, isopropyl pivalate, butyl pivalate, and isobutyl pivalate.

In the present invention, among them, an ether compound, a ketone compound, an aromatic compound, an aliphatic compound, or an ester compound is preferable, and an ester compound, a ketone compound, or an ether compound is more preferable.

The number of carbon atoms of the compound that constitutes the dispersion medium is not particularly limited, and it is preferably 2 to 30, more preferably 4 to 20, still more preferably 6 to 15, and particularly preferably 7 to 12.

The boiling point of the dispersion medium at normal pressure (1 atm) is not particularly limited; however, it is preferably 90° C. or higher, and it is more preferably 120° C. or higher. The upper limit thereof is preferably 230° C. or lower and more preferably 200° C. or lower.

The dispersion medium contained in the electrode composition according to the embodiment of the present invention may be one kind or may be two or more kinds. Examples thereof in which two or more kinds of dispersion media are contained include mixed xylene (a mixture of o-xylene, p-xylene, m-xylene, and ethylbenzene).

The content of the dispersion medium in the electrode composition is not particularly limited and can be appropriately set. For example, the content of the dispersion medium in the electrode composition is preferably 20% to 80% by mass, more preferably 30% to 70% by mass, and particularly preferably 40% to 60% by mass.

### Preparation of Electrode Composition

The electrode composition can be prepared according to a conventional method. For example, it can be prepared, as a mixture and preferably as a slurry, by mixing an inorganic solid electrolyte, an active material, a polymer binder, a dispersion medium, and preferably a conductive auxiliary agent, and further, appropriately a lithium salt, a dispersing agent, and other components by using, for example, various mixers that are generally used. In this case, the content of the polymer binder is set to 3% by mass or less in 100% by mass of the solid content of the electrode composition.

The mixing method of the above-described components is not particularly limited, and the above-described components may be mixed collectively or may be mixed sequentially. In the present invention, it is preferable that an active material, preferably a conductive auxiliary agent or a dispersion medium is mixed with a solid electrolyte composition prepared by mixing an inorganic solid electrolyte, a polymer binder, and a dispersion medium to prepare an electrode composition. In this mixing method, the using amount of each component is appropriately set in consideration of the content of each component in the target electrode composition. For example, it is set in the same range as the content of each component in 100% by mass of the solid content in the electrode composition. The dispersion medium that is used in the preparation of each composition is appropriately set in consideration of the content or the like of the dispersion medium in the electrode composition. In a case where a lithium salt, a dispersing agent, and other additives are used in this preparation method, these components may be mixed in any step.

The mixing method and mixing conditions in the preparation of each composition are not particularly limited and can be appropriately set.

For example, regarding the mixing method, each of the components may be mixed collectively or may be mixed sequentially. In addition, the mixing method can be carried out by using, for example, a known mixer such as a ball mill, a beads mill, a planetary mixer, a blade mixer, a roll mill, a kneader, a disc mill, a self-rotation type mixer, or a narrow gap type disperser. The mixing conditions are set to, for example, a mixing temperature of 10° C. to 60° C. and a rotation speed of a self-rotation type mixer or the like to 10 to 700 rpm (rotation per minute (rpm), and the mixing time can be set to 5 minutes to 5 hours. In a case where a ball mill is used as the mixer, it is preferable to set the rotation speed at 50 to 700 rpm and the mixing time at 5 minutes to 24 hours and preferably 5 minutes to 60 minutes at the mixing temperature described above.

It is noted that the mixing in this step can also be dividedly carried out a plurality of times.

### Coating and Drying of Electrode Composition

In the manufacturing method for a sheet for an electrode according to the embodiment of the present invention, the prepared electrode composition is preferably subjected to coating and drying (film formation) on a surface of a base material (another layer may be interposed) to form a coated and dried layer of the electrode composition. Here, the coated and dried layer refers to a layer formed by carrying out coating with the electrode composition and drying the dispersion medium (that is, a layer formed using the electrode composition and consisting of a composition obtained by removing the dispersion medium from the electrode composition). In the coated and dried layer, the dispersion medium may remain within a range where the effect of the present invention is not impaired, and the residual amount thereof, for example, in a coated and dried layer may be 3% by mass or lower. In the manufacturing method for a sheet for an electrode according to the embodiment of the present invention, the coated and dried film of the electrode composition may be used as it is as an active material layer precursor layer. Alternatively, a layer that has been subjected to a treatment that is generally carried out on this coated and dried layer, for example, a coated and dried film may be pressurized within a range from which the filling rate does not deviate to obtain an active material layer precursor layer.

The coating method for an electrode composition is not particularly limited and can be appropriately selected. Examples thereof include wet-type coating methods such as coating (preferably wet-type coating), spray coating, spin coating, dip coating, slit coating, stripe coating, and bar coating.

The applied electrode composition is subjected to a drying treatment (a heating treatment). The drying temperature is not particularly limited as long as the dispersion medium can be removed, and it is appropriately set according to the boiling point of the dispersion medium. The lower limit of the drying temperature is, for example, preferably 30° C. or higher, more preferably 60° C. or higher, and still more preferably 80° C. or higher. The upper limit thereof is preferably 300° C. or lower, more preferably 250° C. or lower, and still more preferably 200° C. or lower. In a case where the solid electrolyte composition is heated in the above-described temperature range, the dispersion medium can be removed to make the composition enter a solid state (coated and dried layer). This temperature range is preferable since the temperature is not excessively increased and each member of the sheet for an electrode is not impaired. The drying time is appropriately determined according to the drying temperature and the like and is not particularly limited. For example, it can be set to 0.1 to 5 hours, and it is preferably set to 0.2 to 1 hour.

After applying the electrode composition, it is also possible to pressurize the coated and dried layer within a range from which the filling rate does not deviate. Examples of the pressurizing methods include a method using a hydraulic cylinder press machine. The pressurizing force is not particularly limited, and it can be set to an appropriate pressurizing force in consideration of the filling rate of the active material layer precursor layer. Regarding the pressurization time, high pressure may be applied for a short time (for example, within several hours), or pressure may be applied for a long time (one day or longer). The pressing pressure may be a pressure that is constant or varies with respect to a portion under pressure of the coated and dried layer. It is also possible to change the pressing pressure depending on the area or the film thickness of the portion under pressure. In addition, the pressure may also be variable stepwise for the same portion. A pressing surface may be flat or roughened. The pressing may be carried out under heating. However, it is preferably carried out under non-heating, and for example, it is preferably carried out at an environmental temperature of 0° C. to 50° C.

In addition, the applied electrode composition may be heated while being pressurized. The heating temperature is not particularly limited; however, it is generally in a range of 30° C. to 300° C. The pressing can also be applied at a temperature higher than the glass transition temperature of the inorganic solid electrolyte. It is also possible to carry out pressing at a temperature higher than the glass transition temperature of the polymer that constitutes a polymer binder. However, in general, the temperature does not exceed the melting point of this polymer. The pressurization may be carried out in a state where the coating solvent or dispersion medium has been dried in advance or in a state where the solvent or the dispersion medium remains.

It is noted that the electrode composition may be subjected to coating, drying, and pressing simultaneously and/or sequentially.

The atmosphere in which the sheet for an electrode is manufactured is not particularly limited and may be any atmosphere such as atmospheric air, dry air (the dew point: −20° C. or lower), or inert gas (for example, an argon gas, a helium gas, or a nitrogen gas). It is preferably an atmosphere of dry air or inert gas since the inorganic solid electrolyte easily reacts with watery moisture.

### Step (Operation) of Setting Filling Rate to 35% to 50%

In the manufacturing method for a sheet for an electrode according to the embodiment of the present invention, a step (an operation) of setting a filling rate of the active material layer precursor layer to be formed to 35% to 50% is carried out. However, in a case where the active material layer precursor layer that is formed by subjecting the electrode composition to coating and drying has a filling rate of 35% to 50%, it is not necessary to carry out a step (an operation) of setting a filling rate of the active material layer precursor layer, which is described below.

Examples of the step of setting the filling rate include a step of adjusting a film density or a true density, for example, a step of changing the layer thickness of the coated and dried layer and the like, such as the kind, particle diameter, or content of each component, particularly the solid particles, and the concentration of solid contents or drying conditions of the electrode composition, as well as a step of mixing a material that decomposes and volatilizes by applying thereto, for example, heat, carrying out drying to remove a dispersion medium, and then decomposing and volatilizing this material.

Specifically, the filling rate increases in a case where the true density of solid particles such as the inorganic solid electrolyte, the active material, the polymer binder, or the conductive auxiliary agent is decreased, and thus it is preferable that the true density of each kind of the solid particles can be set to be in the above-described range. On the other hand, in a case where the particle diameter of the solid particle is decreased, the filling rate tends to decrease.

In addition, in a case where the solid content concentration of the electrode composition is increased (the content of the dispersion medium is decreased), the filling rate tends to decrease. The filling rate can be set to 50% or less, for example, in a case where the concentration of solid contents is set to 60% by mass or more and preferably 65% by mass or more, among the ranges described above.

Further, in a case where the drying conditions of the electrode composition are set to such conditions that drying is quickly carried out, the filling rate tends to decrease. For example, the filling rate can be reduced by shortening the drying time. Specifically, the drying time is favorably set to 2 hours or less and is preferably 1 hour or less. In addition, the filling rate can be reduced by increasing the drying temperature. Specifically, among the above-described drying temperatures, the drying temperature is favorably set to 80° C. or higher, is preferably 100° C. or higher, and is more preferably 110° C. or higher, and in case where it is set to 120° C. or higher, the filling rate can be reduced within the above-described range, and high transportability can be realized while maintaining low resistance.

It is also possible to set the filling rate by changing the kind or characteristics of the polymer binder. For example, in a case of changing the kind of the polymer that forms the polymer binder from a polymer that is dissolved in a dispersion medium to a particulate polymer that is dispersed therein, the filling rate tends to increase. Further, in a case where the particle diameter of the particulate polymer binder is decreased, the filling rate tends to increase. Further, in a case where the interaction (the adsorptivity) of the polymer binder with respect to the solid particles is weakened, for example, in a case where the content of the above-described constitutional component having a functional group, which is contained in the polymer that forms the polymer binder, is reduced, the filling rate tends to decrease. Specifically, in a case where the content of the constitutional component having a functional group is set to 3% to 20% by mole in the above-described range, it is easy to set the filling rate to 35% to 50% or less, particularly for the chain polymerization polymer.

### Step (Operation) of Setting Film Density

In the manufacturing method for a sheet for an electrode according to the embodiment of the present invention, it is also possible to carry out a step of setting the film density of the active material layer precursor layer in addition to the step (operation) of setting the filling rate. However, in a case where the active material layer precursor layer that is formed by subjecting the electrode composition to coating and drying or carrying out the step of setting the filling rate has a film density in the above range, it is not necessary to carry out a step (operation) of setting the film density.

Examples of the step of setting the film density include the same step as the above-described step of adjusting the film density. Examples thereof include a step of changing the layer thickness of the coated and dried layer and the like, such as the kind, particle diameter, or content of each component, particularly the solid particles, and the concentration of solid contents or drying conditions of the electrode composition, as well as a step of mixing a material that decomposes and volatilizes by applying thereto, for example, heat, carrying out drying to remove a dispersion medium, and then decomposing and volatilizing this material.

Specifically, the film density increases in a case where the true density of solid particles such as the inorganic solid electrolyte, the active material, the polymer binder, or the conductive auxiliary agent is decreased, and thus it is preferable that the true density of each kind of the solid particles can be set to be in the above-described range. On the other hand, in a case where the particle diameter of the solid particle is decreased, the film density tends to decrease.

In addition, in a case where the solid content concentration of the electrode composition is increased (the content of the dispersion medium is decreased), the film density tends to decrease. The film density can be set to 0.8 to 2.2 g/cm³ or less and desirably set to 1.4 to 2.0 g/cm³ or less, for example, in a case where the concentration of solid contents is set to, for example, 60% by mass or more and preferably 65% by mass or more, among the ranges described above.

Further, in a case where the drying conditions of the electrode composition are set to such conditions that drying is quickly carried out, the film density tends to decrease. For example, the film density can be reduced by shortening the drying time. Specifically, the drying time is favorably set to 2 hours or less and is preferably 1 hour or less. In addition, the film density can be reduced by increasing the drying temperature. Specifically, among the above-described drying temperatures, the drying temperature is favorably set to 80° C. or higher, is preferably 100° C. or higher, and is more preferably 110° C. or higher, and in case where it is set to 120° C. or higher, the film density can be reduced within the above-described range, and high transportability can be realized while maintaining low resistance.

It is also possible to set the film density by changing the kind or characteristics of the polymer binder. For example, in a case of changing the kind of the polymer that forms the polymer binder from a polymer that is dissolved in a dispersion medium to a particulate polymer that is dispersed therein, the film density tends to increase. Further, in a case where the particle diameter of the particulate polymer binder is decreased, the film density tends to increase. Further, in a case where the interaction (the adsorptivity) of the polymer binder with respect to the solid particles is weakened, for example, in a case where the content of the above-described constitutional component having a functional group, which is contained in the polymer that forms the polymer binder, is reduced, the film density tends to decrease. Specifically, the film density can be set to 0.8 to 2.2 g/cm³ or less and desirably set to 1.4 to 2.0 g/cm³ or less, in a case where the content of the constitutional component having a functional group is set to 3% to 20% by mole in the above-described range.

The above-described manufacturing method for a sheet for an electrode according to the embodiment of the present invention makes it possible to manufacture a sheet for an electrode, which has an active material layer precursor layer satisfying the filling rate as well as the film density.

### Manufacturing Method for Electrode Sheet

The electrode sheet can be manufactured by a method of pressing the active material layer precursor layer of the sheet for an electrode according to the embodiment of the present invention to form an active material layer (hereinafter, may be referred to as an electrode sheet manufacturing method according to the embodiment of the present invention).

The active material layer precursor layer is pressed in the thickness direction of the active material layer precursor layer. As a method of pressing the active material layer precursor layer, a general pressing method can be applied without particular limitation, and examples thereof include a method using a hydraulic cylinder press machine. The pressurizing force is not particularly limited as long as it is a pressure at which the filling rate of the active material layer can be increased generally to 60% or more, and the pressurizing force is set to an appropriate pressurizing force in consideration of the filling rate or layer thickness of the active material layer precursor layer as well as the damage to the surface of the solid particle. For example, it is preferably 5 to 1,500 MPa, more preferably 50 to 1,000 MPa, and still more preferably 100 to 600 MPa.

In the manufacturing method for a sheet for an electrode according to the embodiment of the present invention, heating may be carried out while the pressing is carried out. The heating method and the heating conditions are not particularly limited, and the heating method and the heating conditions which are respectively carried out and applied at the same time as the pressurization of the applied electrode composition can be applied thereto.

The atmosphere in which the electrode sheet manufacturing method is carried out is not particularly limited, and it can be set to the same atmosphere as the atmosphere in which the sheet for an electrode is manufactured.

In a case where the electrode sheet has a solid electrolyte layer, it can be manufactured by pressing the solid electrolyte layer or a solid electrolyte layer forming material on the sheet for an electrode according to the embodiment of the present invention in a state where they are superposed.

According to the above-described electrode sheet manufacturing method according to the embodiment of the present invention, it is possible to manufacture an electrode sheet having an active material layer which is a pressurized layer of the active material layer precursor layer and satisfies a filling rate of 60% or more.

### Manufacturing Method for All-Solid State Secondary Battery

Using the sheet for an electrode according to the embodiment of the present invention or the above-described electrode sheet, an all-solid state secondary battery can be manufactured by forming an active material layer or an electrode.

In the manufacturing of the all-solid state secondary battery, a solid electrolyte layer or a solid electrolyte sheet, or a solid electrolyte layer forming material is prepared.

The solid electrolyte layer or the solid electrolyte sheet can be produced by forming a film of an inorganic solid electrolyte-containing composition on a base material. As the inorganic solid electrolyte-containing composition, a generally used inorganic solid electrolyte-containing composition can be used without particular limitation. Examples thereof include a composition that contains the inorganic solid electrolyte, the polymer binder, and the dispersion medium, which are described above, and further contains appropriately a conductive auxiliary agent, a lithium salt and a dispersing agent, other additives, and the like. The film forming method and the film forming conditions are not particularly limited, and an appropriate method and appropriate conditions can be applied thereto. It is also possible to produce the solid electrolyte layer or the solid electrolyte sheet by subjecting a powder mixture that does not contain a dispersion medium to pressure molding, according to a general method.

The solid electrolyte layer forming material may be any material as long as it can form a solid electrolyte layer, and examples thereof include a material (in general, a solid composition) that appropriately contains the inorganic solid electrolyte and the polymer binder, which are described above, and further contains a conductive auxiliary agent, a lithium salt and a dispersing agent, other additives, and the like.

### Manufacturing Method for All-Solid State Secondary Battery in Which Sheet for Electrode According to Embodiment of Present Invention is Used

The manufacturing method for an all-solid state secondary battery in which the sheet for an electrode according to the embodiment of the present invention (may be referred to as a battery manufacturing method according to the embodiment of the present invention) is used is a method of pressing the sheet for an electrode according to the embodiment of the present invention and a solid electrolyte layer or solid electrolyte layer forming material in a state where they are superposed, thereby forming an active material layer or an electrode (a laminate of a collector and an active material layer). Here, in a case of forming one of the active material layers with the sheet for an electrode according to the embodiment of the present invention, the sheet for an electrode according to the embodiment of the present invention and the solid electrolyte layer or solid electrolyte layer forming material are superposed. On the other hand, in a case of forming both active material layers with the sheet for an electrode according to the embodiment of the present invention, the sheet for an electrode according to the embodiment of the present invention, the solid electrolyte layer or solid electrolyte layer forming material, and another sheet for an electrode according to the embodiment of the present invention are superposed, and a solid electrolyte layer or a solid electrolyte layer forming material is disposed between active material layer precursor layers of the two sheets of the sheet for an electrode according to the embodiment of the present invention.

In the battery manufacturing method according to the embodiment of the present invention, the active material layer precursor layer in the sheet for an electrode according to the embodiment of the present invention is pressed in the above-described superimposed state until the filling rate reaches, in general, 60% or more. This pressing is carried out collectively (integrally) in a direction in which the active material layer precursor layer is superimposed together with the solid electrolyte layer or a solid electrolyte layer forming material (the thickness direction of the active material layer precursor layer) in a state where the solid electrolyte layer is laminated on the active material layer precursor layer or in a state where the solid electrolyte layer forming material is placed on the active material layer precursor layer. The method and the conditions for pressing are not particularly limited; however, for example, the method and the conditions, which are described in the method and the conditions for pressing the active material layer precursor layer in the electrode sheet manufacturing method according to the embodiment of the present invention can be applied thereto.

In a case where one of the active material layers is not produced with the sheet for an electrode according to the embodiment of the present invention, an appropriate material that forms an active material layer is disposed on a pressed body of the sheet for an electrode according to the embodiment of the present invention and the solid electrolyte layer or solid electrolyte layer forming material and then appropriately pressurized, or the sheet for an electrode according to the embodiment of the present invention, the solid electrolyte layer or solid electrolyte layer forming material, and an appropriate material are superposed and then appropriately pressurized, whereby an all-solid state secondary battery can be manufactured. Regarding a pressurizing method in this case, a method of pressing an active material layer precursor layer can be applied, where the pressurizing force can be, for example, 5 to 1,500 MPa, which is not particularly limited.

### Manufacturing method for All-Solid State Secondary Battery Using Electrode Sheet

The manufacturing method for an all-solid state secondary battery using an electrode sheet is a method of superposing an electrode sheet and a solid electrolyte layer or pressing an electrode sheet and a solid electrolyte layer forming material in a state where they are superposed, thereby forming an active material layer or an electrode (a laminate of a collector and an active material layer). Here, in a case of forming one of the active material layers with an electrode sheet, the electrode sheet and the solid electrolyte layer or solid electrolyte layer forming material are superposed. On the other hand, in a case of forming both active material layers with the electrode sheet, the electrode sheet, the solid electrolyte layer or solid electrolyte layer forming material, and another electrode sheet are superposed, and a solid electrolyte layer or a solid electrolyte layer forming material is disposed between active material layers of the two sheets of the electrode sheet. In a case of carrying out pressing in a manufacturing method using an electrode sheet, regarding a pressurizing method, a method of pressing an active material layer precursor layer can be applied, where the pressurizing force can be, for example, 5 to 1,500 MPa, which is not particularly limited.

In a case where one of the active material layers is not produced from the electrode sheet, an appropriate material that forms an active material layer is disposed on the solid electrolyte layer superposed on the electrode sheet or the solid electrolyte layer forming material and then appropriately pressurized, whereby an all-solid state secondary battery can be manufactured. Regarding a pressurizing method in this case, a method of pressing an active material layer precursor layer can be applied, where the pressurizing force can be, for example, 5 to 1,500 MPa, which is not particularly limited.

The atmosphere in which the battery manufacturing method is carried out is not particularly limited, and it can be set to the same atmosphere as the atmosphere in which the sheet for an electrode is manufactured.

In the battery manufacturing method according to the embodiment of the present invention and the manufacturing method for an all-solid state secondary battery using the electrode sheet, which are described above, it is also possible to form a negative electrode active material layer by precipitating metal ions on a negative electrode collector or the like as a metal by initialization described later or charging during use, without forming the negative electrode active material layer in the manufacturing of the all-solid state secondary battery.

### Initialization

The all-solid state secondary battery manufactured as described above is preferably initialized after the manufacturing or before use. The initialization is not particularly limited, and it is possible to initialize the all-solid state secondary battery by, for example, carrying out initial charging and discharging in a state where the pressing pressure is increased and then releasing the pressure up to a pressure at which the all-solid state secondary battery is ordinarily used.

According to the battery manufacturing method according to the embodiment of the present invention and the manufacturing method for an all-solid state secondary battery using the electrode sheet, which are described above, it is possible to manufacture an all-solid state secondary battery in which an increase in interface resistance is suppressed as well.

### EXAMPLES

Hereinafter, the present invention will be described in more detail based on Examples; however, the present invention is not limited thereto be interpreted. “Parts” and “%” that represent compositions in the following Examples are based on the mass unless particularly otherwise described. In the present invention, “room temperature” means 25° C.

### 1. Polymer Synthesis

Polymers B1 to B5 respectively represented by the following chemical formulae were synthesized as follows.

### Synthesis Example B1: Synthesis of Polymer B1 and Preparation of Binder Solution B1

TUFTEC (registered trade name) H1041: A hydrogenated styrene-based thermoplastic elastomer (product name, SEBS, manufactured by Asahi Kasei Corporation) was dissolved in butyl butyrate to obtain a polymer binder solution B1 (concentration: 20% by mass) consisting of the polymer B1.

### Synthesis Example B2: Synthesis of Polymer B2 and Preparation of Binder Solution B2

To a 100 mL volumetric flask, 29.2 g of octadecyl acrylate (manufactured by FUJIFILM Wako Pure Chemical Corporation), 1.6 g of (2,3-dihydroxypropyl)methacrylate (manufactured by FUJIFILM Wako Pure Chemical Corporation), and 0.3 g of a polymerization initiator V-601 (product name, manufactured by FUJIFILM Wako Pure Chemical Corporation) were added and dissolved in 36 g of butyl butyrate to prepare a monomer solution. Next, to a 300 mL three-neck flask, 20 g of butyl butyrate was added and stirred at 80° C., and then the above-described monomer solution was added dropwise thereto over 2 hours. After completion of the dropwise addition, the temperature was raised to 90° C., and stirring was carried out for 2 hours to synthesize a polymer B2 (a (meth)acrylic polymer), whereby a polymer binder solution B2 (concentration: 35% by mass) consisting of the polymer B2 was obtained.

### Synthesis Example B3: Synthesis of Polymer B3 and Preparation of Binder Solution B3

To a 200 mL three-neck flask, 46.1 g of NIS SO-PB GI-3000 (product name, manufactured by NIPPON SODA Co., Ltd.) was added and dissolved in 92 g of butyl butyrate (manufactured by Tokyo Chemical Industry Co., Ltd.). To this solution, 3.9 g of dicyclohexylmethane-4,4′-diisocyanate (manufactured by Tokyo Chemical Industry Co., Ltd.) was added and stirred at 80° C. to be homogeneously dissolved. To the obtained solution, 0.08 g of Neostan U-600 (product name, manufactured by Nitto Kasei Co., Ltd.) was added and stirred at 80° C. for 12 hours to synthesize a polymer B3 (polyurethane), and a polymer binder solution B3 (concentration: 35% by mass) consisting of the polymer B3 was obtained.

### Synthesis Example B4: Synthesis of Polymer B4 and Preparation of Binder Dispersion Liquid B4

200 g of heptane was poured to a 1 L three-neck flask equipped with a reflux condenser and a gas introduction coke, nitrogen gas was introduced at a flow rate of 200 mL/min for 10 minutes, and the solution was heated to 80° C. A liquid (a liquid in which 177 g of ethyl acrylate (manufactured by Fujifilm Wako Pure Chemical Corporation), 13 g of acrylic acid (manufactured by Fujifilm Wako Pure Chemical Corporation), 100 g (solid content) of a macromonomer AB-6 (product name, manufactured by TOAGOSEI Co., Ltd.), and 2.0 g of a polymerization initiator V-601 (manufactured by Fujifilm Wako Pure Chemical Corporation) were mixed with each other) prepared in a separate container was added dropwise to the solution for 2 hours and was stirred at 80° C. for 2 hours. Next, 1.0 g of V-601 was further added to the obtained mixture, and the solution was stirred at 90° C. for 2 hours. The obtained solution was diluted with heptane to obtain a dispersion liquid B4 (concentration: 10% by mass, particle diameter: 150 nm) of a polymer binder consisting of the polymer B4 (a (meth)acrylic polymer).

### Synthesis Example B5: Preparation of Binder Dispersion Liquid B5

Polyvinylidene fluoride (manufactured by Sigma-Aldrich Co., LLC) was dispersed in butyl butyrate to obtain a dispersion liquid B5 (concentration: 20% by mass, particle diameter: 5 μm) of a polymer binder consisting of the polymer B5.

Each of the polymers synthesized is shown below. The number at the lower right of each constitutional component indicates the content (% by mole).

As a result of measuring the mass average molecular weights of the polymers B1 to B5, which respectively form the polymer binders B1 to B5, according to the above-described method, they were 100,000, 150,000, 50,000, 100,000, and 530,000 in the order from the polymers B1 to B5.

In addition, the form (dissolved or insoluble) of the binder in the electrode compositions of the polymer binders B1 to B5 described later was determined by measuring the solubility in the dispersion medium (butyl butyrate) that was used in the electrode composition according to the above-described method. As a result, the polymer binders B1 to B3 were dissolved in the dispersion medium of the electrode composition, and the polymer binders B4 and B5 were dispersed in a particle shape in the dispersion medium of the electrode composition.

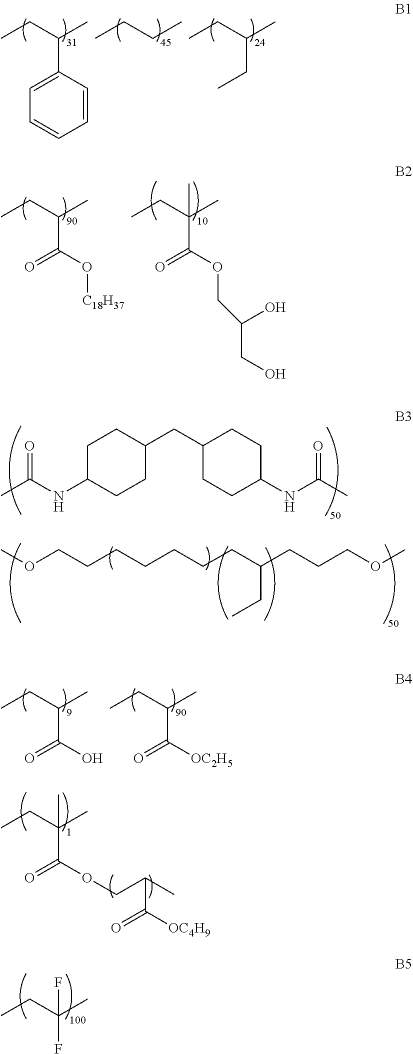

### 2. Synthesis of Sulfide-Based Inorganic Solid Electrolyte

### Synthesis Example A

A sulfide-based inorganic solid electrolyte was synthesized with reference to a non-patent document of T. Ohtomo, A. Hayashi, M. Tatsumisago, Y. Tsuchida, S. Hama, K. Kawamoto, Journal of Power Sources, 233, (2013), pp. 231 to 235 and A. Hayashi, S. Hama, H. Morimoto, M. Tatsumisago, T. Minami, Chem. Lett., (2001), pp. 872 and 873.

Specifically, in a globe box in an argon atmosphere (dew point: −70° C.), lithium sulfide (Li₂S, manufactured by Sigma-Aldrich Co., LLC, purity: >99.98%) (2.42 g) and diphosphorus pentasulfide (P₂S₅, manufactured by Sigma-Aldrich Co., LLC, purity: >99%) (3.90 g) each were weighed, put into an agate mortar, and mixed using an agate pestle for five minutes. The mixing ratio between Li₂S and P₂S₅ (Li₂S:P₂S₅) was set to 75:25 in terms of molar ratio.

Next, 66 g of zirconia beads having a diameter of 5 mm were put into a 45 mL container made of zirconia (manufactured by FRITSCH), the entire amount of the mixture of the above lithium sulfide and the diphosphorus pentasulfide was put thereinto, and the container was sealed in an argon atmosphere. The container was set in a planetary ball mill P-7 (product name, manufactured by FRITSCH), mechanical milling (micronization) was carried out at a temperature of 25° C. and a rotation speed of 510 rpm for 20 hours, thereby obtaining 6.20 g of a yellow powder of a sulfide-based inorganic solid electrolyte (Li/P/S glass, hereinafter, may be denoted as LPS). The particle diameter (the volume average particle diameter) of the LPS was 8 μm.

### Particle Diameter Adjustment

Wet-type dispersion was carried out using the obtained LPS under the following conditions to adjust the particle diameter of the LPS.

### Particle Diameter Adjustment Example A1

160 zirconia beads having a diameter of 5 mm were put into a 45 mL zirconia container (manufactured by Fritsch Japan Co., Ltd.), and 4.0 g of the synthesized LPS and 6.0 g of diisobutyl ketone as an organic solvent were added thereto. Then the container was set in a planetary ball mill P-7, and wet-type dispersion was carried out at 250 rpm for 30 minutes to obtain an LPS1 having a particle diameter (volume average particle diameter) of 2.5 μm.

### Particle Diameter Adjustment Examples A2 and A3

LPS2 having a particle diameter of 1.0 μm and LPS3 having a particle diameter of 3.0 μm were obtained in the same manner as in the particle diameter adjustment example A1, except that in the particle diameter adjustment example A1, the rotation speed in the wet-type dispersion was changed to 300 rpm or 200 rpm.

### Example 1

### Preparation of Positive Electrode Composition (Slurry) S-1

70 parts by mass of NMC (lithium nickel manganese cobalt oxide, particle diameter: 5 μm, manufactured by Sigma-Aldrich Co., LLC) as the positive electrode active material, 27 parts by mass of the LPS1 (particle diameter: 2.5 μm) obtained in the particle diameter adjustment Example A1 as the inorganic solid electrolyte, 2 parts by mass of acetylene black (particle diameter: 0.1 μm, manufactured by Denka Company Limited) as the conductive auxiliary agent, 1 part by mass of the polymer binder solution B1 as the polymer binder (in terms of solid contents), and a dispersion medium were mixed in the order of the following step 1 and step 2 to prepare a positive electrode composition S-1 having a concentration of solid contents of 65% by mass.

### Step 1

20 g of zirconia beads having a diameter of 3 mm was added to a 45 mL container made of zirconia (manufactured by FRITSCH), and further, 27 parts by mass of the inorganic solid electrolyte, 1 part by mass of the polymer binder solution B1 (in terms of solid contents), and butyl butyrate as the dispersion medium were added thereto to adjust the concentration of solid contents to 60% by mass. Thereafter, the container was set in a planetary ball mill P-7 (trade name, manufactured by Fritsch Japan Co., Ltd.), and stirring was carried out for 30 minutes hours at a temperature of 25° C. and a rotation speed of 100 rpm to obtain a solid electrolyte composition S1-1 having a concentration of solid contents of 60% by mass.

### Step 2

70 parts by mass of a positive electrode active material, 2 parts by mass of acetylene black, and further, butyl butyrate as a dispersion medium were added to the entire amount of the solid electrolyte composition S1-1 in the container, which was obtained in the step (1), and the concentration of solid contents was adjusted as shown in Table 1. Thereafter, the container was set in a planetary ball mill P-7, and stirring was carried out at a temperature of 25° C. and a rotation speed of 100 rpm for 30 minutes to obtain a positive electrode composition S-1.

### Preparation of Positive Electrode Compositions (Slurries) S-2 to S-12 and cS-1 to cS-9>

Each of positive electrode compositions S-2 to S-12 and cS-1 to cS-9 was prepared in the same manner as in the preparation of the positive electrode composition S-1, except that in the preparation of the positive electrode composition S-1, the kind (particle diameter) of the inorganic solid electrolyte and the kind or content of the polymer binder were changed as shown in Table 1, the content of the solid electrolyte was changed so that the total mass of the inorganic solid electrolyte, the positive electrode active material, the polymer binder, and acetylene black was 100 parts by mass, and further, the content of the dispersion medium that was used in the step (2) was changed, whereby the concentration of solid contents of the positive electrode compositions was set as shown in Table 1.

### Production of Sheet for Positive Electrode

Each of the positive electrode compositions S-1 to S-12 and cS-1 to cS-9 obtained as above was applied onto an aluminum foil having a thickness of 20 μm by using a baker type applicator (product name: SA-201, manufactured by Tester Sangyo Co., Ltd.), followed by heating and drying (removal of dispersion medium) under the setting to “Coating and drying conditions” shown in Table 1. In this way, a positive electrode active material layer precursor layer was formed on the aluminum foil to produce each of sheets S-1 to S-12 and cS-1 to cS-9 for a positive electrode of an all-solid state secondary battery.

It is noted that the sheet S-12 for an electrode is the same as the sheet S-3 for a positive electrode.

In Table 1, the unit each of the particle diameter (μm) of the inorganic solid electrolyte, the concentration of solid contents (% by mass), the drying temperature (° C.), the drying time (hour), and the filling rate (%) is omitted. In addition, the content of the polymer binder indicates the content (% by mass) with respect to 100% by mass of the solid content of each positive electrode composition; however, the unit thereof is omitted in the table.

TABLE 1

| | Inorganic solid | | | | | | | | | |
|---|---|---|---|---|---|---|---|---|---|---|
| Positive electrode | electrolyte | | | | | Coating and drying conditions | | Sheet for positive | | |
| composition | | Particle | Polymer binder | | Concentration of | Drying | Drying | electrode | | |
| No. | | diameter | | Content | solid contents | temperature | time | No. | Filling rate | Note |
| S-1 | LPS1 | 2.5 | B1 | 1 | 65 | 140 | 0.5 | S-1 | 38 | Present |
| | | | | | | | | | | invention |
| S-2 | LPS1 | 2.5 | B1 | 1 | 65 | 110 | 0.5 | S-2 | 46 | Present |
| | | | | | | | | | | invention |
| S-3 | LPS1 | 2.5 | B2 | 1 | 70 | 140 | 0.5 | S-3 | 40 | Present |
| | | | | | | | | | | invention |
| S-4 | LPS1 | 2.5 | B2 | 1 | 70 | 110 | 0.5 | S-4 | 46 | Present |
| | | | | | | | | | | invention |
| cS-1 | LPS1 | 2.5 | B1 | 1 | 65 | 70 | 1.5 | cS-1 | 53 | Comparative |
| | | | | | | | | | | Example |
| cS-2 | LPS1 | 2.5 | B2 | 1 | 70 | 70 | 1.5 | cS-2 | 57 | Comparative |
| | | | | | | | | | | Example |
| cS-3 | LPS1 | 2.5 | B1 | 4 | 65 | 70 | 1.5 | cS-3 | 53 | Comparative |
| | | | | | | | | | | Example |
| cS-4 | LPS1 | 2.5 | B1 | 4 | 65 | 140 | 0.5 | cS-4 | 43 | Comparative |
| | | | | | | | | | | Example |
| S-5 | LPS3 | 3.0 | B2 | 1 | 70 | 110 | 0.5 | S-5 | 43 | Present |
| | | | | | | | | | | invention |
| cS-5 | LPS3 | 3.0 | B2 | 1 | 70 | 70 | 1.5 | cS-5 | 57 | Comparative |
| | | | | | | | | | | Example |
| S-6 | LPS2 | 1.0 | B2 | 2 | 65 | 140 | 0.5 | S-6 | 43 | Present |
| | | | | | | | | | | invention |
| cS-6 | LPS2 | 1.0 | B2 | 2 | 65 | 70 | 1.5 | cS-6 | 62 | Comparative |
| | | | | | | | | | | Example |
| cS-7 | LPS2 | 1.0 | B2 | 4 | 65 | 140 | 0.5 | cS-7 | 43 | Comparative |
| | | | | | | | | | | Example |
| S-7 | LPS1 | 2.5 | B3 | 1 | 65 | 140 | 0.5 | S-7 | 40 | Present |
| | | | | | | | | | | invention |
| S-8 | LPS1 | 2.5 | B3 | 1 | 65 | 110 | 0.5 | S-8 | 48 | Present |
| | | | | | | | | | | invention |
| S-9 | LPS1 | 2.5 | B4 | 1 | 70 | 140 | 0.5 | S-9 | 44 | Present |
| | | | | | | | | | | invention |
| S-10 | LPS1 | 2.5 | B4 | 1 | 70 | 110 | 0.5 | S-10 | 50 | Present |
| | | | | | | | | | | invention |
| cS-8 | LPS1 | 2.5 | B5 | 4 | 65 | 140 | 0.5 | cS-8 | 33 | Comparative |
| | | | | | | | | | | Example |
| S-11 | LPS1 | 2.5 | B5 | 2 | 65 | 110 | 0.5 | S-11 | 40 | Present |
| | | | | | | | | | | invention |
| S-12 | LPS1 | 2.5 | B2 | 1 | 70 | 140 | 0.5 | S-12 | 40 | Present |
| | | | | | | | | | | invention |
| cS-9 | LPS1 | 2.5 | B2 | 1 | 70 | 100 | 1.0 | cS-9 | 55 | Comparative |
| | | | | | | | | | | Example |

### Manufacturing of All-Solid State Secondary Battery

Each of the produced sheets S-1 to S-12 and cS-1 to cS-9 for a positive electrode was punched into a disk shape having a diameter of 10 mm and placed in a cylinder made of polyethylene terephthalate (PET) and having an inner diameter of 10 mm. 30 mg of the LPS1 (particle diameter: 2.5 μm) obtained in the particle diameter adjustment example A1 was placed on the side of the positive electrode active material layer precursor layer in each cylinder, and a rod made of stainless steel (an SUS rod) having a diameter of 10 mm was inserted from the openings at both ends of the cylinder. A pressure of 350 MPa was applied, with the SUS rod, to the collector side of each of the sheets for a positive electrode and LPS, thereby collectively pressurizing the positive electrode active material layer precursor layer and the LPS. In this way (according to the manufacturing method for an electrode sheet according to the embodiment of the present invention), a positive electrode sheet having a positive electrode active material layer and a solid electrolyte layer in this order on an aluminum foil as a base material was manufactured. It is noted that the pressure was set to 150 MPa for the sheet S-12 for a positive electrode, which was subsequently pressurized together with LPS.

Next, the SUS rod on the LPS side was once removed, and a disk-shaped In sheet having a diameter of 9 mm (thickness: 20 μm) and a disk-shaped Li sheet having a diameter of 9 mm (thickness: 20 μm) were inserted in this order onto the LPS in the cylinder. The removed SUS rod was inserted again into the cylinder and the sheets were fixed while applying a pressure of 50 MPa. In this manner, all-solid state secondary batteries (positive electrode half cells) Nos. 101 to 112 and c101 to c109 having a configuration of an aluminum foil (thickness: 20 μm)—positive electrode active material layer (the thickness is shown in the column of “Film thickness” in Table 2)—solid electrolyte layer (thickness: 250 μm)—negative electrode active material layer (In/Li sheet, thickness: 30 μm) were manufactured.

### Evaluation of Sheet for Positive Electrode

Regarding each of the produced sheets for a positive electrode, the film density, the filling rate, and the film thickness of the positive electrode active material layer precursor layer were measured or calculated. The results are shown in the column of “Sheet for positive electrode” in Table 2. It is noted that in Table 2, the units of the film density (g/cm³), the filling rate (%), and the film thickness (μm) are omitted.

### Calculation of Film Density

Each sheet for a positive electrode was punched out to have a diameter of 10 mm (surface area: 0.785 cm 2), and the mass thereof was measured at 25° C. The mass of the aluminum foil was subtracted from the measured mass to calculate the mass (g) of the positive electrode active material layer precursor layer (the electrode mixed material). Next, the film thickness of the positive electrode active material layer precursor layer was measured at 25° C. using a thickness measuring instrument at constant pressure (manufactured by Mitutoyo Corporation). The volume (cm³) of the positive electrode active material layer precursor layer was calculated from the film thickness and the surface area (0.785 cm 2) of the positive electrode active material layer precursor layer. The film density (g/cm³) was calculated by dividing the mass (g) of the positive electrode active material layer precursor layer by the volume (cm³) thereof.

### Calculation of True Density

The true density of the positive electrode active material layer precursor layer was calculated as described above.

Specifically, first, each of the active material, the inorganic solid electrolyte, the conductive auxiliary agent, and the polymer binders B1 to B5 was subjected to the measurement of the true density at 25° C. by using a density measuring device: BELPYCNO (product name, manufactured by MicrotracBEL Corp.) according to a gas replacement method. As a result, the true density (g/cm³) was 5.3 for the active material, was 2.0 for the LPS1, was 2.0 for the LPS2, was 2.0 for the LPS3, was 2.0 for the conductive auxiliary agent, was 1.1 for each of the polymer binders B1 to B4, and was 1.8 for the polymer binder B5.

Next, from the true densities of the active material, the inorganic solid electrolyte, the conductive auxiliary agent, and the polymer binders B1 to B5, and the content rates thereof in the positive electrode composition, the true density (g/cm³) of the positive electrode active material layer precursor layer was calculated according to the following expression.

True density of positive electrode active material layer precursor layer (g/cm³)=[true density of active material×content rate thereof]+[true density of inorganic solid electrolyte×content rate thereof]+[true density of conductive auxiliary agent×content rate thereof]+[(true density of polymer binder×content rate thereof)

### Calculation of Filling Rate

The filling rate (%) of the positive electrode active material layer precursor layer was calculated according to the above-described method.

### Measurement of Film Thickness

The film thickness of the positive electrode active material layer precursor layer was the film thickness (μm) measured in the calculation of the film density.

### Measurement of Particle Diameter of Inorganic Solid Electrolyte

As a result of recovering the inorganic solid electrolyte from the active material layer precursor layer of each sheet for a positive electrode and measuring the particle diameter thereof according to the above-described measuring method, the particle diameter thereof was almost the same as the particle diameter of the inorganic solid electrolyte which had been used in the preparation of the electrode composition.

The following evaluations were carried out for each of the manufactured sheets for an electrode and each of the manufactured all-solid state secondary batteries, and the results thereof are shown in the column of “All-solid state secondary battery” in Table 2. It is noted that other evaluations were carried out for the all-solid state secondary batteries that did not pass the bending resistance test (excluding the all-solid state secondary battery cS-8). In addition, in Table 2, the unit of each of the filling rate (%) and the film density (g/cm³) is omitted.

### Evaluation 1-1: Calculation of Filling Rate of Positive Electrode Active Material Layer

Each of the all-solid state secondary batteries was cut, and the cross section thereof was observed with a scanning electron microscope (SEM) to measure the film thickness (the average film thickness) of the positive electrode active material layer. Using the obtained film thickness, the filling rate was calculated in the same manner as in the calculation of the filling rate of the positive electrode active material layer precursor layer.

### Evaluation 1-2: Calculation of Film Density of Positive Electrode Active Material Layer

The film density of the positive electrode active material layer, which had been taken out from each of the all-solid state secondary batteries, was measured in the same manner as in the calculation of the film density of the positive electrode active material layer precursor layer.

It is noted that the filling rate and the film density of the positive electrode active material layer in each positive electrode sheet are respectively the same as the filling rate and the film density of the positive electrode active material layer in the all-solid state secondary battery shown in Table 2.

### Evaluation 2: Bending Resistance Test of Sheet for Electrode

The adhesiveness of the solid particles in the positive electrode active material layer precursor layer of each of the manufactured sheets for an electrode, and the bonding property between the positive electrode active material layer precursor layer and the aluminum foil (collector) were evaluated as the transportability of the sheet for an electrode. The results are described in the column of “Bending resistance” of the column of “All-solid state secondary battery” in Table 2.

The produced sheet for an electrode was cut into a rectangle having a width of 3 cm and a length of 14 cm. Using a cylindrical mandrel tester (product code: 056, manufactured by Allgood Co., Ltd.), one end part of the cut-out sheet test piece in the length direction was fixed to the tester and disposed so that the cylindrical mandrel touched the central portion of the sheet test piece, and then the sheet test piece was bent by 180° along the peripheral surface of the mandrel (with the mandrel as an axis) while pulling the other end part of the sheet test piece in the length direction with a force of 2N along the length direction. It is noted that the sheet test piece was set so that the positive electrode active material layer precursor layer thereof was placed on a side opposite to the mandrel (the base material or the collector was placed on the side of the mandrel) and the width direction was parallel to the axis line of the mandrel. The test was carried out by gradually reducing the diameter of the mandrel from 32 mm.

In a state of being wound around the mandrel and a state of being restored to a sheet shape by releasing the winding, the occurrence of defects (cracking, breakage, chipping, and the like) in the positive electrode active material layer precursor layer due to the disintegration of adhesion of solid particles as well as the minimum diameter at which the peeling between the positive electrode active material layer precursor layer and the collector could not be confirmed was measured, and the evaluation was carried out by determining which evaluation standard below is satisfied by the minimum diameter.

In this test, it is meant that the smaller the minimum diameter is, the higher flexibility is obtained while maintaining the adhesion force of the solid particles that constitute the positive electrode active material layer precursor layer, and the disintegration of adhesion of the solid particles can be suppressed since the followability to bending stress is exhibited even in a case of being subjected to a roll transport step in the industrial manufacturing method. The pass level in the test in the present invention is a level equal to or higher than the evaluation standard “B”.

It is noted that the minimum diameters of the all-solid state secondary batteries Nos. c101, c102, c105, c106, c108, and c109 were all 32 mm.

### Evaluation Standards

A: Minimum diameter<14 mm
B: 14 mm≤minimum diameter<25 mm
C: 25 mm≤minimum diameter

### Evaluation 3: Resistance Test

The battery resistance of each of the manufactured all-solid state secondary batteries was evaluated according to the following method. The results are shown in the column of “Battery resistance” of the column of “All-solid state secondary battery” in Table 2.

Specifically, using each of the manufactured all-solid state secondary batteries (half cells), charging was carried out in an environment of 25° C. under the condition of a charging current value of 0.1 mA until the battery voltage reached 3.6 V. Thereafter, discharging was carried out under the condition of a discharging current value of 0.1 mA until the battery voltage reached 1.9 V to initialize each of the all-solid state secondary batteries.

Thereafter, as a rate test, charging was carried out in an environment of 25° C. under the condition of a charging current value of 0.1 mA until the battery voltage reached 3.6 V, and subsequently, discharging was carried out under the condition of a discharging current value of 0.1 mA until the battery voltage reached 1.9 V (a charging and discharging step (1)). Thereafter, charging was carried out under the condition of a charging current value of 0.1 mA until the battery voltage reached 3.6 V, and subsequently, discharging was carried out under the condition of a discharging current value of 1.5 mA until the battery voltage reached 1.9 V (a charging and discharging step (2)).

After the charging and discharging steps (1) and (2) were completed, the discharge capacity was measured using a charging and discharging evaluation device TOSCAT-3000 (trade name, manufactured by Toyo System Co., Ltd.). Using the measured discharge capacity, the retention rate (%) of the discharge capacity was calculated from the following expression and applied to the following evaluation standards to evaluate the rate characteristics of the all-solid state secondary battery.

In this test, it is meant that the higher the retention rate (%) is, the lower the battery resistance (the resistance of the positive electrode active material layer) of the all-solid state secondary battery is, and an evaluation standard “B” or higher is the pass level in this test.

It is noted that the retention rates (%) of the all-solid state secondary batteries Nos. c103, c104, and c107 were respectively 65%, 65%, and 68%, and the retention rates (%) of the all-solid state secondary batteries Nos. c108 and c109 were respectively 62% and 64%.

Retention rate (%)=[discharge capacity in charging and discharging step (2)/discharge capacity in charging and discharging step (1)]×100

### Evaluation standards

A:90%≤retention rate
B: 80%≤retention rate<90%
C: retention rate<80%

TABLE 2

| Sheet for positive electrode | | | | All-solid state secondary battery | | | | | |
|---|---|---|---|---|---|---|---|---|---|
| | Film | Filling | Film | | Film | Filling | Bending | Battery | |
| No. | density | rate | thickness | No. | density | rate | resistance | resistance | Note |
| S-1 | 1.65 | 38 | 170 | 101 | 3.96 | 92 | A | A | Present |
| | | | | | | | | | invention |
| S-2 | 1.98 | 46 | 150 | 102 | 3.91 | 91 | B | A | Present |
| | | | | | | | | | invention |
| S-3 | 1.72 | 40 | 180 | 103 | 4.01 | 93 | A | A | Present |
| | | | | | | | | | invention |
| S-4 | 1.98 | 46 | 150 | 104 | 3.98 | 93 | B | A | Present |
| | | | | | | | | | invention |
| cS-1 | 2.28 | 53 | 130 | c101 | — | — | C | — | Comparative |
| | | | | | | | | | Example |
| cS-2 | 2.45 | 57 | 120 | c102 | — | — | C | — | Comparative |
| | | | | | | | | | Example |
| cS-3 | 2.23 | 53 | 130 | c103 | 3.87 | 92 | A | C | Comparative |
| | | | | | | | | | Example |
| cS-4 | 1.81 | 43 | 160 | c104 | 3.83 | 91 | A | C | Comparative |
| | | | | | | | | | Example |
| S-5 | 1.85 | 43 | 160 | 105 | 3.86 | 90 | A | B | Present |
| | | | | | | | | | invention |
| cS-5 | 2.45 | 57 | 120 | c105 | — | — | C | — | Comparative |
| | | | | | | | | | Example |
| S-6 | 1.84 | 43 | 160 | 106 | 4.02 | 94 | A | A | Present |
| | | | | | | | | | invention |
| cS-6 | 2.65 | 62 | 110 | c106 | — | — | C | — | Comparative |
| | | | | | | | | | Example |
| cS-7 | 1.81 | 43 | 160 | c107 | 3.95 | 94 | A | C | Comparative |
| | | | | | | | | | Example |
| S-7 | 1.72 | 40 | 180 | 107 | 3.96 | 92 | A | A | Present |
| | | | | | | | | | invention |
| S-8 | 2.06 | 48 | 150 | 108 | 4.04 | 94 | A | A | Present |
| | | | | | | | | | invention |
| S-9 | 1.89 | 44 | 160 | 109 | 3.91 | 91 | B | A | Present |
| | | | | | | | | | invention |
| S-10 | 2.15 | 50 | 130 | 110 | 3.96 | 92 | B | A | Present |
| | | | | | | | | | invention |
| cS-8 | 1.39 | 33 | 200 | c108 | 3.46 | 82 | C | C | Comparative |
| | | | | | | | | | Example |
| S-11 | 1.68 | 40 | 180 | 111 | 3.66 | 87 | B | B | Comparative |
| | | | | | | | | | Example |
| S-12 | 1.72 | 40 | 180 | 112 | 3.97 | 92 | A | A | Present |
| | | | | | | | | | invention |
| cS-9 | 2.38 | 55 | 120 | c109 | — | — | C | — | Comparative |
| | | | | | | | | | Example |

The following findings can be seen from the results of Table 1 and Table 2.

The sheet for a positive electrode of Comparative Example, which does not satisfy the content or the filling rate of the polymer binder, is inferior in transportability or cannot suppress an increase in the resistance of the all-solid state secondary battery.

On the other hand, it is possible to effectively suppress an increase in the resistance of the all-solid state secondary battery since the sheet for an electrode of Example, which satisfy the content and the filling rate of the polymer binder, has excellent transportability, and makes it possible to form an active material layer having a high filling rate by pressing in the manufacturing process of the all-solid state secondary battery.

The present invention has been described together with the embodiments of the present invention. However, the inventors of the present invention do not intend to limit the present invention in any part of the details of the description unless otherwise designated, and it is conceived that the present invention should be broadly construed without departing from the spirit and scope of the invention shown in the attached “WHAT IS CLAIMED IS”.

### EXPLANATION OF REFERENCES

1: negative electrode collector
2: negative electrode active material layer
3: solid electrolyte layer
4: positive electrode active material layer
5: positive electrode collector
6: operation portion
8: base material
9: active material layer precursor layer
10: all-solid state secondary battery
11: sheet for electrode

What is claimed is:

1. A sheet for an electrode, comprising:
an active material layer precursor layer containing an inorganic solid electrolyte having ion conductivity of a metal belonging to Group 1 or Group 2 in the periodic table, an active material, and a polymer binder,
wherein the active material layer precursor layer is such that a content of the polymer binder is 3% by mass or less and a filling rate of 35% to 50% is exhibited.

2. The sheet for an electrode according to claim 1,
wherein the active material layer precursor layer has a layer thickness of 150 μm or more.

3. The sheet for an electrode according to claim 1,
wherein the inorganic solid electrolyte is a sulfide-based inorganic solid electrolyte.

4. The sheet for an electrode according to claim 1,
wherein the inorganic solid electrolyte has a particle diameter of 0.1 to 2.5 μm.

5. The sheet for an electrode according to claim 1,
wherein the active material layer precursor layer is a positive electrode active material layer precursor layer having a film density of 1.4 to 2.0 g/cm³.

6. The sheet for an electrode according to claim 1,
wherein the active material layer precursor layer is a negative electrode active material layer precursor layer having a film density of 0.8 to 1.0 g/cm³.

7. A manufacturing method for a sheet for an electrode, which is a method of manufacturing the sheet for an electrode according to claim 1, in which an electrode composition containing an inorganic solid electrolyte having ion conductivity of a metal belonging to Group 1 or Group 2 in the periodic table, an active material, a polymer binder, and a dispersion medium is applied onto a base material and dried to form an active material layer precursor layer, the manufacturing method comprising:
a step of setting a content of solid contents of the polymer binder to 3% by mass or less to prepare the electrode composition; and
a step of setting a filling rate of the active material layer precursor layer to 35% to 50%.

8. A manufacturing method for an electrode sheet, which is a manufacturing method for an electrode sheet having an active material layer on a base material, the manufacturing method comprising:
pressing an active material layer precursor layer of a sheet for an electrode obtained by the manufacturing method for a sheet for an electrode according to claim 7, to form an active material layer.

9. A manufacturing method for an all-solid state secondary battery, which is a manufacturing method for an all-solid state secondary battery including a positive electrode active material layer, a solid electrolyte layer, and a negative electrode active material layer in this order, the manufacturing method comprising:
pressing and forming at least one of the positive electrode active material layer or the negative electrode active material layer in a state where a sheet for an electrode obtained by the manufacturing method for a sheet for an electrode according to claim 7 is superposed with a solid electrolyte layer or a solid electrolyte layer forming material.

10. An all-solid state secondary battery manufactured by the manufacturing method for an all-solid state secondary battery according to claim 9.
